(19) United States
(12) Patent Application Publication
(10) Pub. No.: US 2026/0368543 A1
(43) Pub. Date: Nov. 19, 2026

(54) AGENTIC AI FRAMEWORK USING BIOSIGNALS FOR ADAPTIVE INTERACTION

(71) Applicant: Cognixion Corporation, Santa Barbara, CA (US)

(72) Inventors: Daniela Friedson-Trujillo, Highland Village, TX (US); Christopher Jason Ullrich, Ventura, CA (US); Cole Heiner, Vista, CA (US); Carl Hagmann, Syracuse, NY (US); Soo Bin Park, Santa Barbara, CA (US)

(73) Assignee: Cognixion Corporation, Santa Barbara, CA (US)

(21) Appl. No.: 19/675,008

(22) Filed: May 12, 2026

Related U.S. Application Data
(60) Provisional application No. 63/804,488, filed on May 12, 2025.

(51) Int. Cl. G06N 3/092; G06N 3/042; G06N 3/0895

(52) U.S. Cl. CPC G06N 3/092; G06N 3/042; G06N 3/0895

(57) ABSTRACT

A computer-implemented system controls adaptive behavior in response to user biosignals. The system comprises a biosignal acquisition and processing subsystem, a feature extraction and classification subsystem, a dynamic network of goal-driven software agents, a knowledge base, a short-loop adaptive response logic, and a long-loop long-term model training component. The system processes user biosignals, classifies them into states, selects actions based on those states, executes those actions, and adjusts them in real-time based on feedback. The system also refines its classifiers and agent decision policies over time based on accumulated data.

### CROSS-REFERENCE TO RELATED APPLICATIONS

This application claims the benefit of U.S. provisional patent application Ser. No. 63/804,488, filed on May 12, 2025, the contents of which are incorporated herein by reference in their entirety.

### TECHNICAL FIELD

Computer-implemented agentic artificial intelligence systems that acquire, interpret, and act upon human biosignal data (including but not limited to EEG, HRV, EDA, eye tracking, facial expression, and voice analysis) to drive adaptive, goal-directed software agent behavior. Applications span assistive technology, clinical monitoring, adaptive user interfaces, and communication support for individuals with acquired language disorders (including aphasia).

### BACKGROUND

Human agency as a term of human psychology may refer to an individual's capacity to actively and independently make choices and to impose those choices on their surroundings. There are many situations in which people have a need and desire to make choices in interacting with their environment but are unable to do so without assistance. In this manner, such people find themselves impaired in their human agency to effect a change in their surroundings or communicate with those around them.

Advances in augmented and virtual reality, as well as the field of robotics and artificial intelligence (AI), offer a host of tools whereby a user unable to enact their agency to interact with the world around them unassisted may be supported in doing so. These systems may remain partially or fully inaccessible to users unable to speak, users with limited mobility, users with impaired perception of their surroundings, either sensory perception or social perception, and most of all, users inexperienced in interacting with augmented reality (AR), virtual reality (VR), and robotics.

Recent advances in Generative AI (GenAI) may allow those unfamiliar with coding to interact with AI and robotic assistants, as well as the people around them, using GenAI outputs. “Generative AI” or “GenAI” in this disclosure refers to a type of Artificial Intelligence (AI) capable of creating a wide variety of data, such as images, videos, audio, text, and 3D models. It does this by learning patterns from existing data, then using this knowledge to generate new and unique outputs. GenAI is capable of producing highly realistic and complex content that mimics human creativity, making it a valuable tool for many industries such as gaming, entertainment, and product design (found on https://generativeai.net, accessed May 24, 2023).

GenAI may include large language models (LLMs), Generative Pre-trained Transformer (GPT) including chatbots such as ChatGPT, OpenAI, text-to-image and other visual art creators such as Midjourney and Stable Diffusion, and even more comprehensive models such as the generalist agent Gato. However, conventional interaction with these entities involves formulating effective natural language queries, and this may not be possible for all users.

Existing interactive AI systems respond primarily to explicit user input (typed or spoken commands) and do not make effective use of the rich stream of physiological and behavioral signals continuously produced by a human user. Systems that do ingest biosignals are typically narrowly scoped to a single modality (for example, heart-rate monitoring) or a single use case (for example, seizure alerting), and they do not provide a unifying framework in which multimodal biosignals drive the selection, coordination, and adaptation of software agents over time.

Within the clinical/assistive subdomain, the problem is particularly acute for individuals with acquired language disorders. Aphasia alone affects approximately two million individuals in the U.S., with roughly 180,000 new stroke-related cases each year. Its defining clinical feature is the dissociation between preserved intent and broken expression: the user knows what they wish to communicate but cannot reliably access the linguistic forms to express it. Existing Augmentative and Alternative Communication (AAC) tools are compensatory, not adaptive: they do not personalize to residual ability, do not integrate multi-modal biosignal input, and do not support clinical recovery goals.

There is, therefore, a need for a general framework in which biosignals act as active inputs that shape agent behavior, action selection, and long-term model refinement, while remaining flexible across diverse applications in healthcare, assistive technology, and adaptive human-computer interaction, and that addresses the specific clinical challenge of preserved-intent/broken-expression communication.

### BRIEF SUMMARY

A computer-implemented system for adaptive agent behavior control utilizes biosignal data from a user to drive decision-making processes. The system comprises various components, including biosignal acquisition and processing, feature extraction and classification, dynamic software agents, a knowledge base, an adaptive response logic, and a long-term model training component.

The system's operation involves acquiring multimodal biosignal data from a user, classifying the data into user states, and using this information to inform the selection of actions by software agents. The knowledge base plays a key role in this process, storing historical biosignal patterns, user baselines, and prior outcomes to guide the agents' decision-making.

In real-time, the system receives feedback signals and adjusts ongoing actions based on this feedback, without need for retraining of the classifiers. Periodic refinement of the classifiers and agent decision policies is also performed, using accumulated data to improve the system's performance and adaptability.

In practice, the system's operation may be described as follows: a user's biosignal data is acquired and classified into user states; based on these states, software agents select and execute actions; feedback signals are received, and the ongoing actions are adjusted in real-time; and the classifiers and agent decision policies are periodically refined to reflect accumulated data.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system architecture 100 in accordance with one embodiment.

FIG. 2 illustrates a routine 200 in accordance with one embodiment.

FIG. 3 illustrates a RAG index data and inference pipeline 300 in accordance with one embodiment.

FIG. 4 illustrates a real-time adaptive assistant 400 in accordance with one embodiment.

FIG. 5 illustrates a volitional signal control system 500 in accordance with one embodiment.

FIG. 6 illustrates a multi-agent reasoning and learning system 600 in accordance with one embodiment.

FIG. 7 illustrates a seizure support and intervention system 700 in accordance with one embodiment.

FIG. 8 illustrates an assistive robot system for paralyzed users 800 in accordance with one embodiment.

FIG. 9 illustrates a cognitive health support system 900 in accordance with one embodiment.

FIG. 10 illustrates a goal-oriented dialog support system 1000 in accordance with one embodiment.

FIG. 11 illustrates a routine 1100 for driving adaptive agent behavior from biosignal data in accordance with one embodiment.

FIG. 12 illustrates a routine 1200 for adapting a user interface based on a biosignal-grounded interaction history in accordance with one embodiment.

FIG. 13 illustrates a routine 1300 in accordance with one embodiment.

FIG. 14 illustrates a routine 1400 in accordance with one embodiment.

FIG. 15 illustrates a routine 1500 in accordance with one embodiment.

FIG. 16 illustrates a user agency and capability augmentation system 1600 in accordance with one embodiment.

FIG. 17 illustrates a biosignals subsystem 1700 in accordance with one embodiment.

FIG. 18 illustrates a context subsystem 1800 in accordance with one embodiment.

FIG. 19 illustrates a routine 1900 in accordance with one embodiment.

FIG. 20 illustrates a multiuser system 2000 in accordance with one embodiment.

FIG. 21 illustrates an exemplary tokenizer 2100 in accordance with one embodiment.

FIG. 22A illustrates an isometric view of a BCI headset system 2200 in accordance with one embodiment.

FIG. 22B illustrates a rear view of a BCI headset system 2200 in accordance with one embodiment.

FIG. 22C and FIG. 22D illustrate exploded views of a BCI headset system 2200 in accordance with one embodiment.

FIG. 23 illustrates a BCI+AR environment 2300 in accordance with one embodiment.

FIG. 24 illustrates an augmented reality device logic 2400 in accordance with one embodiment.

FIG. 25 illustrates a block diagram of nonverbal multi-input and feedback device 2500 in accordance with one embodiment.

FIG. 26 illustrates a block diagram of a single framework of a nonverbal multi-input and feedback device 2600 in accordance with one embodiment.

FIG. 27 illustrates a block diagram of nonverbal multi-input and feedback device 2700 in accordance with one embodiment.

FIG. 28 illustrates a logical diagram of a user wearing an augmented reality headset 2800 in accordance with one embodiment.

FIG. 29 illustrates a logical diagram of a user wearing an augmented reality headset 2900 in accordance with one embodiment.

FIG. 30 illustrates a diagram of a use case including a user wearing an augmented reality headset 3000 in accordance with one embodiment.

FIG. 31 illustrates a flow diagram 3100 in accordance with one embodiment.

FIG. 32 illustrates a flow diagram 3200 in accordance with one embodiment.

FIG. 33 illustrates a block diagram 3300 in accordance with one embodiment.

FIG. 34 illustrates a block diagram 3400 in accordance with one embodiment.

FIG. 35 illustrates a block diagram 3500 in accordance with one embodiment.

FIG. 36 illustrates a computing device 3600 in accordance with one embodiment.

FIG. 37 illustrates a cloud computing system 3700 in accordance with one embodiment.

FIG. 38 illustrates cloud computing functional abstraction layers 3800 in accordance with one embodiment.

### DETAILED DESCRIPTION

Disclosed is a modular, multimodal computer-implemented framework that interprets real-time biosignal and contextual data to guide adaptive agentic behavior. The agentic Al framework uses biosignals in a modular, multimodal system designed to interpret real-time physiological and behavioral signals in order to guide adaptive, intelligent agent behavior. At its core, the framework continuously monitors biosignal inputs such as electroencephalography (EEG) measuring brain activity, heart rate variability (HRV), electrodermal activity (EDA), eye tracking, facial expressions, and other contextual signals.

The framework comprises a tools-and-environment layer that acquires biosignals and context; a pre-processing and feature extraction layer that cleans the signals and classifies higher-level user states; a dynamic network of goal-driven AI agents that consume classified state and select actions; a knowledge base that stores historical patterns, user baselines, and prior outcomes; and a dual-timescale feedback loop comprising short-loop adaptive response logic (operating in seconds) and a long-loop long-term model training component (operating across events and weeks).

These biosignals are preprocessed and transformed into actionable features, which are used to classify an entity's cognitive, emotional, and physical state—such as fatigue, confusion, stress, or focused engagement. While this entity is typically the user in interactive settings, the framework also supports adversarial or observational scenarios in which biosignals are captured passively using remote methods (e.g., cameras, infrared, radar, or Wi-Fi sensing). In such cases, any biosignal-producing entity may serve as the target of analysis.

Once a state has been inferred, the system orchestrates the activation, coordination, and prioritization of software agents based on detected needs, intent, or risk level. Unlike traditional Al systems that merely respond to explicit input (like touch or voice), this agentic framework supports adaptive, anticipatory behavior. Each agent is goal-driven, but their behavior is shaped by real-time biosignal feedback and historical patterns stored in a continuously updated knowledge base. A central Supervisor Agent (when present) manages orchestration, deciding which agents to activate, when to escalate support, and how to route outputs to the appropriate interface, environment, or stakeholder. This structure supports both moment-to-moment responsiveness via the adaptive response logic and long-term personalization through a long-loop long-term model training component based on accumulated data.

The framework is designed to support a wide range of use cases—from seizure intervention and assistive robotics, to cognitive health support, adaptive dialogue systems, and even passive biosignal detection in public or high-risk environments. In all contexts, biosignals are not just passive inputs but active elements that shape how agents behave, what actions are taken, and how information is delivered. Whether simplifying a user interface (UI), redirecting a robot, triggering an alert, or surveilling for unusual behavior, the Agentic Al Framework supports systems that are both intelligent and deeply attuned to real-time physiological states-empowering safer, more adaptive, and human-aware interactions.

The framework in particular supports three distinct architectural approaches that differ in how the user and the agent network interact. A Real-time Adaptive Assistant may support autonomous monitoring and intervention without user input. A Volitional Signal Control System may decode user-initiated volitional biosignals into commands, with a Confirmation Gate verifying intent before action. A Multi-Agent Reasoning and Learning may include collaborating specialist agents under a Supervisor, communicating via Agent-to-Agent (A2A) protocol and accessing external tools via Model Context Protocol (MCP), with an evolving user model maintained in a retrieval-augmented Knowledge Base.

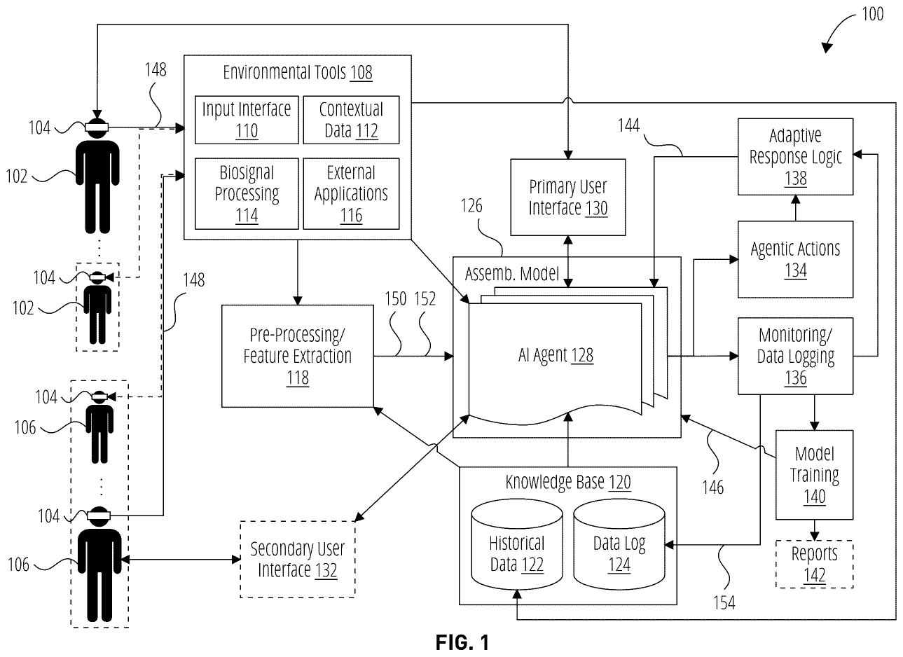

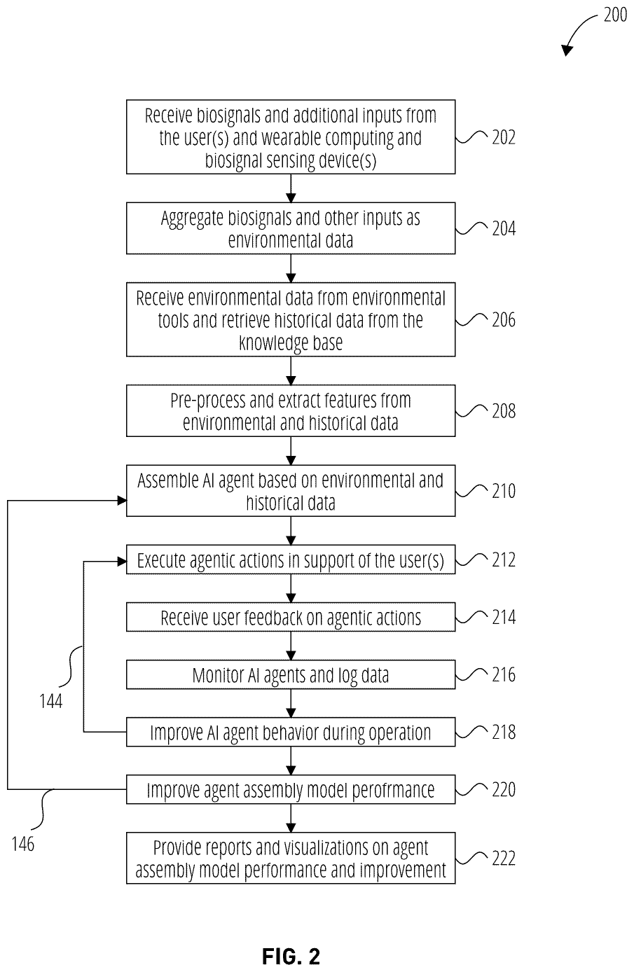

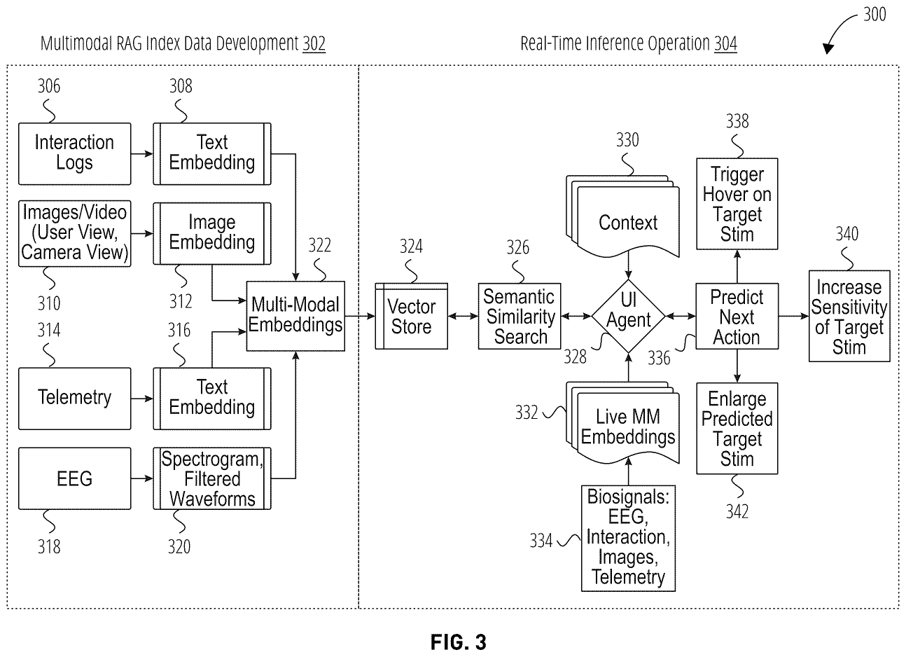

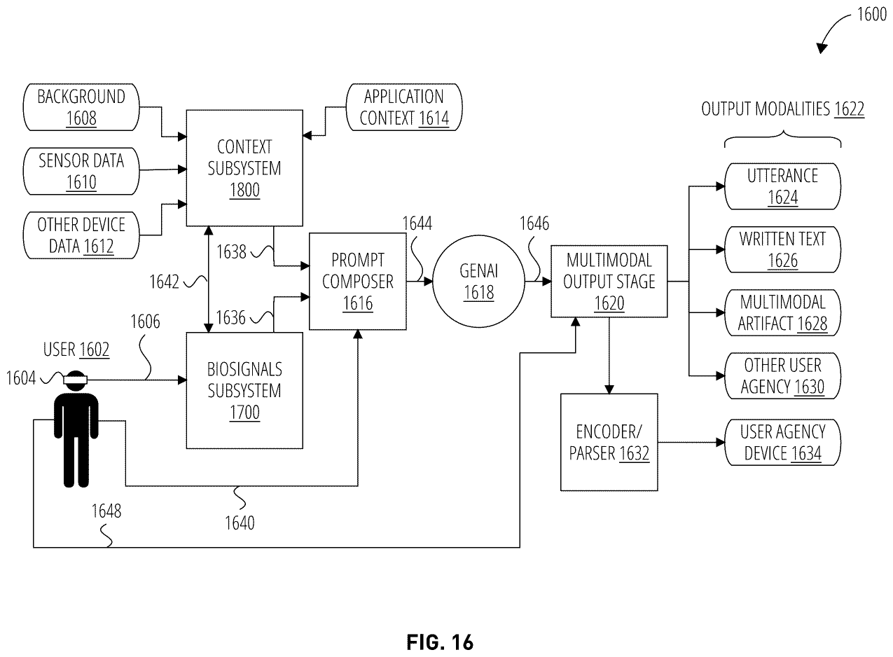

The general architecture and the generic feedback loop common to all three approaches are shown in FIGS. 1-2. FIG. 16 shows the general component system architecture 100: how biosignals from an entity (user) enter the system, flow through a Tools/Environment layer into pre-processing and the AI Agents, and are routed out to actions and monitoring with a Knowledge Base providing persistent context. FIG. 2 shows a flowchart routine 200 supporting the generic feedback loop: the dual-timescale structure in which the Adaptive response logic provides short-loop (immediate) adjustments while Long-Term Model Training provides long-loop (aggregate, cross-session) model refinements. Operation of the disclosed system implements retrieval-augmented generation (RAG) indexing and an inference pipeline described below with respect to the RAG index data and inference pipeline 300 illustrated in FIG. 3.

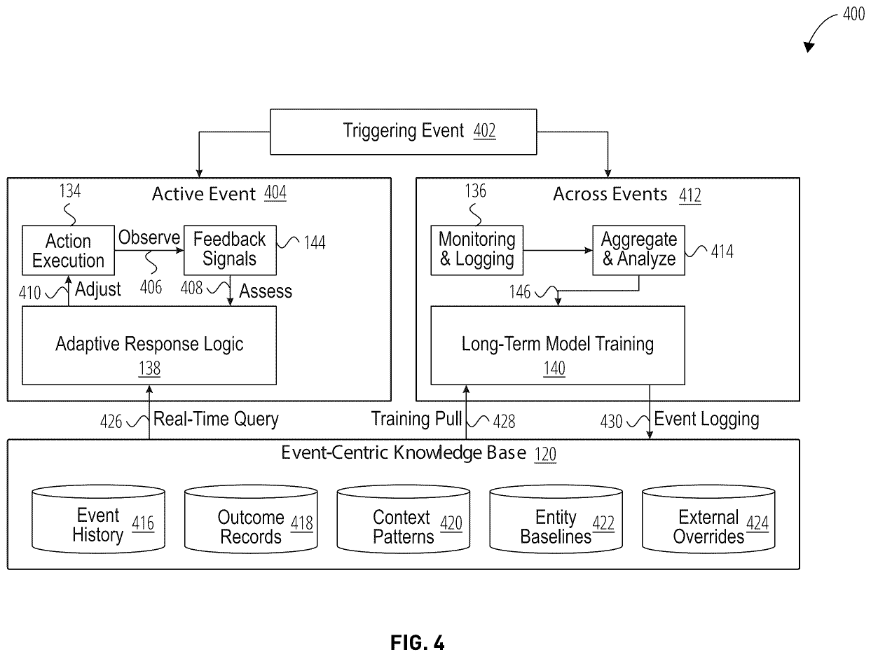

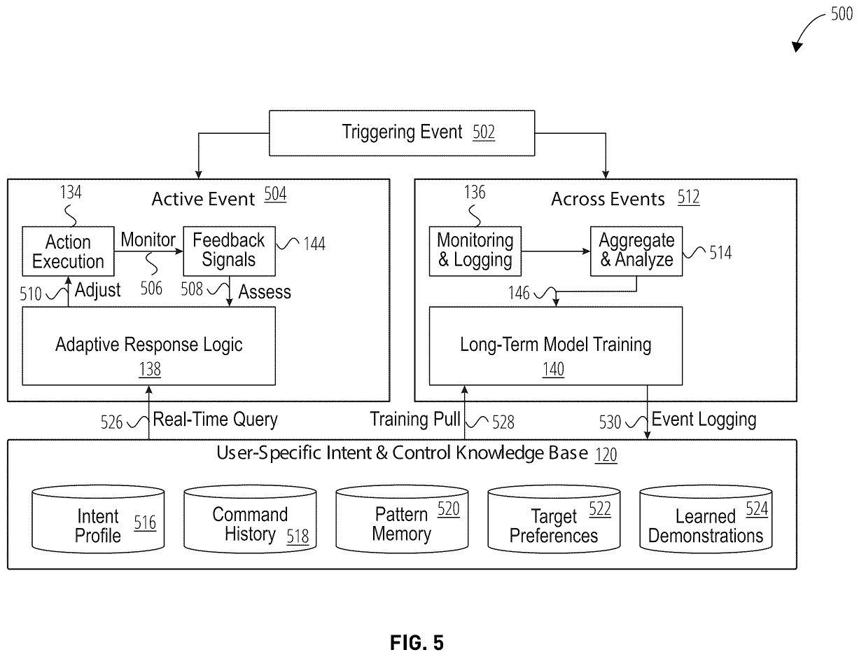

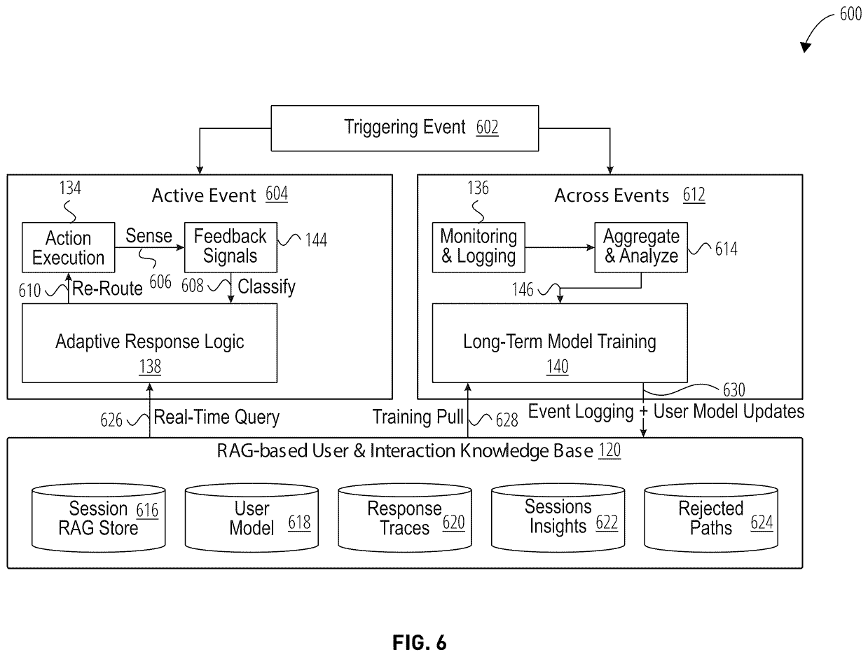

Further described below, with respect to FIGS. 4-6, is how each of the distinct architectural approaches listed above specializes those general structures. The real-time adaptive assistant 400 of FIG. 4, the volitional signal control system 500 of FIG. 5, and the multi-agent reasoning and learning system 600 of FIG. 6 are each a specialization of the overall architecture and flow illustrated in FIGS. 1-2. Each approach is characterized by a distinct triggering event, the role of the user in the confirmation and execution of actions, and in the purpose-specific content of its knowledge base.

The three approaches of FIGS. 4-6 represent key embodiments of the framework, not mutually exclusive alternatives. A deployed system may combine approaches: for example, it may default to Real-time Adaptive Assistant behavior, transition to Volitional Signal Control when the user explicitly initiates a command, and enter Multi-Agent Reasoning and Learning during dedicated review or reflection sessions.

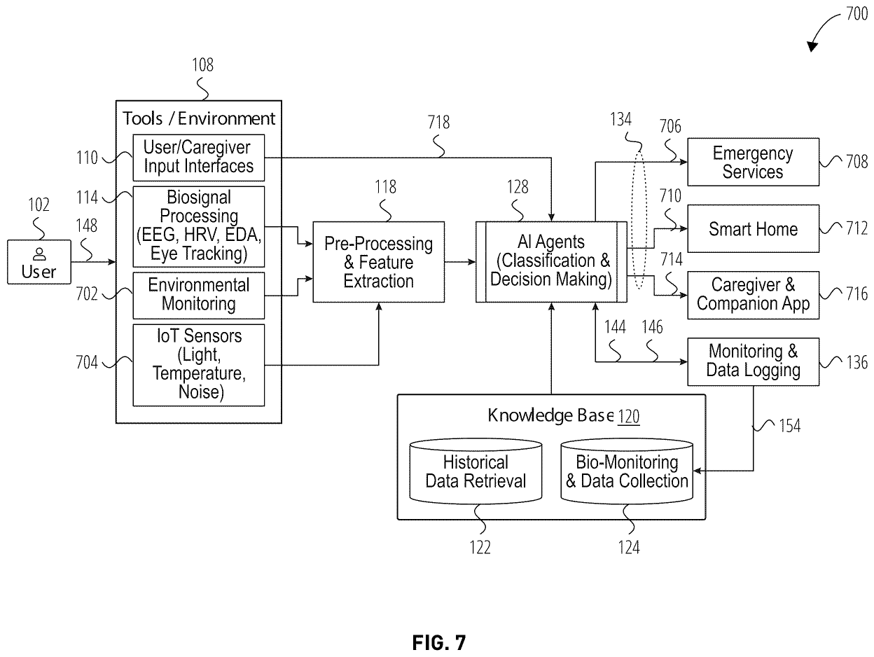

Exemplary applications for the disclosed solution are described with respect to FIGS. 7-10. The seizure support and intervention system 700, assistive robot system for paralyzed users 800, cognitive health support system 900, and goal-oriented dialog support system 1000 illustrated and described are representative of the broad applicability of the disclosed system across healthcare, assistive technology, and clinical domains. These four concrete product embodiments demonstrate the broad operational scope of this disclosure.

An integrated embodiment combining all three approaches is an agentic cognitive support system for users with complex interaction needs. Such an embodiment may use Real-time Adaptive behaviors through an Adaptive complexity logic that performs intra-session state estimation and fatigue-aware pacing; Volitional Signal Control through a preprocessing and feature extraction pipeline that receives gaze, gesture, touch, typed input, contextual signals, and biometric affect, classifies them into cognitive, emotional, or behavioral states, and routes inferred intent to confirmation-gated command execution; and Multi-Agent Reasoning and Learning through a three-tier agentic memory system (profile store, episodic/relational memory, semantic intent graph) with longitudinal interaction telemetry and anticipatory context loading. Such an integrated embodiment demonstrates that the three approaches may be included within a single product.

The disclosed solution has a number of key advantages over conventional approaches. In the disclosed solution, biosignals act as active inputs that shape agent behavior rather than as passive monitoring data. Existing systems typically treat physiological data as telemetry for later analysis; this framework uses it in-the-loop to drive real-time decision-making. The two-timescale feedback architecture (short-loop adaptive response logic plus long-loop Long-Term Model Training) allows the system to react to in-event feedback without waiting for retraining, while still improving models and policies between sessions. The framework supports three distinct interaction patterns within a single underlying architecture, enabling a deployed product to address autonomous intervention, volitional command, and collaborative reasoning use cases without separate systems. The knowledge base design is purpose-specific per approach: event-centric for autonomous intervention, user-specific intent-and-control for volitional control, and retrieval-augmented cross-session for multi-agent reasoning. This purpose-specific memory design is a key novelty. The use of Agent-to-Agent (A2A) protocols and Model Context Protocol (MCP) tools within a biosignal-grounded agent network allows specialist agents to coordinate and access external tools in a standardized way, with user physiological state informing orchestration decisions. Finally, personalized intent-to-expression mapping is supported for users with acquired language disorders: the three-tier memory architecture maps individual meaning to expression where general language models map population expression to meaning. This inverts the conventional direction and is the architectural response to the preserved-intent/broken-expression clinical phenomenon.

In some embodiments of the disclosed solution, outputs of any of the three architectural approaches may be rendered as AR overlays on a wearable or near-eye display. The AR overlay modality is not itself an architectural approach; it is a way to present agent outputs to the user in a low-language, contextually embedded format that reduces linguistic and cognitive load across daily-life activities. AR overlays are especially valuable for users with acquired language disorders (aphasia, alexia) and cognitive impairment.

Context-aware reading assistance AR systems may detect text in the environment and renders a simplified text restatement, a symbol-based substitute, or an audio summary, with complexity calibrated to the user's Adaptive complexity logic state. Real-time conversation support AR overlays surface candidate word cues or related concepts during in-person conversation when a word-retrieval-failure event is detected from biosignal and/or audio features. Cues may be visible to the user but not to conversation partners. In navigation and wayfinding systems, symbol-based directional guidance may be layered over the physical world, replacing text-heavy transit apps and street signage. Smart-home and environmental control systems may use icon-based AR overlays to replace text-heavy device interfaces for appliances, switches, and schedules. Social-situation coaching systems may use real-time contextual cues derived from a multimodal classifier, using prior-situation retrieval from episodic memory to surface likely utterances or appropriate responses during familiar social scenarios; current scenario re-encoded post-interaction. Brain retraining systems may use Speech-Language Pathologist-supported agentic learning exercises rendered as AR interactions, personalized to ACE-estimated state and the compensate-vs-rehabilitate dial.

There are disclosed herein systems and methods for human agency support through an integrated use of context information from the user's environment, the user's historical data such as recorded usage of the system, a body of recorded historical work product, etc., biosensor signals indicating information about the user's physical state and bodily actions, and explicit user input. These are input to a prompt composer capable of taking in these inputs, generating a prompt for a generative AI or generalist agent.

The output of the generative AI or generalist agent may drive an output stage that is able to support and facilitate the human agency of the user based on the output. In this manner, the user may interact with the system with ease and rapidity, the system generating communications to or instructing the actions of supportive and interactive entities surrounding the user, such as other people, robotic aids, smart systems, etc.

In addition to human-centered systems, the Agentic Al Framework using Biosignals may be extended to incorporate real-time physiological signals from nonhuman animals. Many species possess uniquely sensitive perceptual abilities-ranging from magnetic navigation to chemical detection—that may complement or even exceed the capabilities of artificial sensors. By integrating animal biosignals into agentic systems, new forms of environmental sensing, interaction, and decision-making become possible.

These biosignals are treated similarly to human inputs in the framework: they are preprocessed, interpreted in context, and used to drive intelligent agent behavior. Whether identifying changes in EEG associated with recognition, shifts in heart rate variability, or electrosensory responses, agents use these cues to adapt actions such as directing drones, triggering alerts, or repositioning sensors. The following examples illustrate how the Agentic Al Framework may intelligently respond to biosignals from animals to support dynamic, goal-directed operations across diverse environments.

Birds of prey, such as hawks or falcons, possess highly acute vision, often surpassing that of human surveillance systems. By monitoring their EEG in real-time, especially using event-related potentials (ERPs) tied to visual recognition, intelligent systems may detect moments when the bird “notices” specific ground features—such as movement, contrast, or anomalies. This biosignal-triggered cue may be used to guide drones, refine imaging system focus, or flag potential targets for human or autonomous review, effectively turning the bird into a biologically attuned aerial sensor.

Many migratory birds navigate using Earth's magnetic field, with magnetoreception encoded through specialized proteins (e.g., cryptochromes) in their eyes. By monitoring orientation behavior or neural markers (like changes in specific EEG patterns or motor adjustments) in a controlled but mobile environment, systems may track how birds perceive and respond to magnetic fields. These biosignals may augment magnetic field mapping in inaccessible terrains or aid in studying geomagnetic anomalies for environmental, military, or geological purposes.

Electric fish (like knifefish or elephantnose fish) generate weak electric fields and detect disruptions via specialized skin receptors. By reading their sensory patterns or neural activity in real time, systems may infer underwater terrain features, obstacles, or other living organisms with high precision. This biosignal data may guide autonomous underwater vehicles (AUVs) or robotic systems through murky or GPS-denied environments, leveraging fish as real-time environmental proxies.

Detection dogs often outperform machines in identifying explosives, drugs, or specific scents. By outfitting trained dogs with lightweight EEG and heart rate variability (HRV) sensors, it's possible to detect physiological changes that occur when a dog senses a known target or experiences uncertainty. These biosignals may be used to trigger system alerts, mark GPS locations, or initiate video recording, providing more accurate detection and reducing handler subjectivity.

Bees have highly sensitive olfactory systems, capable of detecting specific chemical signatures in parts per trillion. Using neural probes or EMG sensors attached near their antennae or olfactory lobes, systems may monitor bees' responses to volatile compounds like pollutants, explosives, or agricultural pathogens. These biosignals may trigger alerts, triangulate chemical plumes, or guide drone-based sampling, transforming bees into autonomous mobile chemical detectors.

The Agentic Al Framework may operate using signals and data other than biosignals collected through direct wearables or user-facing interfaces. Passive and remote sensing technologies such as radar, infrared, WiFi, and thermal imaging offer powerful, non-intrusive alternatives for detecting human presence, posture, physiological changes, and contextual cues. These modalities are especially valuable in environments where continuous monitoring is needed but direct input is impractical or invasive. By converting these remote signals into interpretable features—such as respiration rate, movement trajectory, or attention shifts-agentic systems may make informed decisions about what actions to take, which agents to engage, and how to adjust their timing or delivery. The following use cases show how passive sensing provides seamless, low-friction support in applications ranging from safety monitoring to interface adaptation.

WiFi signal reflection and interference patterns may be used to passively detect the presence, movement, and even posture of individuals in an indoor environment. By monitoring signal distortions, Al agents may infer if an entity has entered a room, fallen, or remained motionless for an extended period. The Adaptive response logic may then trigger interventions such as increasing lighting, alerting a caregiver, or pausing ongoing activities. These adjustments occur without cameras or wearables, preserving privacy while maintaining situational awareness.

Certain passive sensors, including radar and WiFi, may monitor micro-movements caused by breathing and heartbeat. These signals allow Al agents to detect when an individual is asleep, entering rapid eye movement (REM) cycles, or experiencing respiratory distress. In smart environments, this data helps agents delay non-urgent prompts, initiate quiet modes, or alert medical responders if anomalies are found. Because no wearables are needed, this approach is ideal for continuous overnight monitoring in clinical or home settings.

The disclosed framework supports a wide range of use-case types that apply agentic Al systems to biosignal-driven interactions. Broadly, use cases fall into three categories: real-time adaptive assistants, which autonomously monitor biosignals and intervene without user input; volitional signal control systems, where agents decode user goals and execute robotic or smart home actions; and multi-agent reasoning systems, where multiple Al agents collaborate to analyze user input, adapt questioning strategies, and refine understanding over time. These categories are not mutually exclusive and often overlap in hybrid deployments, enabling flexible and personalized applications across domains such as health monitoring, assistive robotics, cognitive support, and dynamic dialogue.

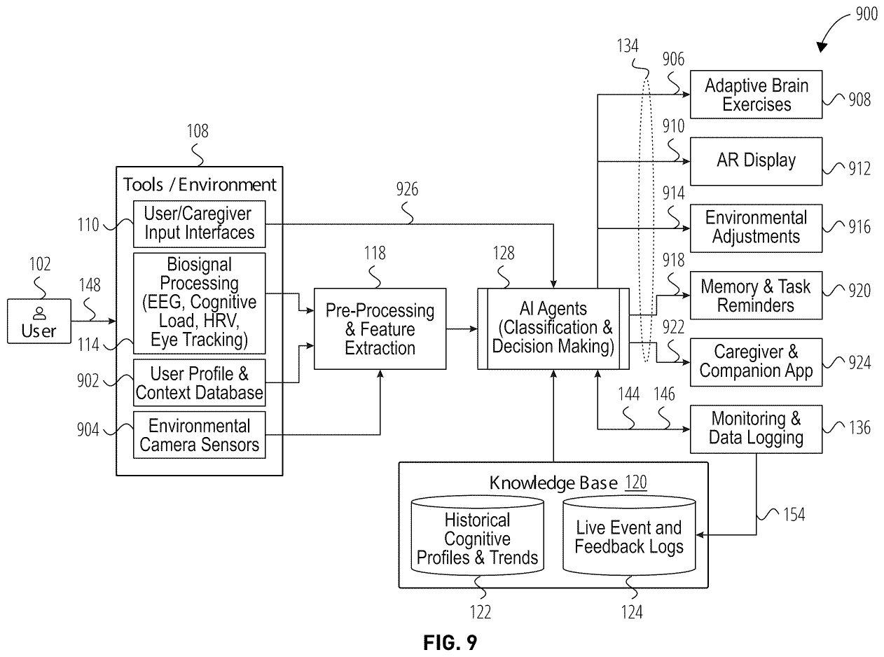

A real-time adaptive assistant 400 is illustrated in FIG. 4. The real-time adaptive assistant 400 may continuously monitor biosignals, predict changes, and autonomously intervene to assist the user. It may be triggered by autonomous monitoring & intervention (no user input needed). Key AI capabilities of the real-time adaptive assistant 400 may include constant biosignal tracking, event-based decision-making: agents detect patterns and predict outcomes, and proactive intervention (adjust environment, alert caregivers, suggests actions, etc.). Examples of real-time adaptive assistant 400 may include the seizure support and intervention system 700 of FIG. 7, which may detect seizure risk and trigger automated interventions, and the cognitive health support system 900 of FIG. 9, which may monitor cognitive fatigue and assist with memory recall and mental clarity.

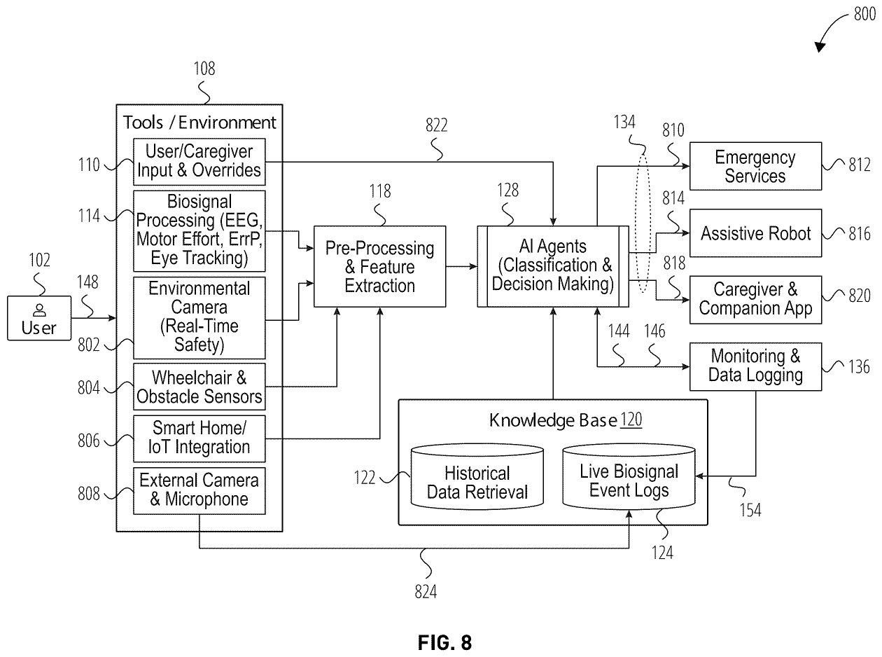

A volitional signal control system 500 is illustrated in FIG. 5. The volitional signal control system 500 may decipher user goals and execute complex actions, such as control of robotics, wheelchairs, and smart home components. Agents of the volitional signal control system 500 may be triggered by user actions and may decode signals before acting. Confirmation may be provided by the user directly or by a designated human or AI agent acting as, for example, a caregiver. Key AI capabilities of the volitional signal control system 500 may include user goal recognition via EEG and eye tracking (EEG detects effort to initiate control, i.e., the “when”, and eye tracking identifies gaze targets, i.e., the “what”, which may be combined to estimate user goals and trigger context-aware actions), decision-making by agents that choose and executes actions with confirmation where needed, autonomous execution where agents control smart home, robotics, or mobility devices, and support of multi-source confirmation such that actions may be verified by the user or a trusted proxy agent when needed (e.g., caregiver, supervisory AI). The assistive robot system for paralyzed users 800 of FIG. 8 is an exemplary volitional signal control system 500.

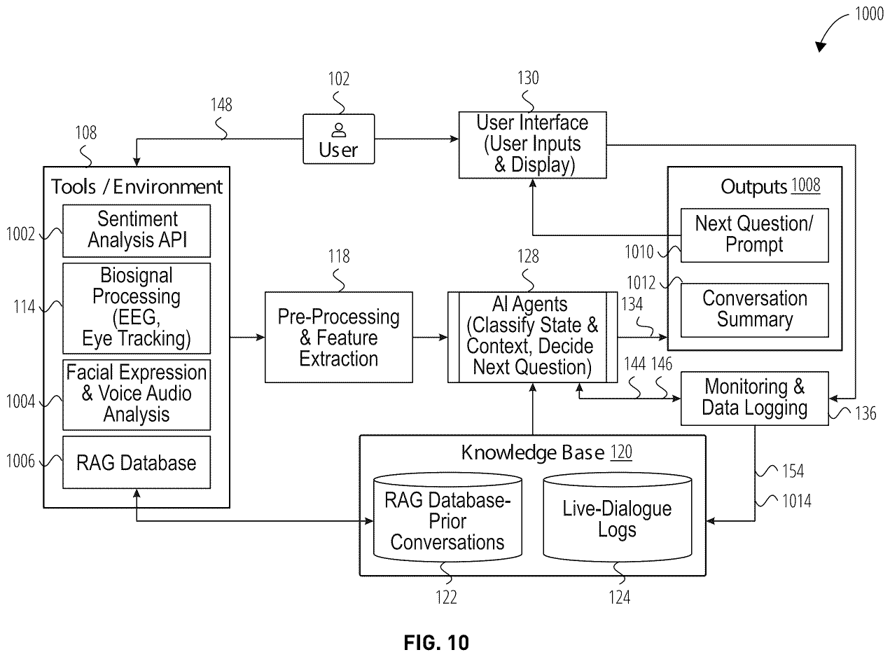

A multi-agent reasoning and learning system 600 is illustrated in FIG. 6. The multi-agent reasoning and learning system 600 may uses multiple agents to extract knowledge, analyze responses, and refine interactions over time. It may be triggered by user attention and AI-driven reasoning. Agents may interact autonomously using agent-to-agent (A2A) protocol and use tools with model context protocol (MCP). Key AI capabilities may include multi-agent collaboration, with different agents handle questioning, fact-checking, summarization, and user adaptation, conversational learning that modifies responses based on real-time feedback, and long-term memory and refinement where past sessions are remembered to build an adaptive knowledge base. One example of a multi-agent reasoning and learning system 600 is the goal-oriented dialog support system 1000 described with respect to FIG. 10. Agents in the goal-oriented dialog support system 1000 may learn about a person dynamically by adapting questioning strategies.

Examples provided above for real-time adaptive assistants 400, volitional signal control systems 500, and multi-agent reasoning and learning systems 600, offer a high-level overview of how agents may be applied across different biosignal-driven use cases. In the following section of this document, each of these examples will be expanded upon in greater detail. These deeper dives explore system components, decision logic, and adaptive behaviors unique to each use case, illustrating the flexibility and real-world potential of the disclosed Agentic Al Framework.

In one embodiment, a computer-implemented system comprises: a biosignal acquisition and processing subsystem configured to receive multimodal biosignal data from a user; a feature extraction and classification subsystem configured to classify the multimodal biosignal data into at least one user state; a dynamic network of goal-driven software agents configured to select and execute at least one action based on the classified at least one user state; a knowledge base storing historical biosignal patterns, user baselines, and prior action outcomes; a short-loop adaptive response logic configured to adjust the at least one action in real time based on feedback signals; and a long-loop long-term model training component configured to periodically refine classifiers of the feature extraction and classification subsystem and agent decision policies based on accumulated biosignal, action, and outcome data. In this context, real time means that the system operates on a timescale that makes it responsive to user interaction.

In one embodiment, the short-loop adaptive response logic is configured to read from the knowledge base with a latency of seconds or less to inform in-event action adjustment; wherein the long-loop long-term model training component is configured to read from and write to the knowledge base on a session-to-session basis to refine at least one of an agent assembly model and an agent decision policy; and wherein both the short-loop adaptive response logic and the long-loop long-term model training component operate over the knowledge base on different timescales.

In one embodiment, the system is configurable to operate in at least one mode selected from: a real-time adaptive assistant mode in which the dynamic network of the goal-driven software agents autonomously selects and executes actions in response to classified user states without receiving explicit user commands; a volitional signal control mode in which the dynamic network of the goal-driven software agents decodes a user intent from volitional biosignals and executes commands on external targets after passing through a confirmation gate; and a multi-agent reasoning and learning mode in which a plurality of specialist agents collaborate under a supervisor agent via an agent-to-agent protocol and access external tools via a model context protocol, wherein the system maintains and updates a user model across events. As used herein, “across events” refers to a longitudinal series of triggering events occurring over a timeframe of days or weeks; “a triggering event” refers to a single such occurrence.

In one embodiment, the system is configured to transition between the modes during operation based on at least one of the classified at least one user state, the explicit user commands, and a scheduled session context.

In one embodiment, the dynamic network of the goal-driven software agents operates autonomously without an explicit user command; wherein the at least one action produced by the dynamic network of the goal-driven software agents is directed to at least one target selected from: emergency services, stakeholder notification, and environmental actuation; and wherein the at least one action is executed without routing to a user interface.

In one embodiment, the computer-implemented system further comprises an adaptive complexity logic configured to perform intra-session state estimation from biosignal features comprising a latency, an error rate, a retry frequency, and fatigue indicators; wherein the adaptive complexity logic dynamically adjusts a complexity of outputs delivered to the user based on the intra-session state estimation, in accordance with a configurable balance between compensation of a target behavior and rehabilitation of the target behavior.

In one embodiment, the system is configured to detect repeated failures across an input modality; and wherein, responsive to detecting the repeated failures, the system automatically shifts to a different input modality, wherein selection of the different input modality is informed by a historical modality performance record of the user.

In one embodiment, the biosignal acquisition and processing subsystem is configured to receive a volitional intent signal comprising a volitional biosignal indicating an intent of the user to act, and a target signal comprising a user-directed selection of a target object, a direction, or a command; and wherein the system further comprises a confirmation component configured to evaluate a decoded intent against at least one proxy confirmation signal, permitting execution of the decoded intent on condition that no rejection signal is detected within a specified verification window.

In one embodiment, the confirmation component is configured to detect the rejection signal during or after the execution of the decoded intent; and wherein, responsive to detecting the rejection signal, the confirmation component is configured to at least one of cancel, reverse, and retry the execution in real time.

In one embodiment, the feature extraction and classification subsystem is configured to fuse a plurality of input modalities into a unified intent vector; wherein the plurality of input modalities includes at least two of: partial or degraded speech, gaze fixation or saccade patterns, gesture or pointing, symbol or touch selection, typed text input, contextual signals from an environment of the user, and biometric affect signals; and wherein a relative weighting of each of the plurality of input modalities in the unified intent vector is personalized for the user based on historical modality reliability.

In one embodiment, the dynamic network of goal-driven software agents comprises a plurality of specialist agents and a supervisor agent; wherein the plurality of specialist agents communicates via an agent-to-agent protocol; wherein one or more specialist agents of the plurality of specialist agents accesses external tools via a model context protocol; and wherein the supervisor agent selects which of the plurality of specialist agents acts at each step of a session based at least in part on the classified user state.

In one embodiment, the knowledge base comprises three cooperating tiers comprising a profile store containing user-specific category-level performance mappings, an episodic and relational memory store containing person-indexed, location-indexed, and topic-indexed prior-interaction records, and a semantic intent graph mapping intended meanings to expressions by way of a personalized semantic distance model; and wherein the three cooperating tiers are continuously updated from each session.

In one embodiment the computer-implemented system further comprises a platform orchestration layer configured to: expose a sensor-abstraction interface configured to receive biosignal input from a plurality of sensor devices conforming to a defined biosignal input protocol, wherein the sensor-abstraction interface is configured to accept sensor devices of different biosignal modalities without modification of the feature extraction and classification subsystem; expose an output-modality-abstraction interface configured to route outputs of the dynamic network of goal-driven software agents to one or more presentation surfaces conforming to a defined output protocol, wherein the one or more presentation surfaces include at least one selected from a visual display, an augmented-reality display, a haptic device, a synthesized-voice output, and a networked actuator; record, in an audit log, each received biosignal input, each classified user state, each agent decision, and each executed action, together with a timestamp and a retention-policy tag associated with each recorded entry; and apply a privacy-preserving processing policy to the multimodal biosignal data, the privacy-preserving processing policy comprising at least one of: on-device feature extraction with reduction of raw biosignal data prior to egress from a user device; application of a differential-privacy mechanism to telemetry data aggregated across users; and a configurable data-retention window applied per a user consent parameter. In one embodiment, the sensor-abstraction interface is configured to receive biosignal input from at least two sensor modalities selected from electroencephalography, heart-rate variability, electrodermal activity, eye tracking, facial expression, and voice analysis, concurrently and without reconfiguration of the feature extraction and classification subsystem.

In one embodiment, the privacy-preserving processing policy comprises on-device feature extraction such that raw biosignal data is reduced to a feature representation on a user device prior to transmission, and the audit log records the feature representation rather than the raw biosignal data.

In one embodiment, a method for driving adaptive agent behavior from biosignal data comprises acquiring multimodal biosignal data from a user; classifying the multimodal biosignal data into at least one user state; selecting, by at least one software agent, at least one action responsive to the classified at least one user state, wherein the selecting is informed by a knowledge base of historical biosignal patterns and prior outcomes; executing the selected at least one action; receiving feedback signals comprising further biosignal data and environmental data; adjusting the selected at least one action in real time based on the feedback signals with or without retraining a classifier; and periodically retraining the classifier and refining agent decision policies based on accumulated biosignal, action, and outcome data.

In one embodiment, classifying the multimodal biosignal data comprises determining a severity level for a detected state change; and wherein the executed at least one action is selected based on the severity level, wherein, when the severity level exceeds a severity threshold, simultaneous environmental, stakeholder, and emergency-service actions are triggered.

In one embodiment, periodically retraining the classifier and refining agent decision policies comprises updating a persistent user model stored in the knowledge base, such that the persistent user model evolves across events as a principal output from the events.

In one embodiment, a computer-implemented method for adapting a user interface based on a biosignal-grounded interaction history comprises: collecting, during prior sessions, multimodal time-series data comprising interaction logs, at least one of image and video, device telemetry, and electroencephalography signals; segmenting the collected multimodal time-series data into chunks keyed to a user goal and an outcome comprising one of success and failure; generating a multimodal embedding for each chunk; storing the multimodal embedding in a vector store; receiving current interaction context data and real-time biosignal data at runtime; generating a real-time multimodal embedding from the current interaction context data and the real-time biosignal data in a same latent space as the stored multimodal embeddings; retrieving, from the vector store, at least one stored multimodal embedding similar to the real-time multimodal embedding; predicting, from the retrieved at least one stored multimodal embedding, at least one of a likely next user action and a likely target stimulus; and modifying at least one interface parameter for the predicted likely target stimulus to reduce effort taken to complete the predicted likely next user action.

In one embodiment, modifying the at least one interface parameter comprises at least one action selected from: increasing a rendered size of the predicted likely target stimulus; increasing a sensitivity of a brain-computer interface classifier specifically for the predicted likely target stimulus; and bypassing a dwell or hover confirmation step for the predicted likely target stimulus in a multi-step selection paradigm.

In one embodiment, a method comprises: capturing an environmental image via a wearable device; detecting text within the environmental image; classifying the text for linguistic complexity using a real-time performance state estimate of a user; and rendering an augmented reality overlay containing at least one of a simplified text restatement, a symbol-based substitute, and an audio summary.

In one embodiment, a method comprises: receiving audio of a conversation in which a user is a participant; detecting a word-retrieval-failure event using at least one of biosignal features and audio features; identifying candidate words or concepts via a personalized semantic intent graph; and rendering the candidate words or concepts as an augmented reality overlay visible to the user and not visible to conversation partners.

In one embodiment, a method comprises: classifying an ongoing social scenario using multimodal input; retrieving encoded memories of similar prior scenarios; generating contextual cues; rendering the contextual cues as augmented reality overlays; and re-encoding the ongoing social scenario to memory upon completion.

FIG. 1 illustrates a system architecture 100 in accordance with one embodiment. The system architecture 100 comprises at least one primary user 102 wearing a wearable computing and biosignal sensing device 104. In some embodiments, multiple primary users 102 are supported. The system architecture 100 also comprises a secondary user 106 in one embodiment. In other embodiments, there may be multiple secondary users 106. The system architecture 100 includes environmental tools 108 including an input interface 110, contextual data 112, biosignal processing logic 114, and external applications 116. The system architecture 100 includes pre-processing/feature extraction logic 118, a knowledge base 120 storing historical data 122 and an accumulated logged data 124, an agent assembly model 126 generating AI agent 128. The system architecture 100 may provide a primary user interface 130 to one or more primary users 102 and a secondary user interface 132 to one or more secondary users 106. The system architecture 100 includes agentic actions 134 of the AI agent 128, monitoring/data logging logic 136, a short-loop adaptive response logic 138 supporting short-loop feedback 144, and a long-loop long-term model training component 140 supporting long-loop feedback 146. In one embodiment, the system architecture 100 includes reporting/visualization logic 142. These elements of the system architecture 100 may operate in coordination to perform the routine 200 illustrated in FIG. 2.

Real-time biosignals 148 flow from the entity (user) into the environmental tools 108, which contains biosignal processing logic 114, contextual data 112, external applications 116, and user or caregiver input interface 110. These feed pre-processing/feature extraction logic 118 that supplies the AI Agents 128 supported by the agent assembly model 126. The AI Agents 128 consult a knowledge base 120 comprising historical data 122 and accumulated logged data 124 collected during system architecture 100 operation. The AI agents 128 execute agentic actions 134, and, where applicable, route results through a user interface such as the primary user interface 130 and in some embodiments the secondary user interface 132. Agentic action outputs are monitored and logged by monitoring/data logging logic 136, and event and outcome logs 154 are written back into the knowledge base 120.

At its core, the system architecture 100 begins with real-time signals generated by a user and captured through various tools and sensors within environmental tools 108. This includes biosignal processing (e.g., EEG, HRV, eye tracking), contextual data sources, external applications, and manual input interfaces from primary users 102 or caregivers (e.g., secondary users 106). These data streams feed into pre-processing/feature extraction logic 118 that filters, organizes, and classifies incoming information into meaningful user states 150 and environmental insights 152.

Once processed, this information is routed to a dynamic network of AI agents 128 responsible for real-time classification, decision-making, and task execution. These AI agents 128 reference a continually updated knowledge base 120 that includes both historical data 122 and accumulated logged data 124 from ongoing data collection from biosignals and behavior logs. Based on the user's current state, AI agents 128 may generate adaptive agentic actions 134—such as triggering interventions, altering interfaces, or coordinating with smart devices. All outputs and agent decisions are monitored and logged by monitoring/data logging logic 136 to support immediate feedback (short-loop feedback 144) from the short-loop adaptive response logic 138, long-term learning (long-loop feedback 146) through the long-loop long-term model training component 140, and continuous refinement. This modular and agent-driven architecture allows for flexibility across diverse use cases, while maintaining a consistent feedback loop that prioritizes user context and safety.

The short-loop adaptive response logic 138 may serve as a high-speed feedback module that monitors real-time biosignals, behavioral cues, and environmental signals, including those captured remotely via WiFi, infrared, or other non-contact methods—to dynamically adjust agent behavior and system output. Unlike long-term model training, which updates over time, the short-loop adaptive response logic 138 intervenes in seconds-fine-tuning actions, suppressing or modifying agent commands, and reconfiguring interface elements based on moment-to-moment fluctuations in cognitive, emotional, or physiological state. These immediate adjustments allow the system to remain responsive, safe, and entity-centered in volatile or high-stakes conditions, whether the entity is an active system user or passively observed subject.

The short-loop adaptive response logic 138 may in some embodiments provide the exemplary adjustments that follow. These examples illustrate the flexibility and responsiveness of the system, but the list is not exhaustive. The short-loop adaptive response logic 138 is designed to operate as a general-purpose control layer capable of adapting to a wide range of biosignal inputs, agent types, and interaction contexts, and its specific behaviors may be extended or specialized depending on the domain of use. In this manner, the short-loop adaptive response logic 138 may: reduce UI prompt complexity under high cognitive load; slow dialogue pacing when user shows fatigue or stress; increase classifier sensitivity when signal strength degrades; pause robotic actions upon detection of error-related potentials (ErrPs); dim ambient lighting in response to overstimulation; activate calming haptic feedback (e.g., wristband vibration); auto-confirm user selection when intent is confidently inferred; cancel or re-route robotic navigation upon stress escalation; expand UI hitboxes when motor precision degrades; delay non-essential prompts if user shows signs of overload; trigger breathing cue visual when emotional escalation is detected; shift to simpler question phrasing if misunderstanding is inferred; temporarily suppress low-confidence agent responses; highlight relevant UI elements when gaze scatter increases; display positive reinforcement when user appears uncertain; offer break prompt after prolonged engagement with declining HRV; suppress caregiver notifications unless critical thresholds are crossed; escalate to caregiver override when system uncertainty exceeds safe limits; trigger object safety lock (e.g., stove, door) when confusion and stress co-occur; replace long-form input with multiple-choice options during fatigue; introduce humor or affirmation in emotionally flat sessions; auto-switch UI modality (e.g., switching from text to icons) under gaze instability; reduce stimulus frequency when EDA spikes are sustained; insert recall cue if memory strain is detected mid-task; reroute planned agent path if user rejects same type of question twice; reorient robot's camera or arm when user's gaze suggests misalignment; increase confirmation timeout when blink rate increases; provide caregiver-facing alert while keeping user UI calm; preload backup plan for next agent in case of user disengagement; hide emotionally triggering options from current display; highlight most successful past selections for decision support; re-cue abandoned task after stabilization; shift AR visual overlays into neutral gaze zone; display interactive summary when cognitive state begins to rebound; reduce environmental sound level if HRV and gaze indicate strain; initiate background logging mode when user needs rest; reschedule non-critical tasks detected during fatigue; trigger routine-based reminders when time-of-day strain pattern appears; dynamically reassign agent roles based on recent failures; elevate the Supervisor Agent's priority to override all non-critical agents during crisis; adjust environmental audio or light output when remote sensing indicates an entity's presence behind obstacles; trigger indirect system activation when passive motion is detected in expected care zones via WiFi-based localization; suppress vocal prompts when thermal imaging or infrared indicates the entity is asleep or inactive; redirect notification from voice assistant to silent UI display when entity is inferred to be in conversation (via acoustic occlusion); trigger preemptive caregiver alert when multiple entities (e.g., visitors) enter monitored space unexpectedly; trigger aerial camera focus or autonomous drone tracking when avian EEG detects gaze fixation on ground targets; activate alert system when migratory birds' magnetoreception shifts suggest geomagnetic anomalies; deploy acoustic sensor calibration routines in natural reserves when animal EEG signals indicate discomfort due to noise pollution; initiate pollination or agricultural response systems when bee neural signals detect optimal flower patterns or locations; and suppress nearby drone or vehicle movement when equine EEG indicates agitation or perceived threat in shared environments.

Disclosed embodiments and additional configurations of the framework may includes all of the components listed above and may operate with a multimodal biosignal front-end (including EEG, HRV, EDA, eye tracking, and optionally facial expression and voice analysis), a streaming feature extraction and classification pipeline, a dynamic agent assembly capable of instantiating specialist agents as needed, a persistent knowledge base supporting both structured stores and vector-indexed retrieval (RAG), and an explicit separation of the short-loop adaptive response logic from the long-loop long-term model training component.

FIG. 2 illustrates an example routine 200 performed through the operation of the system architecture 100 introduced in FIG. 1. Although the example routine 200 depicts a particular sequence of operations, the sequence may be altered without departing from the scope of the present disclosure. For example, some of the operations depicted may be performed in parallel or in a different sequence that does not materially affect the function of the routine 200. In other examples, different components of an example device or system that implements the routine 200 may perform functions at substantially the same time or in a specific sequence.

According to some examples, the method includes receiving biosignals and additional inputs from the user(s) and wearable computing and biosignal sensing device(s) at block 202. For example, the environmental tools 108 illustrated in FIG. 1 may receive biosignals and additional inputs from the user(s) and wearable computing and biosignal sensing device(s). Real-time data from biomonitoring sensors, user interactions, and environmental inputs may be collected. Raw signal data may be filtered with Fourier transforms, wavelet decomposition, or similar signal processing techniques. Time-series data may be tokenized with tokenizers trained on prior data. Processed data may be organized and sent to AI agents 128 and knowledge base 120.

According to some examples, the method includes aggregating biosignals and other inputs as environmental data at block 204. For example, the environmental tools 108 illustrated in FIG. 1 may aggregate biosignals and other inputs as environmental data.

According to some examples, the method includes receiving environmental data from environmental tools and retrieving historical data from the knowledge base at block 206. For example, the pre-processing/feature extraction logic 118 illustrated in FIG. 1 may receive environmental data from environmental tools and retrieve historical data from the knowledge base. Stored biosignal trends, baselines, and patterns relevant to the user or application context may be retrieved, along with records of past actions taken by agents and the outcomes to inform future decision strategies. Relevant user-specific, environmental, or situational context (e.g., preferences, schedules, common patterns) may also be retrieved. Pre-trained biosignal classifiers may be loaded.

According to some examples, the method includes pre-process and extract features from environmental and historical data at block 208. For example, the pre-processing/feature extraction logic 118 illustrated in FIG. 1 may pre-process and extract features from environmental and historical data. Noise, artifacts, and irrelevant signal fluctuations may be removed from raw biosignals. Raw data may be transformed into meaningful features for interpretation. Cleaned features may be classified into cognitive, emotional, or behavioral states for agentic use. Signal complexity may be reduced using dimensionality reduction to highlight key features for efficient classification.

According to some examples, the method includes assembling AI agent based on environmental and historical data at block 210. For example, the agent assembly model 126 illustrated in FIG. 1 may assemble AI agent based on environmental and historical data. An agentic environment may be assembled based on system goals, current context, and agent-specific biosignal expectations. AI agents may be aligned to the task with each agent configured by assigning roles and tasks. Agents may be configured to collaborate and share data in real time.

According to some examples, the method includes executing agentic actions in support of the user(s) at block 212. For example, the AI agent 128 illustrated in FIG. 1 may execute agentic actions in support of the user(s). Actions may be executed based on estimated user goals and system objectives. Actions may be adjusted in real-time based on feedback and contextual data.

According to some examples, the method includes receiving user feedback on agentic actions at block 214. For example, the monitoring/data logging logic 136 illustrated in FIG. 1 may receive user feedback on agentic actions. Real-time feedback from the user, biosignals, or environmental context may be received. This feedback may indicate whether the system's actions were appropriate or need adjustment. In one embodiment, real-time feedback from the user, biosignals, or environmental context may indicate whether the system's actions were appropriate or need adjustment.

According to some examples, the method includes monitoring AI agents and log data at block 216. For example, the monitoring/data logging logic 136 illustrated in FIG. 1 may monitor AI agents and log data. Performance data, task success, biosignal changes, and behavioral outcomes may be logged to monitor the effectiveness of actions. Event completion may be determined and the feedback loop exited. A traceable record of interactions and events may be created to support both immediate and future learning.

According to some examples, the method includes improving AI agent behavior during operation at block 218. For example, the short-loop adaptive response logic 138 illustrated in FIG. 1 may improve AI agent behavior during operation. The system architecture 100 may use real-time feedback and monitoring data to make short-term adjustments to agent behavior and improve responsiveness in the moment without retraining models.

The short-loop adaptive response logic 138 may provide real-time feedback about action success or failure based on biosignals and environment status. The system uses feedback and monitoring data to make short-term adjustments to behavior. Feed adjustments continuously without waiting for long-term, model retraining. Adjusted decisions and updated actions may be fed back immediately without waiting for long-term retraining actions.

According to some examples, the method includes improving agent assembly model performance at block 220. For example, the long-loop long-term model training component 140 illustrated in FIG. 1 may improve agent assembly model performance. Event data may be provided to drive model retraining and personalization. Trends and patterns in the data may be analyzed. Aggregate data from feedback and monitoring may be used to update models including classifiers, prediction engines, and agent strategies. System behavior may be refined by updating models based on cumulative feedback and event data. Persistent personalization and smarter decision-making over time may be thus supported. Biosignal classifiers may be updated and thresholds refine for gaze duration, blink frequency, and fatigue markers. This may support smarter agent selection, updated agent prompts and updated biosignal expectations.

According to some examples, the method includes providing reports and visualizations on agent assembly model performance and improvement at block 222. The routine 200 comprises a short-loop feedback 144 and a long-loop feedback 146. Reports and dashboards may be generated showing how feedback and adaptation have shaped system behavior. These may provide transparency to users, caregivers, or researchers and support trust evaluation, or research.

Described more generally, the system operation begins with Bio-monitoring & Data Collection, where real-time physiological and contextual data—such as EEG, HRV, eye tracking, and environmental inputs—are continuously captured from the user and their surroundings. In parallel, the system performs Historical Data Retrieval, loading relevant past biosignal patterns, behavioral trends, user preferences, and prior intervention outcomes. This combination of live and stored data flows into the Pre-processing & Feature Extraction stage, where raw signals are cleaned, transformed into structured features (e.g., cognitive load levels, engagement markers), and classified into high-level user states like fatigue, confusion, or motor intent.

These states inform the Agentic Assembly, where one or more agents are orchestrated based on the user's current condition and the system's goals. In some use cases, a Supervisor Agent may coordinate this process, while in others, agent routing may be distributed or task-specific. Once activated, agents perform Action Execution-triggering UI changes, physical device control, or environmental interventions. As actions are carried out, the system collects Feedback Signals from biosignals, user behavior, and environmental sensors. These signals are first processed by the Monitoring & Data Logging module, which both records events and exposes relevant real-time data to the Adaptive response logic. The adaptive response logic uses this feedback stream to make immediate, short-loop adjustments to ongoing actions (e.g., pausing, simplifying, escalating), while all collected data contributes to Long-Term Model Training that refines future agent behavior and classifier performance. Finally, Reporting & Visualization outputs tailored summaries to users, caregivers, or analysts—while respecting privacy boundaries and display filtering.

The feedback loop captured in the routine 200 below incorporates the dual-timescale feedback structure common across various embodiments. Historical Data Retrieval and Bio-monitoring/Data Collection feed the Preprocessing & Feature Extraction stage, which provides features to the Agentic Assembly. Action Execution produces Feedback Signals, which inform both the Adaptive response logic (immediate adjustments, short-loop) and the Monitoring and Data Logging component. Monitoring and Data Logging drives Long-Term Model Training (aggregate model refinements, long-loop) and optional Reporting and Visualization. Each approach in the embodiments disclosed herein specializes this generic loop with its own memory stores and decision logic.

FIG. 3 illustrates a RAG index data and inference pipeline 300 in accordance with one embodiment. The RAG index data and inference pipeline 300 may comprise multimodal RAG index data development 302 and a real-time inference operation 304. In the multimodal RAG index data development 302, an interaction log 306 may be processed into a text embedding 308, images/video 310 may be used to generate an image embedding 312, device telemetry 314 may be captured in a text embedding 316, and EEG data 318 may be processed into a spectrogram/filtered waveforms 320. Multimodal RAG index data development 302 may aggregate these into multimodal embedding 322.

The multimodal embedding 322 may be stored in a vector store 324 feeding the real-time inference operation 304, which includes a semantic similarity search 326 and a user interface AI agent 328 informed by contextual data 330 and real-time multimodal embedding 332 of biosignal data/sensor data 334. The user interface AI agent 328 may generate a next action prediction 336. This may trigger hover on predicted likely target stimulus 338, may increase sensitivity of a predicted likely target stimulus 340, and/or may enlarge a predicted likely target stimulus 342.

The disclosed method operates in two phases: an offline indexing phase and a real-time inference phase. In the indexing phase, time-series data logged during prior user interactions is collected, segmented into chunks keyed to the user's goal at the time and whether the interaction was successful, and embedded into a multimodal vector store. In the inference phase, a UI agent receives the current context and real-time biosignal data, embeds them into the same latent space, performs semantic similarity search against the vector store, and uses the retrieved similar past situations to predict the user's likely next action. The prediction is fed back to the interface, which adapts pre-emptively to make the predicted action easier to complete.

Interaction Logs are text records of user behavior within the interface, embedded as text vectors. Images and Video (User View, Camera View) provide visual frames from device-mounted or separate cameras, embedded as image vectors. Telemetry includes device performance and interaction telemetry, embedded as text vectors. EEG data is provided by scalp or in-ear electrode signals, represented as spectrograms and filtered waveforms prior to embedding.

All four of these data streams are combined into a joint multimodal embedding and stored in a vector store keyed to the goal and outcome of the interaction chunk from which they were derived.

At run time, the UI agent receives the current interaction context and live multimodal biosignal data (EEG, biosignal streams, interaction images, and telemetry). These are embedded in the same latent space as the indexed store and submitted to a semantic similarity search.

A semantic similarity search retrieves items such as documents, sentences, product descriptions, code, or images that are meaningfully related to a query based on content and meaning rather than on exact keyword overlap. The core idea is to convert both the query and candidate items into dense vector representations, called embeddings, that capture semantic information. Retrieval is then performed by comparing the query vector to item vectors in the embedding space and selecting the items whose vectors are nearest the query vector according to a chosen similarity metric.

Semantic similarity search differs from lexical or keyword search because it matches concepts and paraphrases rather than literal tokens and exact phrases. This enables retrieval of relevant results even when the query and the candidate contain different surface words or are in different languages. A typical pipeline encodes each document and each query with an embedding model, stores the document vectors in a vector index, computes a vector for the incoming query, and performs a nearest-neighbor search to find the top-k closest vectors. Many systems also apply an optional re-ranking step using a more expensive cross-encoder model or business rules to improve precision.

Common similarity measures include cosine similarity and inner product, with Euclidean distance sometimes used depending on the embedding normalization and model characteristics. The choice of metric may affect both retrieval behavior and how embeddings may be normalized or postprocessed. In one embodiment, cosign similarity may indicate a high similarity between two vectors when their similarity score approaches a value of 1. Other score quantities and appropriate thresholds indicating adequate similarity based on similarity search types will be appreciated one of ordinary skill in the art. Exact nearest-neighbor search becomes computationally expensive at large scale, so production systems typically use approximate nearest neighbor algorithms such as HNSW, IVF, or product quantization. These algorithms are implemented in libraries and services including FAISS, Milvus, Pinecone, and Weaviate, which provide tradeoffs between accuracy, latency, and storage.

Frequent use cases for semantic similarity search include document and passage retrieval for question answering, semantic code search, recommendation systems, deduplication, and cross-lingual information retrieval. The primary advantages of semantic search are improved recall for paraphrases, synonyms, and conceptual matches, and the ability to perform fuzzy and cross-lingual matching. These benefits depend on embedding quality and the suitability of the model for the domain. There are several challenges and tradeoffs. Embedding quality limits retrieval accuracy, approximate nearest neighbor methods introduce approximation error, vector dimensionality affects storage and latency, and embeddings may drift as the underlying data distribution changes, necessitating reindexing. Semantic search may also reduce explainability compared with keyword-based methods and may need additional filtering to enforce precise constraints. Recommended practices include combining vector search with keyword filters or using a hybrid ranking that blends lexical and semantic signals, normalizing or tuning embeddings for the chosen similarity metric, applying re-ranking for precision-sensitive tasks, and monitoring retrieval quality and latency. Evaluation may use metrics such as Recall@k, nDCG, and MAP.

If the search retrieves prior situations similar to the current one, the UI agent uses those retrieved situations to predict the most likely next action or target for the user. The prediction drives one or more of the following pre-emptive interface adaptations. A predicted target stimulus may be rendered larger in the visual interface to reduce selection error. The sensitivity of the SSVEP or other brain computer interface (BCI) classifier may be increased specifically for the predicted target stimulus, reducing the signal threshold needed to register a selection. In a two-step hover-then-click interaction paradigm, the hover step may be bypassed for the predicted target, allowing the user to complete the action in a single step. The hover trigger may also be pre-activated on the predicted target stimulus to further reduce interaction latency. This inference pipeline is shown in FIG. 3.

The operation of the RAG index data and inference pipeline 300 is orthogonal to the architectural approaches and embodiments described below. The RAG index data and inference pipeline 300 may be deployed as a layer within any of them. In a Real-time Adaptive Assistant deployment, it provides proactive UI simplification driven by predicted user focus. In a Volitional Signal Control deployment, it reduces the number of steps needed to complete a command by pre-activating the most likely target stimulus. In a Multi-Agent Reasoning and Learning deployment, the multimodal vector store described here is structurally analogous to the session RAG store in that diagram and may share infrastructure with it, with the distinction that this store is indexed on interaction-outcome chunks rather than dialogue-session chunks.

This method facilitates navigation and interaction in an interface that accepts biosignals such as eye-tracking and EEG. When using the device, time-series data is logged, including the user's behaviors in the interface, images and video from cameras on the device or a separate computer, telemetry data from the device, eye-tracking data from the device or a separate system, and EEG data from sensors on the scalp or in the ear.

These data are stored and post-processed into ‘chunks’ based on the user's goal at the time and whether the behavior was successful. Each chunk is then embedded in a multimodal vector store. The multimodal embeddings may be in the form of, for instance, image-with-caption using Amazon Titan, or pure multimodal embeddings with Cohere.

Once the vector store is built, a UI agent may be developed that will consume current context and biosignals, interpret/pre-process the incoming signals, embed them in the same latent space as the vector store, and autonomously conduct semantic similarity search of the vector store. If it finds previous situations similar to the current one, it may predict the next action or actions (the target) by the user. This prediction is fed back to the system, which adapts by making it easier for the user to take that action. This may be done by, for instance, making the target larger in the visual interface, increasing the sensitivity of the SSVEP classifier, and/or skipping the ‘hover’ step in a two-step hover-click interaction paradigm.

FIG. 4 illustrates a real-time adaptive assistant 400 in accordance with one embodiment. The real-time adaptive assistant 400 specializes the general architecture shown in FIG. 1. As such, the real-time adaptive assistant 400 includes a knowledge base 120, agentic action 134, monitoring/data logging logic 136, short-loop adaptive response logic 138 providing short-loop feedback 144, and a long-loop long-term model training component 140 providing long-loop feedback 146.

The real-time adaptive assistant 400 may recognize a triggering event 402 when the system autonomously detects a state change necessitating response. An active event 404 includes new or ongoing agentic actions 134. Observation 406 may support generation of short-loop feedback 144 based on continuous biosignal and environmental monitoring. An assessment 408 may allow the short-loop adaptive response logic 138 to make in-event action adjustments 410. For example, if state trends stabilize, the short-loop adaptive response logic 138 may direct the system to scale back the response and/or narrow the scope of agentic actions 134, and return to passive monitoring. If state trends worsen the short-loop adaptive response logic 138 may modify or escalate the response (adjust strategy, scope, or intensity). The short-loop adaptive response logic 138 may thus support the real-time adaptive assistant 400 in continuously adapting without waiting for long-term model retraining. In this manner, through closed-loop response adjustment during the active event 404, the response strategy, escalation pathway, and active AI agent 128 selection may be improved within seconds, while the active event 404 is ongoing.

Also upon recognizing the triggering event 402, and across events 412 and a timeframe of days or weeks, an aggregated event history refining classifiers and decision policies may be developed. The monitoring/data logging logic 136 may record signal trends, actions, and resolved event outcomes. An aggregation and analysis 414, stage may correlate signal patterns with actual event outcomes. This may allow the long-loop long-term model training component 140 to improve classifier accuracy (reduce false positives and false negatives), identify which response strategies produced the best outcomes, personalize detection thresholds per entity or user, and update agent coordination and escalation logic. Over time, this supports improvement of detection accuracy, personalized thresholds, and response effectiveness.

The knowledge base 120 of the real-time adaptive assistants 400 may be an event-centric knowledge base including memory stores such as event history 416, outcome records 418, context patterns 420, user baselines 422, and external overrides 424. The event history 416 may include signal trends, timing, and actions taken during prior events. The outcome records 418 may include which response strategies resolved events successfully and which did not. The context patterns 420 may include contextual factors that correlate with event occurrence. The user baselines 422 may include personalized normal ranges and detection thresholds. The external overrides 424 may include false-positive flags and manual corrections, used during long-loop retraining. The short-loop adaptive response logic 138 may perform real-time queries 426 to retrieve data from the memory stores. The long-loop long-term model training component 140 may perform a training pull 428 to retrieve data from the memory stores, and may support event logging 430 back to them.

The Real-time Adaptive Assistant continuously monitors biosignals and contextual data, detects state changes of interest, and intervenes without needing user input. The system is defined by its autonomy: the user does not issue commands, and the system does not wait for permission before acting. Intervention may take the form of adjusting the environment, alerting stakeholders, initiating a protocol, or escalating to emergency services. The user's role is passive; the system is the active party throughout.

In one embodiment, classifiers run continuously on incoming biosignal and environmental streams. No triggering user action is needed. Decision-making is event-based. When a classifier indicates a state of interest has been reached, agents execute a response strategy immediately. Outputs typically bypass the user interface. Actions are directed at the environment, at stakeholders other than the user, or at external services. The system operates across a full spectrum of risk levels, from benign ambient adjustments up to emergency escalation, all without user prompting.

Flow is unidirectional: biosignals from the passive user flow through Tools/Environment and Pre-Processing into the AI Agents, and actions flow outward to external targets. The user interface is minimal or absent because the system does not need user prompts. The Knowledge Base provides historical context to ground decisions and receives event data from all actions.

The Tools and Environment layer is composed of four primary input types. Biosignal Processing delivers continuous multimodal physiological streams from sensors such as EEG, HRV, EDA, and eye-tracking hardware. Environmental Sensors capture contextual ambient data, such as light level, temperature, and noise. Wearable Sensors provide a dedicated continuous stream of biometric data from devices the user wears during normal activity. An optional External Override permits a caregiver, stakeholder, or proxy agent to dismiss false alarms or correct misclassifications; this input is passive in that the system does not wait for it.

Pre-Processing and Feature Extraction cleans raw biosignals, extracts features relevant to the states of interest, and outputs a classified state or state-change event. The AI Agents component receives classified state and, when an event of interest is detected, selects and executes one or more response actions. Agents consult the Knowledge Base to ground decisions in historical context and user-specific baselines.

Actions are directed at four categories of external target: Emergency Escalation (alerts to emergency services with contextual information such as location); Stakeholder Notification (real-time alerts to designated parties such as caregivers or supervisors); Environmental Actuation (IoT or ambient device control); and Monitoring and Data Logging (recording the event, action, and outcome for later analysis). All four categories may be active simultaneously.

In one embodiment, the decision flow is continuous rather than triggered. Biosignals and environmental data stream into the system without interruption. Features are extracted and classifications updated at a cadence appropriate to the state being monitored, typically sub-second for acute events and several seconds to minutes for gradual trends. When the classifier crosses a threshold indicating a state change, the AI agents immediately assemble a response plan. The plan is tailored to the severity of the detected state: low-severity events may trigger an environmental adjustment, while high-severity events simultaneously trigger environmental, stakeholder, and emergency actions.

Within an active event, the Adaptive response logic cycles continuously. Feedback Signals (ongoing biosignal and environmental monitoring) report whether the intervention is having the desired effect. If state trends worsen, the adaptive response logic modifies or escalates the response by adjusting strategy, scope, or intensity. If state trends stabilize, the adaptive response logic scales back the response, narrows its scope, and returns to passive monitoring. These adjustments occur without waiting for long-term model retraining.

Between events, accumulated data feeds the Long-Term Model Training process. Event history, outcomes, and context patterns are aggregated and analyzed to identify correlations between signal patterns and outcomes. The training process improves classifier accuracy, identifies which response strategies produced the best outcomes, personalizes detection thresholds per entity, and updates agent coordination and escalation logic. Outputs of the long-loop are deployed as updated models and thresholds for the short-loop to use on subsequent events.

FIG. 5 illustrates a volitional signal control system 500 in accordance with one embodiment. The volitional signal control system 500 specializes the general system architecture 100 shown in FIG. 1. As such, the volitional signal control system 500 includes a knowledge base 120, agentic action 134, monitoring/data logging logic 136, short-loop adaptive response logic 138 providing short-loop feedback 144, and a long-loop long-term model training component 140 providing long-loop feedback 146.

The system may recognize a triggering event 502, such as a user-originated intent detected from volitional biosignals. An active event 504 may begin, including real-time intent verification and action correction. The active event 504 may include agentic actions 134 wherein a decoded command is carried out on an external target. Actions may be subject to monitoring 506, which may generate short-loop feedback 144 including user proxy signals of approval, rejection, or discomfort. Assessment 508 of the feedback may allow the short-loop adaptive response logic 138 to direct the volitional signal control system 500 to make in-event action adjustments 510. Detection of a rejection signal may trigger cancellation or reversal of an action in real-time. Detection of ambiguity may generate a request for confirmation from user or a trusted proxy agent. Detection of fatigue or stress detected may result in slower interaction and/or lower command sensitivity. In this manner, the short-loop adaptive response logic 138 may direct improvements to the confirmation threshold, interaction pace, and cancel/retry state within seconds, during the active event 504.

Also upon recognizing the triggering event 502, and across events 512 and a timeframe of days or weeks, the long-loop long-term model training component 140 may support the volitional signal control system 500 in personalizing intent decoding and anticipating recurring user patterns. Monitoring/data logging logic 136 may log commands, errors, overrides, success rate, and context of each action. This may inform an aggregation and analysis 514 stage, which may correlate decoded intent with confirmed success and detect recurring patterns. Based on this, the long-loop long-term model training component 140 may fine-tune intent-decoding and rejection-signal classifiers for particular users. Confirmation and cancellation thresholds may be personalized to individual patterns. Detection and learning of recurring usage patterns may improve the system's ability to anticipate likely next commands from context. Over time, this supports improvement of decoding accuracy and next-action prediction and reduces override rates.

The knowledge base 120 of the volitional signal control system 500 may be user-specific intent and control knowledge base including memory stores such as intent profiles 516, command history 518, pattern memory 520, target preferences 522, and learned demonstrations 524. Intent profiles 516 may store per-user signal signatures and calibration data used to decode volitional signals. Command history 518 may include past commands together with confirmation outcomes (confirmed, rejected, or overridden). Pattern memory 520 may include time- and context-linked recurring command patterns for anticipatory behavior. Target preferences 522 may store default settings, avoidance rules, and personalization parameters. Learned demonstrations 524 may store multimodal examples of trusted-agent actions for imitation. The short-loop adaptive response logic 138 may perform real-time queries 526 to retrieve data from the memory stores. The long-loop long-term model training component 140 may perform a training pull 528 to retrieve data from the memory stores, and may support event logging 530 back to them.

The Volitional Signal Control System interprets user-initiated biosignals as intentional commands, decodes what the user wants to do, confirms the decoded intent, and acts on an external target on the user's behalf. Unlike the Real-time Adaptive Assistant, this approach is active rather than passive; the user is the initiator, and the system waits for an explicit volitional signal before doing anything. The primary output is an external action in the physical or digital environment, not a conversational or informational response.

In one embodiment, the system distinguishes two types of volitional signal: an intent signal (the “when”: that the user wants to do something) and a target signal (the “what”: the specific object, direction, or command). Decoded intent passes through a Confirmation Gate before action is taken. The gate verifies the decoded intent against proxy confirmation signals such as error-related potentials, gaze aversion, or explicit approval from a trusted proxy agent. Rejection signals detected after action has begun may cancel or correct the action mid-execution. Actions are directed at external targets in the environment: manipulators, mobility devices, IoT-connected ambient equipment, or stakeholder-facing interfaces.

The flow begins with the user issuing a volitional signal, which enters through the Tools/Environment layer. Pre-Processing and Feature Extraction performs intent-plus-target fusion. The AI Agents produce a candidate action, which passes through a Confirmation Gate before reaching the Action output. User proxy signals (rejection, discomfort, gaze aversion) feed back into the gate and the agents during and after execution. The Knowledge Base provides per-user intent profiles and calibration data.

The Tools and Environment layer in this approach explicitly separates two complementary channels. The Intent Signal channel captures the volitional effort to initiate an action as well as error-related potentials that indicate rejection. The Target Signal channel captures the user's selection of a specific target object, direction, or command. These two signals are fused downstream to produce a single decoded command. A Physiological State channel provides ancillary signals of fatigue, arousal, or discomfort. Environmental Sensors capture obstacle locations and target positions. A Proxy Interface permits a trusted agent (for example, a caregiver or supervisory AI) to confirm ambiguous commands or override actions on the user's behalf.

Pre-Processing and Feature Extraction performs intent-plus-target fusion: it combines the two volitional channels into a single candidate command. The AI Agents component contains specialized agents for navigation, manipulation, environment control, safety monitoring, engagement tracking, and context memory. The AI agents' output is a candidate action rather than a finalized action.

The Confirmation Gate is the component that most distinguishes this approach. Before the candidate action is executed, the gate verifies it against live feedback from the user: error-related potentials, gaze aversion, physiological stress indicators, or explicit proxy confirmation. If no rejection signal is detected within a short window, the action proceeds. If a rejection signal is detected, the action is canceled before execution or, if already begun, reversed.

The decision flow is initiated by the user. When an intent signal is detected, the system begins decoding. The target signal is sampled and fused with the intent signal to produce a candidate command. The candidate passes into the AI agent network, where the appropriate specialist agent is selected and the command is refined into an executable action plan. The action plan is submitted to the Confirmation Gate. The gate watches for rejection signals during a configurable verification window; if none arrive, the action is executed. If rejection is detected after execution has begun, the gate signals the agent network to cancel, reverse, or retry the action.

The Adaptive response logic is concerned with in-flight verification and correction. When a rejection signal is detected during or after action execution, the adaptive response logic cancels or reverses the action in real time. When ambiguity is detected in the decoded intent, the adaptive response logic requests confirmation from the user or trusted proxy rather than executing. When fatigue or stress is detected, the adaptive response logic slows the interaction, increases dwell time on target selection, and lowers command sensitivity to reduce the rate of incorrect decodings.

Between sessions, accumulated command logs and outcome records are used to fine-tune the intent-decoding and rejection-signal classifiers on a per-user basis. Confirmation and cancellation thresholds are personalized to individual patterns. The training process also learns recurring usage patterns (for example, a user's typical morning routine) and builds predictive models that anticipate likely next commands from contextual cues.

FIG. 6 illustrates a multi-agent reasoning and learning system 600 in accordance with one embodiment. The multi-agent reasoning and learning system 600 specializes the general system architecture 100 shown in FIG. 1 by expanding the AI Agents component into a cluster of specialist agents under a Supervisor. As such, the multi-agent reasoning and learning system 600 includes a knowledge base 120, agentic action 134, monitoring/data logging logic 136, short-loop adaptive response logic 138 providing short-loop feedback 144, and a long-loop long-term model training component 140 providing long-loop feedback 146.

The system may recognize a triggering event 602, such as a user providing input or response within an interaction session. An active event 604 may begin, including live orchestration across collaborating specialist agents. The active event 604 may include agentic actions 134 wherein a supervisor may select an agent and strategy for the next interaction step. Actions may be subject to sensing 606, which may generate short-loop feedback 144 including biosignals, behavioral cues, and context of the user response. Classification 608 of the feedback may allow the short-loop adaptive response logic 138 to direct the volitional signal control system 500 perform in-event re-routing 610. For example, the short-loop adaptive response logic 138 may detect a high cognitive load and may reduce the complexity of agent outputs. Hesitation or stress may, when detected, lead to supervisor suppression or deference of sensitive agent paths. Disengagement may lead to re-routing 610 to a different agent or a reframing of an agent's approach to re-engage the user. This allows the multi-agent reasoning and learning system 600 to improve agent selection, interaction complexity, and agent orchestration within seconds, during the active event 504.

Also upon recognizing the triggering event 602, and across events 612 and a timeframe of days or weeks, the long-loop long-term model training component 140 may support the multi-agent reasoning and learning system 600 in retained context drives agent behavior across events. Monitoring/data logging logic 136 may record, for every step of an action, inputs, responses, signal traces, and rejected paths. This may inform an aggregation and analysis 614 stage, which may flag high-engagement moments and recurring response patterns. Based on this, the long-loop long-term model training component 140 may extend the user model preferences, traits, and recurring response patterns, refine per-agent strategies based on which approaches produced the strongest outcomes, and re-index session context into the RAG store for future retrieval across all agents. Over time, this supports improvement of user model depth, agent personalization, and cross-session continuity.

The knowledge base 120 of the multi-agent reasoning and learning system 600 may be an RAG-based user and interaction knowledge base including memory stores such as session RAG store 616, user models 618 response traces 620, session insights 622, and rejected paths 624. The session RAG store 616 may include vector-indexed prior interactions and responses, queried at every step. The user model 618 may store evolving traits, preferences, and interaction history. It may be updated directly by the long-loop long-term model training component 140. Response traces 620 may store biosignal patterns tied to specific input types, used to anticipate user state in future sessions. Session insights 622 may store agent-flagged key moments and outcomes, summarized for stakeholder review. Rejected paths 624 may store skipped approaches and hesitation patterns, used to avoid unproductive directions in future sessions. The short-loop adaptive response logic 138 may perform real-time queries 626 to retrieve data from the memory stores. The long-loop long-term model training component 140 may perform a training pull 628 to retrieve data from the memory stores, and may feed event logging and user model updating 630 back to them.

The Multi-Agent Reasoning and Learning system uses several specialized agents that collaborate over time to build a rich understanding of the user and to interact with the user through multi-turn sessions. Unlike the Real-time Adaptive Assistant, this approach is interactive and foregrounded; the user is a full participant in each session. Unlike the Volitional Signal Control System, the primary output is not a single executed action but an evolving sequence of responses, insights, and prompts. The defining feature is that the long-term memory of the system—particularly its model of the user—is itself the core product.

This system continuously monitors EEG, HRV, EDA, and environmental inputs to detect early warning signs of seizure activity and trigger proactive, adaptive interventions. A set of agents responds to classified risk states by alerting caregivers, adjusting environmental conditions, or initiating calming protocols. Realtime biosignal feedback drives continuous adaptation of these interventions, while all performance and biosignal trends are logged to improve classifier accuracy and refine agent coordination over time. The system is designed for safety, personalization, and minimal user disruption.

In one embodiment, multiple specialized agents collaborate via an Agent-to-Agent (A2A) protocol. A Supervisor Agent orchestrates collaboration, controlling which specialist acts at each step and how outputs are combined. Agents call external tools via the Model Context Protocol (MCP) to retrieve information, validate claims, or perform structured lookups. Every step of every session is grounded in a Retrieval-Augmented Generation (RAG) knowledge base containing prior sessions, live signal traces, and an evolving user model. Outputs are audience-filtered: user-facing (typically minimal and supportive), stakeholder/analyst-facing (typically detailed). Long-term training updates the user model itself, not just classifiers or thresholds. The memory is the principal product.

User biosignals, behavioral cues, and semantic content all enter the Tools/Environment layer, are combined in Pre-Processing, and passed to the specialist cluster. The Knowledge Base is not a supporting store in this approach but the principal product: a RAG-backed, cross-session memory queried by every specialist on every step, and updated directly by the long-loop training process. Outputs are routed through an audience-filtering stage that distinguishes user-facing, stakeholder-facing, and analyst-facing content.

The Tools and Environment layer delivers biosignal streams (physiological state), behavioral analysis (expression, tone, pacing), semantic analysis (content, sentiment, intent of the user's input), and external tools accessed via MCP (for research, validation, or structured lookups). Pre-Processing and Feature Extraction fuses these into a combined user state and context representation.

The AI Agents component is explicitly a cluster of specialists under a supervisor. The Supervisor Agent orchestrates flow and escalation, selecting which specialist acts at each step and deciding when to escalate to a higher-authority view. The specialist agents include an Interaction agent that delivers prompts and adapts pacing; an Insight agent that extracts patterns from user responses; a Retrieval agent that performs external lookups via MCP; a State Monitor that interprets user affect and cognitive load; a User Model agent that maintains the evolving profile; and a Filter/Safety agent that distinguishes between internal (user-facing) and external (stakeholder-facing) views. Specialists communicate via the A2A protocol.

The Knowledge Base is more than a supporting store; it is the principal product. It contains prior sessions (vector-indexed for retrieval), live logs plus biosignal traces, and an evolving user profile with cumulative insights. Every specialist reads from this store on every step.

Outputs are routed to three categories of audience through the Filter/Safety agent. User-facing output is typically minimal, supportive, and simplified. Stakeholders and analysts receive richer session summaries. For ongoing operations, a Monitoring and Data Logging component persists every step for long-term retraining.

The decision flow is session-based. At the start of each user input or response, the Supervisor reads the current state from the Knowledge Base and decides which specialist agent is to act next. The selected specialist performs its role. Specialists coordinate with each other via A2A and produce a candidate output. The Filter/Safety agent inspects the output and routes content to the appropriate audiences. The step completes with every relevant store in the Knowledge Base updated. The next step repeats this cycle until the session ends, and the long-loop training process takes over between sessions.

The Adaptive response logic orchestrates the agents in real time during a session. When high cognitive load is detected, the adaptive response logic directs specialists to reduce the complexity of their outputs. When hesitation or stress is detected, the Supervisor suppresses or defers sensitive agent paths. When disengagement is detected, the adaptive response logic re-routes to a different specialist or reframes the approach to re-engage the user. These adjustments happen within a single session without waiting for retraining.

Between sessions, accumulated session logs drive a training process that extends the user model with new preferences, traits, and recurring response patterns; refines the per-agent strategies based on which approaches produced the strongest outcomes; and re-indexes session content into the RAG store so it is available for retrieval in future sessions across all agents. Because the user model is itself the product, updates to this store are the principal output of the long-loop.

FIG. 7 illustrates a seizure support and intervention system 700 in accordance with one embodiment. The seizure support and intervention system 700 comprises a primary user 102, an environmental tools 108, an input interface 110, a biosignal processing logic 114, a pre-processing/feature extraction logic 118, a knowledge base 120, a historical data 122, an accumulated logged data 124, an AI agent 128, an agentic action 134, a monitoring/data logging logic 136, a short-loop feedback 144, a long-loop feedback 146, a real-time biosignals 148, an event and outcome log 154, an environmental monitoring 702, an IoT sensors 704, a notification 706, an emergency service 708, a smart home commands 710, a smart home 712, a status alerts 714, a caregiver and companion application 716, and a manual override and user/caregiver feedback 718. In some embodiments, the monitoring/data logging logic 136 is configured as an audit log that records each biosignal input, classified user state, agent decision, and executed action together with a timestamp and a retention-policy tag governing how long the recorded entry is retained.

The seizure support and intervention system 700 comprises a real-time monitoring system that continuously acquires EEG, HRV, EDA, and environmental data to detect early warning signs of seizure activity. A network of specialized agents alerts caregivers, adjusts smart-home environments (lighting, noise, temperature), initiates calming interventions (haptic feedback, binaural audio), and contacts emergency services when risk thresholds are crossed. The Adaptive response logic modulates intervention intensity based on live biosignal feedback, and Long-Term Model Training personalizes seizure-risk classifiers and intervention thresholds over time.

This system continuously monitors EEG, HRV, EDA, and environmental inputs to detect early warning signs of seizure activity and trigger proactive, adaptive interventions. A set of agents responds to classified risk states by alerting caregivers, adjusting environmental conditions, or initiating calming protocols. Realtime biosignal feedback drives continuous adaptation of these interventions, while all performance and biosignal trends are logged to improve classifier accuracy and refine agent coordination over time. The system is designed for safety, personalization, and minimal user disruption.

EEG (motor intention and cognitive state) tracks abnormal brainwave activity and detects pre-seizure patterns to classify risk and trigger interventions. HRV monitors sympathetic nervous system activation. Declining HRV (autonomic response) signals pre-seizure stress. EDA measures sudden autonomic spikes before seizures and detects early stress and seizure-related arousal. Eye tracking detects pre-seizure cognitive changes and monitors disengagement and visual attention shifts. Wearable EEG/HRV sensors provide continuous real-time biosignal tracking. They stream high-frequency biometric data to support proactive agent activation signals for proactive response. Smart-home and IoT control adjusts lights, noise, temperature, creating a seizure-friendly environment to reduce or respond to triggers. Companion app and caregiver alerts may notify caregivers and emergency services by sending real-time alerts with seizure status, location, and biosignal summaries. Haptic wristbands deliver tactile calming feedback during elevated risk by vibrating gently and providing breathing guidance, awareness that support signaling, and increased focus.

A narrative timeline is provided below as an exemplary operation of the seizure support and intervention system 700.

Narrative Timeline
00:00- Monitoring Begins
User is seated at home reading
Baseline EEG and HRV readings are within normal
personalized thresholds
EDA is stable; no environmental anomalies detected
00:02 - Subtle Cognitive Change Detected
EEG shows brief spike in high-frequency activity (temporal
lobe region)
HRV begins to decline slightly; early autonomic signal of
stress
Eye tracking shows user pausing focus, subtle increase in
blink rate
Preprocessing classifies early-stage irregularity but below
intervention threshold
00:04-System Flags “Elevated Risk”
Second spike in EEG, longer duration; HRV drops further
EDA rises above baseline; user now showing physiological
stress
Agentic Assembly activates:
Smart Environment Agent (prepares to dim lights, reduce
noise)
Intervention Agent (queues calming audio sequence)
Supervisor Agent elevates internal confidence to 0.65
(threshold: 0.7)
00:05-System Crosses “Imminent Risk” Threshold
EEG now shows consistent pre-seizure pattern over 6-second
window
HRV dips below user's known seizure threshold; EDA spiking
Supervisor Agent raises confidence to 0.81 → triggers full
intervention
00:06-Action Execution Initiated
Environment Agent:
Dims lights, mutes ambient audio
Locks stove and auto-shuts off any high-risk appliances
Intervention Agent:
Begins calming audio (binaural tones), activates
vibration wristband
Emergency Agent:
Sends alert to caregiver with location and current
biosignal state
Sends signal to external UI for real-time caregiver
monitoring
00:07-Adaptive Response in Real-Time
User shifts position, eye tracking resumes stable pattern
EEG shows flattening of pre-seizure spikes; HRV begins
recovery
Adaptive response logic reduces intervention intensity
Lowers audio volume
Returns lights to mid-level after 2 min of recovery
00:10- Event Stabilizes
All biosignals trend back toward baseline
No full seizure occurred; system classifies this as a
“near-event”
Supervisor deactivates emergency protocols
System transitions back to passive monitoring
00:11 - Logging and Post-Event Summary
Monitoring & Data Logging records:
Full biosignal profile (EEG, HRV, EDA)
Activated agents and timing
Recovery duration
Caregiver notification timestamp and response
Later- Long-Term Model Training
System updates personalized seizure threshold window
Adjusts EEG pattern sensitivity for this user's profile
Logs recovery time improvement due to early intervention
Supervisor updates environment agent to trigger
interventions faster during evening hours (based on pattern)

FIG. 8 illustrates an assistive robot system for paralyzed users 800 in accordance with one embodiment. The assistive robot system for paralyzed users 800 comprises a primary user 102, an environmental tools 108, an input interface 110, a biosignal processing logic 114, a pre-processing/feature extraction logic 118, a knowledge base 120, a historical data 122, an accumulated logged data 124, an AI agent 128, an agentic action 134, a monitoring/data logging logic 136, a short-loop feedback 144, a long-loop feedback 146, a real-time biosignals 148, an event and outcome log 154, an environmental camera sensor 802, a wheelchair and obstacle sensor 804, a smart home/IoT integration 806, an external camera and microphone 808, a critical alert 810, an emergency service 812, a robot command 814, an assistive robot 816, a status alerts 818, a caregiver and companion application 820, a manual override and user/caregiver feedback 822, and caregiver demonstration capture 824.

The assistive robot system for paralyzed users 800 comprises a volitional biosignal control system that supports hands-free operation of robotic arms, smart wheelchairs, and home environments using EEG motor imagery, eye tracking, and EDA. Specialized agents handle navigation, object retrieval, environment automation, and caregiver interfacing. Error-related potentials serve as rejection or correction signals; long-term model training personalizes control thresholds and agent behavior based on accumulated user preferences and outcomes.

The system may also learn from caregiver demonstrations using external cameras and microphones. These sessions create multimodal embeddings that allow agents to anticipate user needs and assist with common care routines. Over time, this allows the system to replicate simple caregiving tasks, such as repositioning, responding to discomfort, or adjusting the environment, enhancing autonomy and reducing caregiver burden.

EEG (motor intention and cognitive state) and SSVEP and brain signals trigger movement, stop, retrieve, other robot commands. EEG (fatigue/attention) adjusts command sensitivity. EEG (error-related potentials) trigger auto-correction or user confirmation on unexpected actions. EDA (emotional arousal) triggers fallback/calming on spikes. Eye tracking (gaze-based selection) controls robot arm and/or wheelchair. Smart wheelchair sensors queue obstacle detection and autonomous navigation. Smart robotic arm perform object retrieval via BCI-selected targets. Smart-home IoT controls lights, locks, and appliances. Environment cameras monitor safety, obstacles, caregiver presence. External camera and microphone capture caregiver demonstrations for multimodal embeddings.

FIG. 9 illustrates a cognitive health support system 900 in accordance with one embodiment. The cognitive health support system 900 comprises a primary user 102, an environmental tools 108, an input interface 110, a biosignal processing logic 114, a pre-processing/feature extraction logic 118, a knowledge base 120, a historical data 122, an accumulated logged data 124, an AI agent 128, an agentic action 134, a monitoring/data logging logic 136, a short-loop feedback 144, a long-loop feedback 146, a real-time biosignals 148, an event and outcome log 154, a seizure support and intervention system 700, a user profile and context database 902, an environmental camera sensor 904, an exercise suggestion 906, an adaptive brain exercise 908, an AR cues and overlays 910, an AR display 912, a light, sound, and temperature settings 914, an environmental adjustments 916, a reminders and alerts 918, a memory and task reminders 920, a status alerts 922, a caregiver and companion application 924, and a manual override and user/caregiver feedback 926.

The cognitive health support system 900 comprises a biosignal-driven agentic system designed to support users experiencing cognitive fatigue, cognitive strain, decline, or acquired language disorders. The system continuously analyzes EEG, eye tracking, HRV, and contextual environmental data to assess cognitive and language state in real time. A suite of agents provides task support, memory reinforcement, safety monitoring, and—for users with aphasia—communication scaffolding including word-retrieval cues, paraphasia interception, telegraphic-speech expansion, and agraphia-specific input normalization. The system adapts conversational and interface strategies (complexity reduction, pacing adjustment, memory-recall cues) via the Adaptive complexity logic and the clinician-configurable compensate-vs-rehabilitate dial. Long-term learning refines classifiers and personalizes support to each user's evolving cognitive patterns and preferences.

Clinical scope and unmet need: Aphasia affects ~2M individuals in the U.S. with ~180K new stroke-related cases per year; primary progressive aphasia, Traumatic Brain Injury-related aphasia, and post-stroke cognitive impairment are additional target populations. The defining clinical challenge is the dissociation between preserved intent and broken expression, which the three-tier agentic memory addresses by mapping individual meaning-to-expression (vs. general LLMs' population expression-to-meaning).

TABLE 1
Aphasia Symptom Coverage Matrix

| Aphasia Symptom | System Components Addressing It |
|---|---|
| Anomia (word-finding | Semantic Intent Graph, Anomia Cue Ladder, Multi-Modal |
| difficulty) | Intent Fusion, AR conversation support |
| Non-fluent/effortful speech | Telegraphic speech expansion, Activity, Conservation, |
| | and Envelope(ACE) fatigue pacing |
| Impaired comprehension | Adaptive complexity logic, AR reading assistance |
| Paraphasias (wrong-word | Paraphasia detection/interception |
| substitution) | |
| Agraphia (writing difficulty) | Agraphia-specific input normalization, touch/symbol |
| | fallback |
| Alexia (reading difficulty) | AR reading assistance, simplified text output |
| Global aphasia (severe) | Full multi-modal fallback stack: AAC + yes/no + image |
| | selection + confirmation gate |
| Preserved intent, broken | Three-tier agentic memory/Semantic Intent Graph + |
| expression | Multi-Modal Intent Fusion |
| Fatigue/cognitive-load | ACE intra-session state estimation, Frustration-Interrupt |
| sensitivity | Protocol |
| Inconsistent performance | Adaptive thresholding, longitudinal Aphasia Profile |
| | tracking |

EEG (cognitive load/fatigue) tracks attention, memory recall, effort; triggers memory aids and adaptive task guidance. EEG (memory encoding/recall) displays contextual reminders when recall difficulty is detected. Eye tracking (gaze fixation, blink rate) measures focus and visual engagement; adjusts information display when comprehension struggle detected. Eye tracking (pupil dilation, saccades) tracks emotional response and cognitive effort; adjusts interventions dynamically. External camera (visual context) detects missed steps, misplaced items, or signs of confusion.

A narrative timeline is provided below as an exemplary operation of the cognitive health support system 900.

Narrative Timeline
00:00-Baseline Monitoring Active
User opens a cooking app to follow a familiar recipe
EEG, HRV, and gaze fixation are stable; user shows
consistent attention
Environmental context (lighting, noise) is typical;
caregiver is not present No alerts displayed to user;
system in passive mode
00:04-Subtle Cognitive Fatigue Detected
EEG shows gradual increase in theta activity (associated
with fatigue)
Blink rate increases; gaze fixation time decreases slightly
HRV begins trending downward; user pauses and rereads a
step
System notes early-stage disengagement but holds off on
intervention
Supervisor Agent suppresses user-facing feedback and
quietly flags state as “mild cognitive load”
00:07-Attention Disruption & Behavioral Deviation
User skips a step in the recipe, places pan on stove but
doesn't turn burner on
External camera detects misplaced ingredient (e.g., leaving
milk out)
Facial expression suggests confusion; vocal muttering
detected
Eye tracking shows inconsistent scanning of interface
Cognitive State Classifier triggers:
“disorientation/confusion -confidence 0.74” Supervisor
activates Task Support Agent and Environment Awareness Agent
00:08-Gentle Support Introduced
Task Support Agent simplifies on-screen instructions and
adds a visual anchor
A soft chime prompts the user to reread the skipped step
without explicitly calling out the error
User follows the cue and continues cooking
HRV stabilizes slightly, gaze fixation improves
No caregiver alert issued; internal interface displays
“Looking good - take your time!” 00:11-Name Recall Challenge
Detected
Later in the task, user receives a video call from a known
contact
Eye tracking reveals hesitation on contact name, increased
blink rate
EEG indicates elevated cognitive load and momentary drop in
focus
Memory Reinforcement Agent activates in background
System unobtrusively displays recent messages with that
contact's name in peripheral view
User regains composure and answers confidently
00:14-Session Recovery & Exit
Biosignals stabilize; HRV and EEG return to mid-baseline
Supervisor deactivates agents; user finishes task
User-facing UI displays encouragement: “You handled that
beautifully. Great work today.” 00: 15-Monitoring & Logging
Begins
System logs:
Onset of cognitive fatigue, timing of confusion event
Agent interventions and user response
Memory lapse episode and resolution
No alerts sent to caregiver (threshold not met), but
session is marked for trend analysis
Adaptive thresholds are updated for gaze deviation and name
recall timing
Later-Long-Term Model Training
System refines classifiers for disorientation and memory
stress
Updates profile with new peak fatigue window (mid-
afternoon)
Enhances agent response strategies for subtle recall cues
without direct correction
Improves personalization of pacing and reinforcement across
future tasks

FIG. 10 illustrates a goal-oriented dialog support system 1000 in accordance with one embodiment. The goal-oriented dialog support system 1000 comprises a primary user 102, an environmental tools 108, a biosignal processing logic 114, a pre-processing/feature extraction logic 118, a knowledge base 120, a historical data 122, an accumulated logged data 124, an AI agent 128, a primary user interface 130, an agentic action 134, a monitoring/data logging logic 136, a short-loop feedback 144, a long-loop feedback 146, a real-time biosignals 148, an event and outcome log 154, a seizure support and intervention system 700, a cognitive health support system 900, a sentiment analysis API 1002, a facial expression and voice audio analysis 1004, a RAG database 1006, an output 1008, a next question/prompt 1010, a conversation summary 1012, and user reactions 1014.

The goal-oriented dialog support system 1000 comprises a multi-agent conversational system that conducts adaptive, emotionally-aware dialogues using biosignals (EEG, HRV, eye tracking), facial expression analysis, and vocal tone to detect engagement, fatigue, and relaxation states. Specialized agents—Tutor, Curator, Researcher, Sentiment Interpreter—collaboratively ask questions, extract insights, and adjust phrasing and flow in response to user state. A Supervisor Agent manages pacing and feedback delivery, surfacing supportive internal feedback to users while providing deeper summaries to caregivers or analysts. Long-term model training evolves sensitivity, responsiveness, and personalization over time.

Dialogue memory and RAG retrieval personalizes prompts, avoids repetition, supports emotionally coherent follow-ups. EEG (emotional response/cognitive state) adjusts question phrasing, tone, difficulty. EEG (mental effort/cognitive load) sets question difficulty; slows down or offers easier prompts if cognitive load high. Eye tracking (pupil dilation) detects emotional cues; adapts conversation. Eye tracking (gaze fixation/blink rate) detects disengagement and adjusts dialogue style. Sentiment analysis API refines flow based on positivity/negativity/uncertainty. Facial expression analysis detects confusion, frustration, and agreement; refines tone. Voice audio analysis vocal stress/tone/pacing; adjusts response style. HRV sensor adjusts dialogue difficulty and pacing based on stress/relaxation.

A narrative timeline is provided below as an exemplary operation of the goal-oriented dialog support system 1000.

Narrative Timeline
00:00- Session Begins
User is seated in a quiet room; EEG and HRV indicate a
relaxed but alert baseline
Eye tracking shows consistent fixation on the interface
Supervisor Agent initiates session with light onboarding
prompt through Tutor Agent
No external caregiver interface is engaged
00:02- Early Engagement Detected
Tutor Agent asks a personalized opening question based on
historical interest (‘What's something that energized you
this week?”)
EEG shows elevated beta activity (focused thinking); gaze
remains steady
HRV remains high; facial expression shows mild enthusiasm
Curator Agent silently flags strong emotional valence in
user's response
00:04-Subtle Emotional Shift
Question shifts to social preferences; user pauses, looks
away briefly
Eye tracking detects reduced fixation; HRV slightly
decreases
Sentiment Agent notes downward shift in tone and
microexpression tension
Supervisor slows pacing and prompts Tutor to soften next
question
No internal alert shown; system preserves flow 00:06-
Insight Moment Identified
User shares a reflective comment about a childhood
experience
EEG shows a unique peak in memory recall signals (temporal
pattern spike)
Curator tags the statement as high-value for profile
enrichment
Researcher Agent is triggered to pull a related follow-up
based on a past session thread
00:08- Fatigue Detected Mid-Session
EEG shows increased theta, drop in alpha; blink rate rises
HRV dips; pupil dilation increases
Supervisor Agent determines cognitive load rising →
instructs Tutor to ask a lighter, affirming question
Adaptive response logic simplifies UI layout and gently
reduces interaction pressure
Internal UI displays encouraging phrase: “You're doing
great. Want a quick breather?” 00:10- Recovery & Continued
Flow
User resumes with steadier gaze; HRV trends upward
Sentiment Agent detects improved tone
Curator summarizes recent insights silently; Supervisor
decides to close session gradually 00:12-session Wrap-Up
Supervisor Agent ends session with a reflective summary
prompt (“Anything you'd like to explore more next time?”)
All biosignals return to comfortable baseline
No direct user feedback needed Post-Session - Monitoring &
Logging
Logs include:
Biosignal fluctuations per prompt
Agent activation timeline
Highlighted insights and adaptive changes made
Session marked as “high engagement/mild fatigue”
No external caregiver alert sent; data stored for long-term
adaptation
Later- Long-Term Model Training
Curator and Sentiment Agent data used to refine emotional
classifiers
Supervisor thresholds updated for when to reduce pacing
Personalized dialogue profile adjusted with new tone and
pacing preferences
Future sessions will prioritize soft start and mid-session
recovery cues earlier

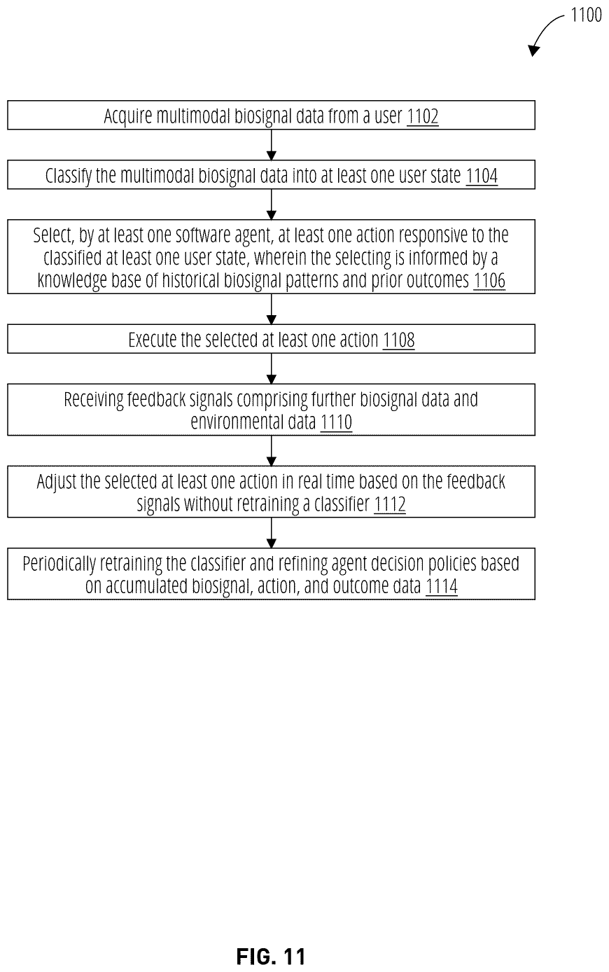

FIG. 11 illustrates an example routine 1100. Although the example routine 1100 depicts a particular sequence of operations, the sequence may be altered without departing from the scope of the present disclosure. For example, some of the operations depicted may be performed in parallel or in a different sequence that does not materially affect the function of the routine 1100. In other examples, different components of an example device or system that implements the routine 1100 may perform functions at substantially the same time or in a specific sequence.

According to some examples, the method includes acquiring multimodal biosignal data from a user at block 1102. According to some examples, the method includes classifying the multimodal biosignal data into at least one user state at block 1104.

According to some examples, the method includes selecting, by at least one software agent, at least one action responsive to the classified at least one user state, wherein the selecting is informed by a knowledge base of historical biosignal patterns and prior outcomes at block 1106. According to some examples, the method includes executing the selected at least one action at block 1108.

According to some examples, the method includes receiving feedback signals comprising further biosignal data and environmental data at block 1110. According to some examples, the method includes adjusting the selected at least one action in real time based on the feedback signals with or without retraining a classifier at block 1112. According to some examples, the method includes periodically retraining the classifier and refining agent decision policies based on accumulated biosignal, action, and outcome data at block 1114.

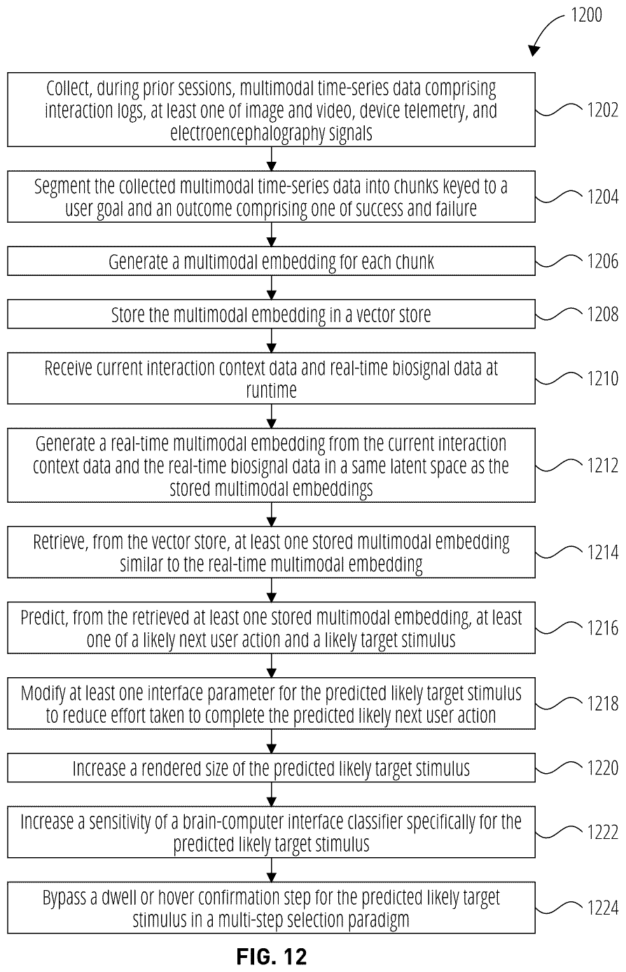

FIG. 12 illustrates an example routine 1200 such as may be completed by the RAG index data and inference pipeline 300 of FIG. 3. Although the example routine 1200 depicts a particular sequence of operations, the sequence may be altered without departing from the scope of the present disclosure. For example, some of the operations depicted may be performed in parallel or in a different sequence that does not materially affect the function of the routine 1200. In other examples, different components of an example device or system that implements the routine 1200 may perform functions at substantially the same time or in a specific sequence.

According to some examples, the method includes collecting, during prior sessions, multimodal time-series data comprising interaction logs, at least one of image and video, device telemetry, and electroencephalography signals at block 1202. According to some examples, the method includes segmenting the collected multimodal time-series data into chunks keyed to a user goal and an outcome comprising one of success and failure at block 1204. According to some examples, the method includes generating a multimodal embedding for each chunk at block 1206.

According to some examples, the method includes storing the multimodal embedding in a vector store at block 1208. According to some examples, the method includes receiving current interaction context data and real-time biosignal data at runtime at block 1210. According to some examples, the method includes generating a real-time multimodal embedding from the current interaction context data and the real-time biosignal data in a same latent space as the stored multimodal embeddings at block 1212.

According to some examples, the method includes retrieving, from the vector store, at least one stored multimodal embedding similar to the real-time multimodal embedding at block 1214. According to some examples, the method includes predicting, from the retrieved at least one stored multimodal embedding, at least one of a likely next user action and a likely target stimulus at block 1216.

According to some examples, the method includes modifying at least one interface parameter for the predicted likely target stimulus to reduce effort taken to complete the predicted likely next user action at block 1218. According to some examples, the method includes increasing a rendered size of the predicted likely target stimulus at block 1220. According to some examples, the method includes increasing a sensitivity of a brain-computer interface classifier specifically for the predicted likely target stimulus at block 1222. According to some examples, the method includes bypassing a dwell or hover confirmation step for the predicted likely target stimulus in a multi-step selection paradigm at block 1224.

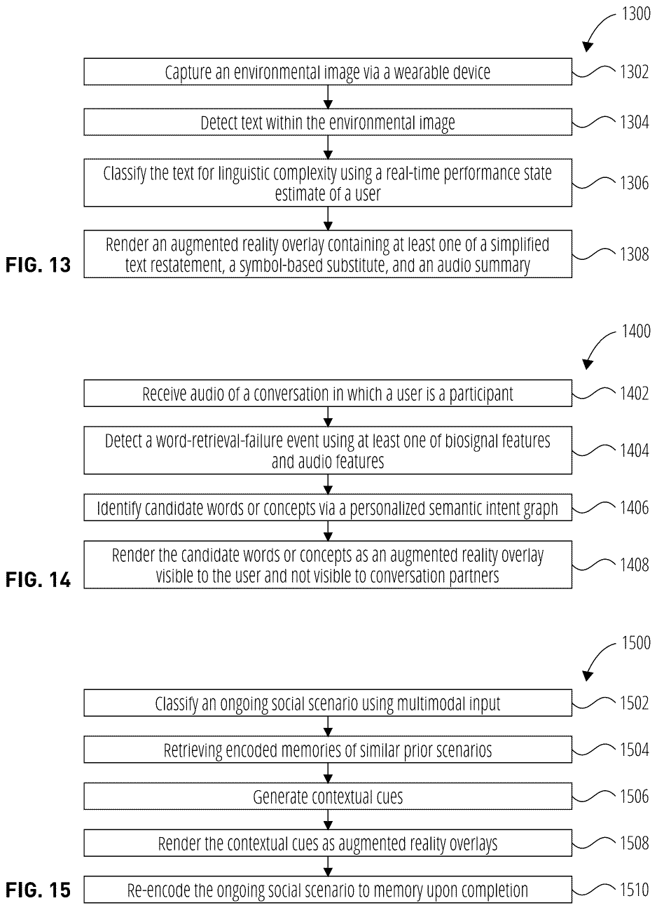

FIG. 13 illustrates an example routine 1300. Although the example routine 1300 depicts a particular sequence of operations, the sequence may be altered without departing from the scope of the present disclosure. For example, some of the operations depicted may be performed in parallel or in a different sequence that does not materially affect the function of the routine 1300. In other examples, different components of an example device or system that implements the routine 1300 may perform functions at substantially the same time or in a specific sequence.

According to some examples, the method includes capturing an environmental image via a wearable device at block 1302. According to some examples, the method includes detecting text within the environmental image at block 1304. According to some examples, the method includes classifying the text for linguistic complexity using a real-time performance state estimate of a user at block 1306. According to some examples, the method includes rendering an augmented reality overlay containing at least one of a simplified text restatement, a symbol-based substitute, and an audio summary at block 1308.

FIG. 14 illustrates an example routine 1400. Although the example routine 1400 depicts a particular sequence of operations, the sequence may be altered without departing from the scope of the present disclosure. For example, some of the operations depicted may be performed in parallel or in a different sequence that does not materially affect the function of the routine 1400. In other examples, different components of an example device or system that implements the routine 1400 may perform functions at substantially the same time or in a specific sequence.

According to some examples, the method includes receiving audio of a conversation in which a user is a participant at block 1402. According to some examples, the method includes detecting a word-retrieval-failure event using at least one of biosignal features and audio features at block 1404. According to some examples, the method includes identifying candidate words or concepts via a personalized semantic intent graph at block 1406. According to some examples, the method includes rendering the candidate words or concepts as an augmented reality overlay visible to the user and not visible to conversation partners at block 1408.

FIG. 15 illustrates an example routine 1500. Although the example routine 1500 depicts a particular sequence of operations, the sequence may be altered without departing from the scope of the present disclosure. For example, some of the operations depicted may be performed in parallel or in a different sequence that does not materially affect the function of the routine 1500. In other examples, different components of an example device or system that implements the routine 1500 may perform functions at substantially the same time or in a specific sequence.

According to some examples, the method includes classifying an ongoing social scenario using multimodal input at block 1502. According to some examples, the method includes retrieving encoded memories of similar prior scenarios at block 1504. According to some examples, the method includes generating contextual cues at block 1506. According to some examples, the method includes rendering the contextual cues as augmented reality overlays at block 1508. According to some examples, the method includes re-encode the ongoing social scenario to memory upon completion at block 1510.

FIG. 16 illustrates a user agency and capability augmentation system 1600 in accordance with one embodiment. The user agency and capability augmentation system 1600 comprises a user 1602, a wearable computing and biosignal sensing device 1604, biosignals 1606, background material 1608, sensor data 1610, other device data 1612, application context 1614 a prompt composer 1616, a GenAI 1618, a multimodal output stage 1620, an encoder/parser 1632, output modalities 1622 such as an utterance 1624, a written text 1626, a multimodal artifact 1628, an other user agency 1630, and a non-language user agency device 1634, a biosignals subsystem 1700, and a context subsystem 1800.

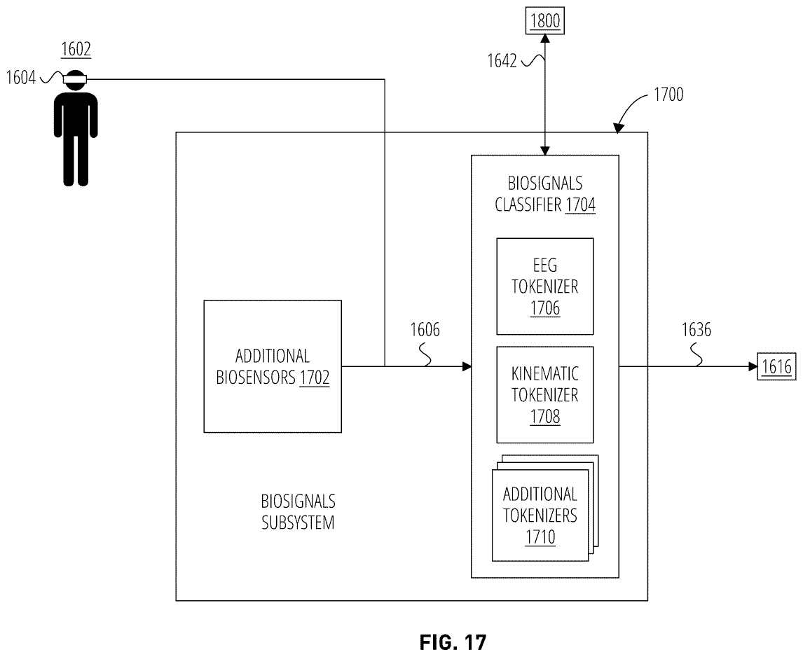

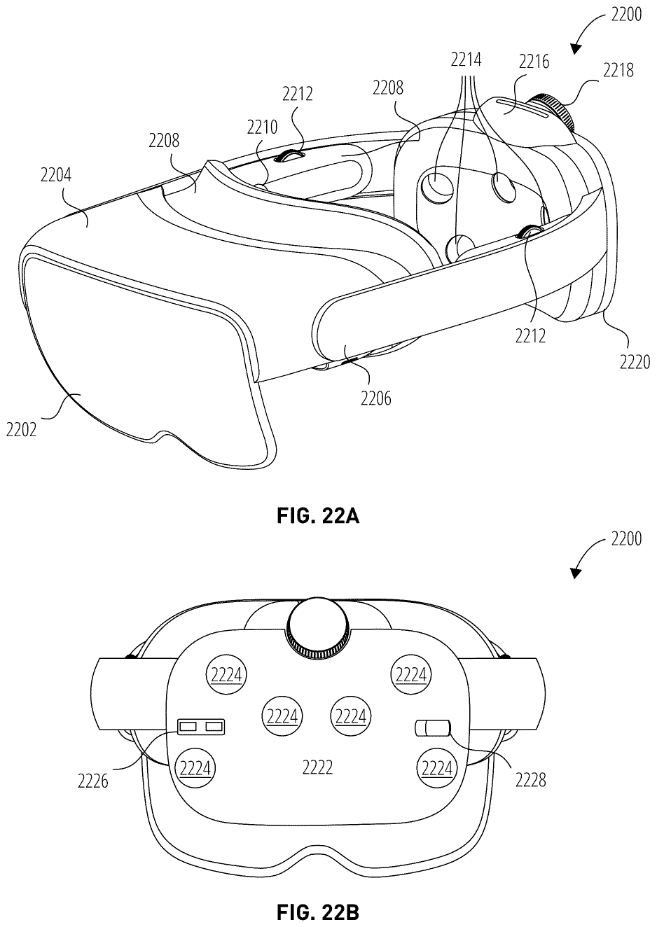

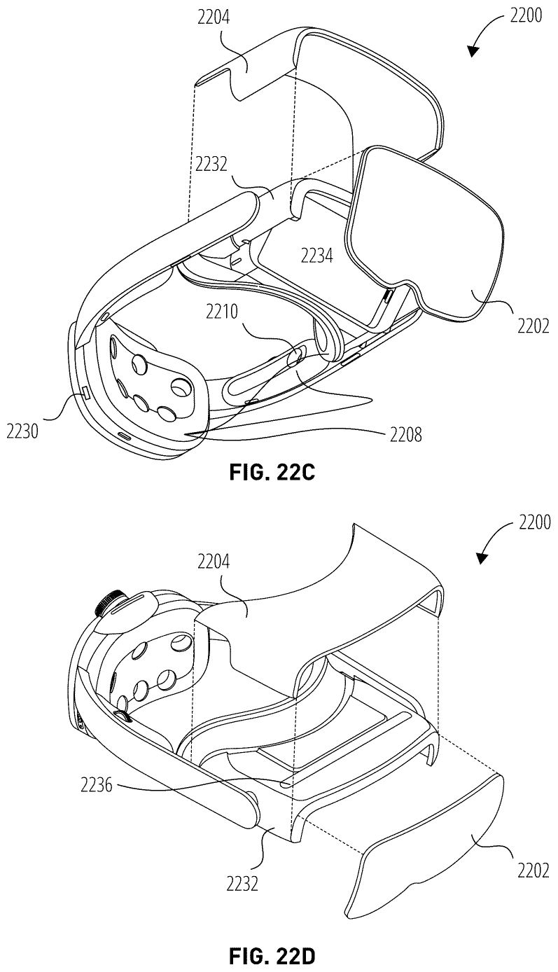

The user 1602 in one embodiment may be equipped with and interact with a wearable computing and biosignal sensing device 1604. The wearable computing and biosignal sensing device 1604 may be a device such as the brain computer interface or BCI headset system 2200 described in greater detail with respect to FIG. 22A through FIG. 22D. This embodiment may provide the user 1602 with capability augmentation or agency support by utilizing biosignals 1606, such as neurologically sensed signals and physically sensed signals, detected from the wearable computing and biosignal sensing device 1604 and sent to a biosignals subsystem 1700, in addition to data from biosignal sensors that may be part of the biosignals subsystem 1700. The biosignals subsystem 1700 may produce as its output a tokenized biosignals prompt 1636. The action of the biosignals subsystem 1700 is described in detail with respect to FIG. 17.

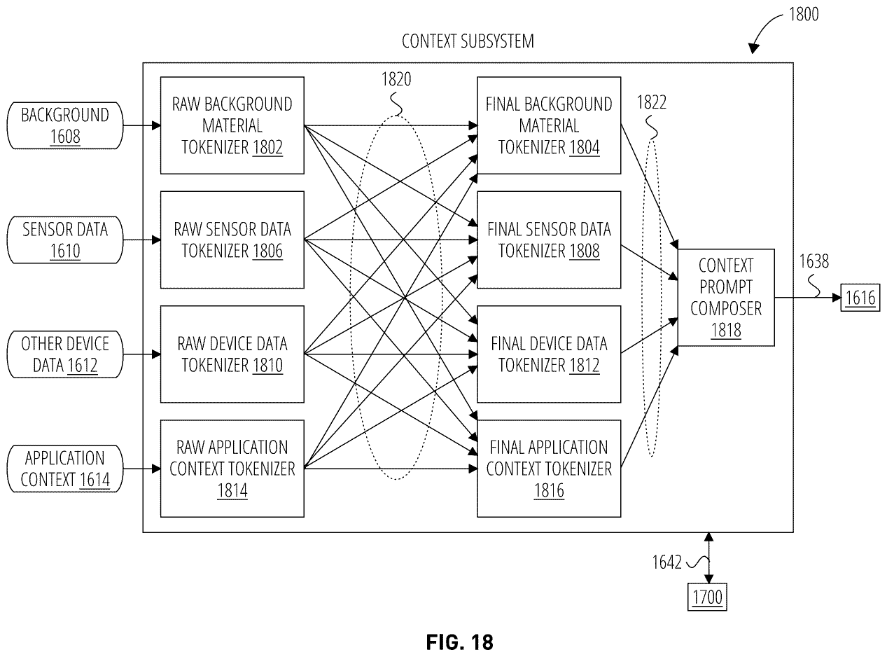

This embodiment may provide the user 1602 with capability augmentation or agency support by utilizing inference of the user's environment, physical state, history, and current desired capabilities as a user context, to be gathered at a context subsystem 1800, described in greater detail with respect to FIG. 18. This data may be provided as background material 1608 on the user stored in a database or other storage structure, sensor data 1610 and other device data 1612 from a range of devices and on-device and off-device sensors, and application context 1614 provided by applications, interfaces, or parameters configured to provide the capability augmentation sought by the user 1602. The context subsystem 1800 may produce as its output a tokenized context prompt 1638.

In one embodiment, the biosignals subsystem 1700 and the context subsystem 1800 may be coupled or configured to allow shared data 1642 to flow between them. For instance, some sensor data 1610 or other device data 1612 may contain biosignal information that may be useful to the biosignals subsystem 1700. Or the biosignals subsystem 1700 may capture sensor data 1610 indicative of the user 1602 context. These systems may communicate such data, in raw, structured, or tokenized forms, between themselves using wired or wireless communication. In one embodiment, these systems may operate as part of a device that is also configured and utilized to run other services.

This embodiment may finally provide the user 1602 capability augmentation or agency support by utilizing direct user 1602 input in the form of a user input prompt 1640, such as mouse, keyboard, or biosignal-based selections, typed or spoken language, or other form of direct interaction the user 1602 may have with a computational device that is part of or supports the user agency and capability augmentation system 1600 disclosed. In one embodiment, the user 1602 may provide an additional token sequence in one or more sensory modes, which may include a sequence of typed or spoken words, an image or sequence of images, and a sound or sequence of sounds. The biometric and optional multimodal prompt input from the user may be tokenized using equivalent techniques as for the context data.

The biosignals prompt 1636, context prompt 1638, and user input prompt 1640 may be sent to a prompt composer 1616. The prompt composer 1616 may consume the data including the biosignals prompt 1636, context prompt 1638, and user input prompt 1640 tokens, and may construct a single token, a set of tokens, or a series of conditional or unconditional commands suitable to use as a prompt 1644 for a GenAI 1618 such as a Large Language Model (LLM), a Generative Pre-trained Transformer (GPT) like GPT-4, or a generalist agent such as Gato. For example, a series such as “conditional on command A success, send command B, else send command C” may be built and sent all at once given a specific data precondition, rather than being built and sent separately.

The prompt composer 1616 may also generate tokens that identify a requested or desired output modality (text vs. audio/visual vs. commands to a computer or robotic device, etc.) from among available output modalities 1622 such as those illustrated. In one embodiment, the prompt composer 1616 may further generate an embedding which may be provided separately to the GenAI 1618 for use in an intermediate layer of the GenAI 1618. In another embodiment, the prompt composer 1616 may generate multiple tokenized sequences at once that constitute a series of conditional commands. In one exemplary use case, the user 1602 submits a general navigational command to an autonomous robot or vehicle, such as “go to the top of the hill.” The prompt composer 1616 may then interact with satellite and radar endpoints to construct specific motor commands, such as “Move forward 20 feet and turn left,” that navigate the robot or vehicle to the desired destination.

In one exemplary use case, the context subsystem 1800 may generate a context prompt 1638 token sequence corresponding to the plaintext, “The user has travelled to Los Angeles to visit a doctor specializing in rare diseases. The user is sitting in the doctor's office and preparing to discuss their disease. The user is looking at the doctor who has just asked the user for an update on their condition.” Such a context prompt 1638 may be generated by utilizing sensors on a computing device worn or held by the user 1602, such as a smart phone or the wearable computing and biosignal sensing device 1604. Such sensors may include global positioning system (GPS) components, as well as microphones configured to feed audio to a speech to text (STT) device or module in order to identify the doctor and the questions. The biosignals subsystem 1700 may generate a biosignals prompt 1636 including a token sequence corresponding to the user selecting “speak” with a computing device to select this directive using an electroencephalography-based brain computer interface. The user input prompt 1640 may include a token sequence corresponding to the plaintext, “The user has selected ‘summarize my recent disease experience’.” In this case, the prompt composer 1616 may simply append these three token sequences into a single prompt 1644 and may then pass it to the GenAI 1618. In an alternate embodiment, the prompt composer 1616 may replace the biosignals prompt 1636 with a token sequence corresponding to the plaintext “Generate output in a format suitable for speech synthesis.”

In some embodiments, the prompt composer 1616 may utilize a formal prompt composition language such as Microsoft Guidance. In such a case, the composition language may utilize one or more formal structures that facilitate deterministic prompt composition as a function of mixed modality inputs. For example, the prompt composer 1616 may contain subroutines that process raw signal data and utilize this data to modify context prompt 1638 and/or biosignals prompt 1636 inputs in order to ensure specific types of GenAI 1618 outputs.

A more intricate exemplary prompt from the prompt composer 1616 to the GenAI 1618, incorporating information detected from user 1602 context and biosignals 1606, may be as follows:

I am Sarah, a 60-year-old retired schoolteacher with advanced
ALS. I enjoy the peaceful sounds of birds chirping. I just
finished reading a mystery novel recommended by my friend
Donna. As a literature enthusiast, I have a long history of
discussing books with my friends and family
I need help communicating and you are my assistant.
This is the current context:
Conversation history: Recent discussions about books with
family and friends, including favorite authors, genres, and
specific titles
Personal preferences: Fondness for mystery novels,
historical fiction, and biographies; appreciation for strong
character development and engaging plots
Language corpus and demographics: 60-year-old, retired
school teacher, well-versed in literary terms and expressions
Mood: Content, relaxed, and eager to share her thoughts on
the novel
Conversation Partner: Donna, my friend with shared interest
in literature
Environmental audio: Sounds of birds chirping, rustling
leaves, and distant neighborly conversations in the garden
Front-facing camera: Images of blooming flowers, lush
greenery, and the mystery novel's cover
Location, motion, and positioning: At home, sitting in a
comfortable garden chair
Reading preferences: Mystery novels, historical fiction,
biographies, and classic literature
Educational background: Years of teaching experience in
literature, familiarity with various literary periods and
styles.
If I send an emoji, use it to topically or thematically
improve prediction and alter tone. Use all contextual
information and prior conversation history to modulate your
responses. After each input, review the prior inputs and
modify your subsequent predictions based on the context of
the thread. Taking into account the current context, with
spartan language, return a JSON string called ‘suggestions’
with three different and unique phrases without quotes. They
should be complete sentences longer than two words. Do not
include explanations. The phrases you respond with will be
spoken by my speech generating device.

The GenAI 1618 may take in the prompt 1644 from the prompt composer 1616 and use this to generate a multimodal output 1646. The GenAI 1618 may consist of a pre-trained machine learning model, such as GPT. The GenAI 1618 may generate a multimodal output 1646 in the form of a token sequence that may be converted back into plaintext, or which may be consumed by a user agency process directly as a token sequence. In an alternate embodiment, the output of the GenAI 1618 further constitutes embeddings that may be decoded into multimodal or time-series signals capable of utilization by agency endpoints. Once determined, the output is digitally communicated to an agency endpoint capable of supporting the various output modalities 1622.

In some embodiments, the GenAI 1618 may generate two or more possible multimodal outputs 1646 and the user 1602 may be explicitly prompted at the multimodal output stage 1620 to select between the choices. In the case of language generation, the user 1602 may at the multimodal output stage 1620 select between alternative utterances 1624. In the case of robot control, the choices may consist of alternative paths that a robot could take in order to achieve a user-specified goal. In these embodiments, there may be an output mode selection signal 1648 provided by the user 1602 explicitly or indicated through biosignals 1606, to the multimodal output stage 1620. The output mode selection signal 1648 may instruct a choice between the multimodal outputs 1646 available from the GenAI 1618 at the multimodal output stage 1620. In one embodiment, the user 1602 may further direct one or more of the alternatives to alternate endpoints supporting the various output modalities 1622. For example, the user 1602 may select one utterance 1624 for audible presentation and a different one for transformation and/or translation to written text 1626.

In an alternate configuration, the user agency and capability augmentation system 1600 may contain multiple GenAIs 1618, each of which is pre-trained on specific application, context, or agency domains. In this configuration, the context subsystem 1800 may be responsible for selecting the appropriate GenAI 1618 or GenAIs 1618 for the current estimated user context. In some embodiments, mixture-of-experts models such as a generalist language model may be used for this.

In some embodiments, models may be fine-tuned by the user 1602. For example, the user 1602 may provide a GenAI 1618 LLM classifier model with exemplars of classes, either by speaking or writing them, and through few-shot learning, the model may improve accuracy. The multimodal outputs 1646 may be made available to the user 1602 through the agency endpoints supporting the various output modalities 1622, and the user 1602 may respond in a manner detectable through the user's biosignals 1606, or directly through an additional user input prompt 1640, and in this manner may also provide data through which the GenAI 1618 may be refined.

The multimodal outputs 1646 may be used to extend and support user 1602 agency and augment user 1602 capability into real and virtual endpoints. In one embodiment, the selected user agency process may be a speech synthesis system capable of synthesizing a token sequence or text string as a spoken language utterance 1624 in the form of a digital audio signal. In another embodiment, the system's output may be constrained to a subset of domain-relevant utterances 1624 for applications such as employment, industry, or medical care. This output constraint may be implemented using a domain specific token post-processing system or it may be implemented with an alternate GenAI that has been pre-trained on the target domain. In another embodiment, the endpoint may be a written text 1626 composition interface associated with a communication application such as email, social media, chat, etc., or presented on the user's or their companions' mobile or wearable computing device. In a further embodiment, the output may be a multimodal artifact 1628 such as a video with text, an audio file, etc. In another embodiment, the output may augment some other user agency 1630, such as by providing haptic stimulation, or through dynamic alteration of a user's interface, access method, or complexity of interaction, to maximize utility in context.

In some embodiments, the multimodal outputs 1646 may be additionally encoded using an encoder/parser 1632 framework such as an autoencoder. In this system, the output of the encoder/parser 1632 framework may be a sequence of control commands to control a non-language user agency device 1634 or robotic system such as a powered wheelchair, prosthetic, powered exoskeleton, or other smart, robotic, or AI-powered device. In one embodiment, the prompt 1644 from the prompt composer 1616 may include either biosignals prompt 1636 or user input prompt 1640 tokens which represent the user's desired configuration, and the multimodal output includes detailed steps that a robotic controller may digest, once encoded by the encoder/parser 1632. In this embodiment, the user 1602 may express a desire to move from location A to location B, and the combination of the GenAI 1618 and the robot controller may generate an optimal path as well as detailed control commands for individual actuators. In another embodiment, biosignals 1606 may be used to infer a user's comfort with the condition of their surroundings, their context indicating that they are at home, and a prompt may be developed such that the GenAI 1618 provides multimodal outputs 1646 instructing a smart home system to adjust a thermostat, turn off music, raise light levels, or perform other tasks to improve user comfort. In a further embodiment, the GenAI 1618 may generate a novel control program which is encoded by parsing or compiling it for the target robot control platform at the encoder/parser 1632. The multimodal output 1646 may through these methods be available as information or feedback to the user 1602, through presentation via the wearable computing and biosignal sensing device 1604 or other devices in the user's immediate surroundings. The multimodal output 1646 may be stored and become part of the user's background material 1608. The user 1602 may respond to the multimodal output 1646 in a manner detectable through biosignals 1606, and thus a channel may be provided to train the GenAI 1618 based on user 1602 response to multimodal output 1646.

In general, the user agency and capability augmentation system 1600 may be viewed as a kind of application framework that uses the biosignals prompt 1636, context prompt 1638, and user input prompt 1640 sequences to facilitate interaction with an application, much as a user 1602 would use their finger to interact with a mobile phone application running on a mobile phone operating system. Unlike a touchscreen or mouse/keyboard interface, this system incorporates real time user inputs along with an articulated description of their physical context and historical context to facilitate extremely efficient interactions to support user agency. FIG. 16 shows the pathways signals take from input, by sensing devices, stored data, or the user 1602, to output in the form of text-to-speech utterances 1624, written text 1626, multimodal artifacts 1628, other user agency 1630 supportive outputs, and/or commands to a non-language user agency device 1634. It will be well understood by one of skill in the art that not all components of the disclosed user agency and capability augmentation system 1600 may be used in every application such a system may operate within or may not be used with equal weight. Some applications may make greater use of biosignals 1606 than of context indicating the user history and surroundings. Some applications may necessitate operation completely independent from user input prompt 1640 data. The disclosed user agency and capability augmentation system 1600 may be used in support of such user applications as are described in the embodiments disclosed herein.

FIG. 17 illustrates a biosignals subsystem 1700 in accordance with one embodiment. The biosignals subsystem 1700 may comprise additional biosensors 1702, a biosignals classifier 1704, an electroencephalography or EEG tokenizer 1706, a kinematic tokenizer 1708, and additional tokenizers 1710, each of which may be suitable for one or more streams of biosignal data.

In addition to sensors which may be available on the wearable computing and biosignal sensing device 1604 worn by the user 1602, additional biosensors 1702 may be incorporated into the biosignals subsystem 1700. These may be of a mixture of physical sensors on or near the user's body that connect with network-connected and embedded data sources and models to generate a numerical representation of a biosignal estimate. An appropriate biosignal tokenizer may encode the biosignal estimate with associated data to generate at least one biosignal token sequence. In some embodiments, the mobile or wearable computing and biosignal sensing device 1604 may include a set of sensory peripherals designed to capture user 1602 biometrics. In this manner, the biosignals subsystem 1700 may receive biosignals 1606, which may include at least one of a neurologically sensed signal and a physically sensed signal.

Biosignals 1606 may be tokenized through the use of a biosignals classifier 1704. In some embodiments, these biometric sensors may include some combination of EEG, electrocorticography (ECOG), electrocardiogram (ECG or EKG), electromyography (EMG), electrooculography (EOG), pulse, heart rate variability, blood sugar sensing, dermal conductivity, etc. These biometric data may be converted into a biosignal token sequence in the biosignals classifier 1704, through operation of the EEG tokenizer 1706, kinematic tokenizer 1708, or additional tokenizers 1710, as appropriate.

It is common practice for biosignal raw signal data to be analyzed in real time using a classification system. For EEG signals, a possible choice for an EEG tokenizer 1706 may be canonical correlation analysis (CCA), which ingests multi-channel time series EEG data and outputs a sequence of classifications corresponding to stimuli that the user may be exposed to. However, one skilled in the art will recognize that many other signal classifiers may be chosen that may be better suited to specific stimuli or user contexts. These may include but are not limited to independent component analysis (ICA), xCCA (CCA variants), power spectral density (PSD) thresholding, and machine learning. One skilled in the art will recognize that there are many possible classification techniques. In one example, these signals may consist of steady state visually evoked potentials (SSVEP) which occur in response to specific visual stimuli. In other possible embodiments, the classification may consist of a binary true/false sequence corresponding to a P300 or other similar neural characteristic. In some embodiments, there will be a user or stimuli specific calibrated signal used for the analysis. In other embodiments, a generic reference may be chosen. In yet other possible embodiments, the classes may consist of discrete event related potential (ERP) responses. It may be clear to one of ordinary skill in the art that other biosignals including EOG, EMG, and EKG, may be similarly classified and converted into symbol sequences. In other embodiments, the signal data may be directly tokenized using discretization and a codebook. The resulting tokens may be used as part of the biosignals prompt 1636.

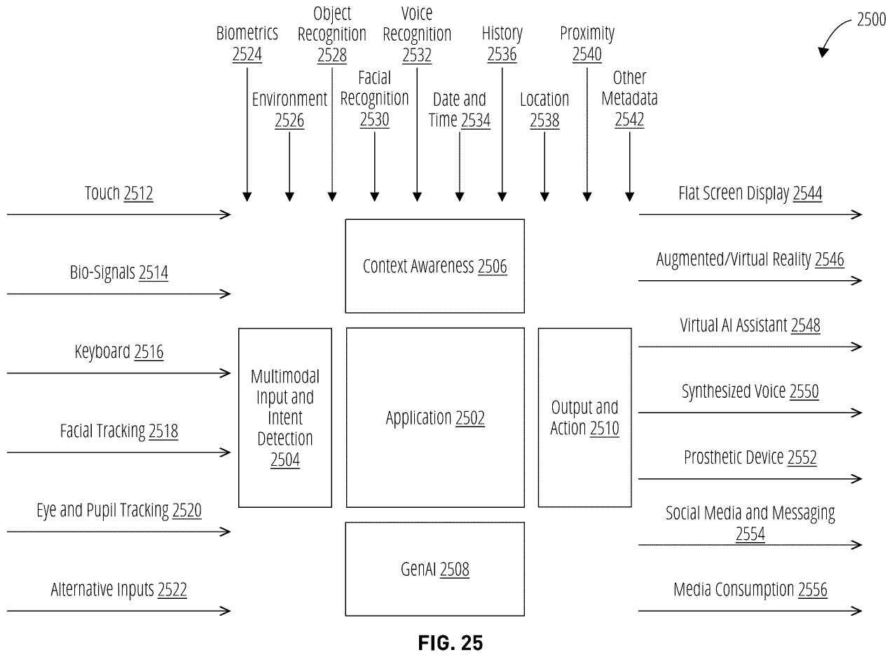

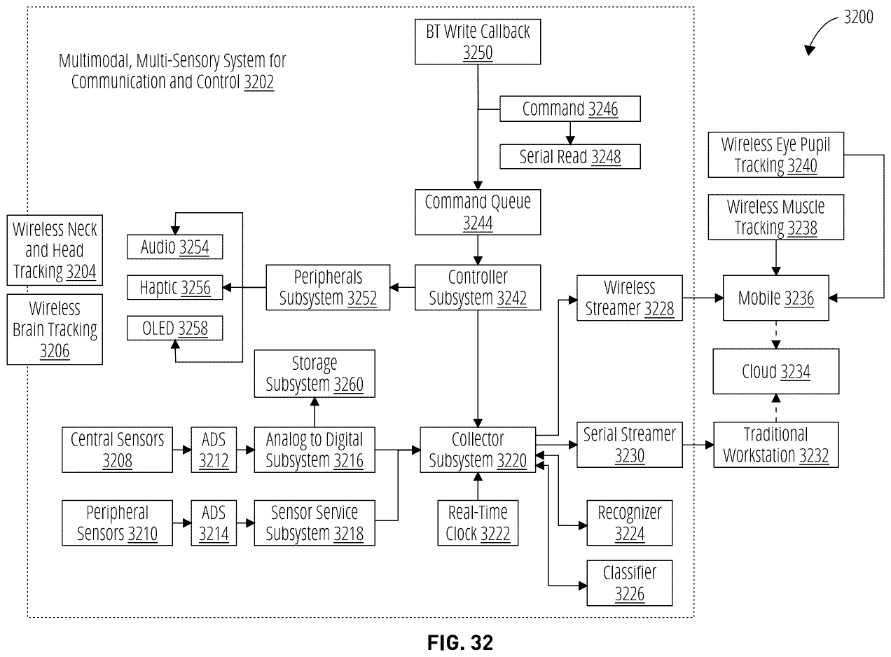

The kinematic tokenizer 1708 may receive biosignals 1606 indicative of user 1602 motion, or motion of some part of a user's body, such as gaze detection based on the orientation and dilation of a user's pupils, through eye and pupil tracking discussed with reference to FIG. 25 or FIG. 32. Such kinematic biosignals 1606 may be tokenized through the operation of the kinematic tokenizer 1708 for inclusion in the biosignals prompt 1636. Additional tokenizers 1710 may operate similarly upon other types of biosignals 1606. In one possible embodiment, the kinematic tokenizer 1708 may utilize a codebook that maps state-space values (position/orientation, velocity/angular velocity) into codes which form the sequence of codes. In other embodiments, a model-based tokenizer may be used to convert motion data into discrete code sequences.

The final output from the biosignals subsystem 1700 may be a sequence of text tokens containing a combination of the token sequences generated from the biosignals 1606, in the form of the biosignals prompt 1636. The biosignals subsystem 1700 may also have a connection with the context subsystem 1800 in advance of any prompt composition. This shared data 1642 connection may bidirectionally inform each of the subsystems to support more precise, or more optimal token generation.

FIG. 18 illustrates a context subsystem 1800 in accordance with one embodiment. The context subsystem 1800 may comprise a raw background material tokenizer 1802, a final background material tokenizer 1804, a raw sensor data tokenizer 1806, a final sensor data tokenizer 1808, a raw device data tokenizer 1810, a final device data tokenizer 1812, a raw application context tokenizer 1814, a final application context tokenizer 1816, and a context prompt composer 1818.

Broadly speaking, the user's context consists of prompts generated from a variety of different data sources, including background material 1608 that provides information about the user's previous history, sensor data 1610 and other device data 1612 captured on or around the user 1602, and application context 1614, i.e., information about the current task or interaction the user 1602 may be engaged in.

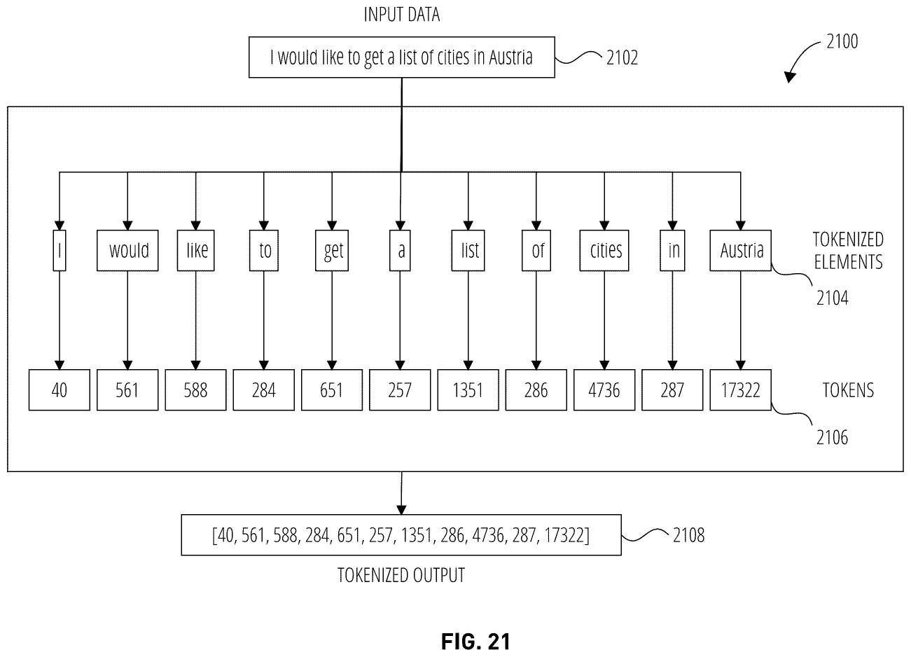

Background material 1608 may be plain text, data from a structured database or cloud data storage (structured or unstructured), or any mixture of these data types. In one embodiment background material 1608 may include textual descriptions of activities that the user 1602 has performed or requested in a similar context and their prior outcomes, if relevant. In one embodiment, background material 1608 may include general information about the user 1602, about topics relevant to the user's current environment, the user's conversational histories, a body of written or other work produced by the user 1602, or notes or other material related to the user's situation which is of a contextual or historical nature. In some embodiments, the background material 1608 may first be converted into a plain text stream and then tokenized using a plaintext tokenizer. This is illustrated in greater detail with respect to FIG. 21.

Sensor data 1610 may include microphone output indicative of sound in the user's environment, temperature, air pressure, and humidity data from climactic sensors, etc., output from motion sensors, and a number of other sensing devices readily available and pertinent to the user's surroundings and desired application of the user agency and capability augmentation system 1600. Other device data 1612 may include camera output, either still or video, indicating visual data available from the user's surrounding environment, location information from a global positioning system device, date and time data, information available via a network based on the user's location, and data from a number of other devices readily available and of use in the desired application of the user agency and capability augmentation system 1600. Scene analysis may be used in conjunction with object recognition to identify objects and people present in the user's environment, which may then be tokenized. The context subsystem may also include a mixture of physical sensors such as microphones and cameras that connect with network-connected and embedded data sources and models to generate a numerical representation of a real-time context estimate.

In some instances, the user 1602 may interact with an application on a computing device, and this interaction may be supported and expanded through the integration of a user agency and capability augmentation system 1600. In these instances, explicit specification of the application may greatly enhance the context subsystem 1800 knowledge of the user 1602 context and may facilitate a more optimal context token set. Application context 1614 data may in such a case be made available to the user agency and capability augmentation system 1600, and data from the application context 1614 data source may be tokenized as part of the operation of the context subsystem 1800, for inclusion in the context prompt 1638. Application context 1614 data may include data about the current application (e.g., web browser, social media, media viewer, etc.) along with the user's interactions associated with the application, such as a user's interaction with a form for an online food order, data from a weather application the user is currently viewing, etc.

For each data source, a raw data tokenizer may generate a set of preliminary tokens 1820. These preliminary tokens 1820 may be passed to final tokenizers for all of the data sources to be consumed as input for the final tokenizers for each data source. Each data source final tokenizer may refine its output based on the preliminary tokens 1820 provided by other data sources. This may be particularly important for background material 1608. For example, the context used by the final background material tokenizer 1804 to determine which background material 1608 elements are likely to be relevant may be the prompt generated by the raw data source tokenizers. For example, camera data and microphone data may indicate the presence and identity of another person within the user's immediate surroundings. Background material 1608 may include emails, text messages, audio recordings, or other records of exchanges between this person and the user, which the final background material tokenizer 1804 may then include and tokenize as of particular interest to the user's present context.

The context subsystem 1800 may send the final tokens output from the final tokenizers for each data source to a context prompt composer 1818. The context prompt composer 1818 may use these final tokens 1822, in whole or in part, to generate a context prompt 1638, which may be the final output from the context subsystem 1800. The context prompt 1638 may be a sequence of text tokens containing the combination of the background, audio/video, and other final tokens 1822 from the final background material tokenizer 1804, final sensor data tokenizer 1808, final device data tokenizer 1812, and final application context tokenizer 1816. In the simplest embodiment, the context prompt composer 1818 concatenates all the final tokens 1822. In other possible embodiments, the context prompt composer 1818 creates as its context prompt 1638 a structured report that includes additional tokens to assist the GenAI in parsing the various final tokens 1822 or prompts.

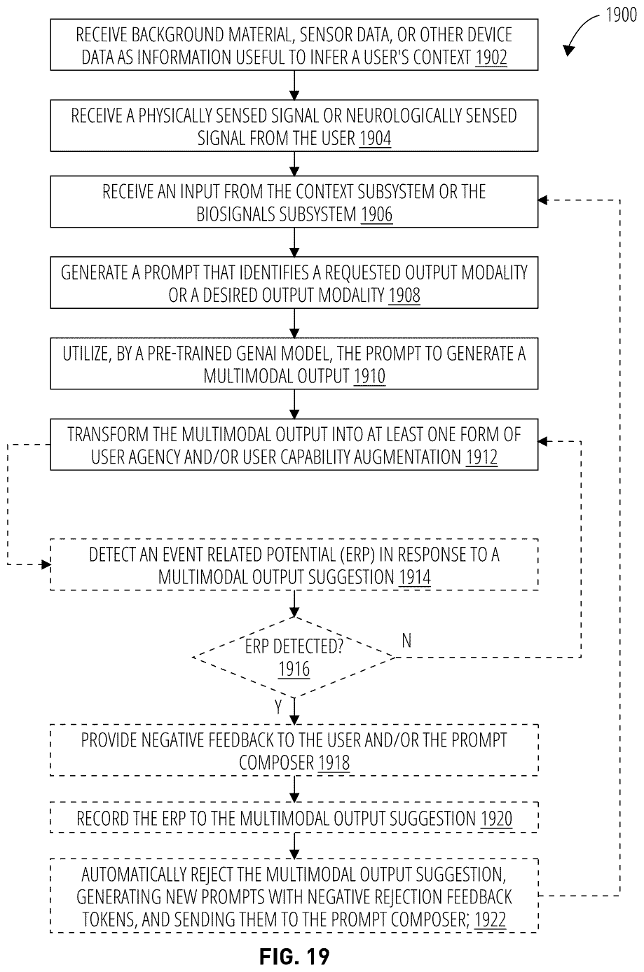

FIG. 19 illustrates an example routine 1900 for implementation using a human augmentation platform using context, biosignals, and Generative AI. Such a routine 1900 may be performed through the operation of a user agency and capability augmentation system 1600 such as that illustrated and described with respect to FIG. 16. Although the example routine 1900 depicts a particular sequence of operations, the sequence may be altered without departing from the scope of the present disclosure. For example, some of the operations depicted may be performed in parallel or in a different sequence that does not materially affect the function of the routine 1900. In other examples, different components of an example device or system that implements the routine 1900 may perform functions at substantially the same time or in a specific sequence.

According to some examples, the method includes receiving, by a context subsystem, at least one of background material, sensor data, and other device data as information useful to infer a user's context at block 1902. For example, the context subsystem 1800 illustrated in FIG. 18 may receive background material, sensor data, or other device data as information useful to infer a user's context. In one embodiment, the at least one of the sensor data and the other device data may be received by the context subsystem from at least one of a camera and a microphone array. In one embodiment, the context subsystem may also receive application context from applications installed on computing or smart devices in communication with the context subsystem.

According to some examples, the method includes receiving, by a biosignals subsystem, at least one of a physically sensed signal and a neurologically sensed signal from the user at block 1904. For example, the biosignals subsystem 1700 illustrated in FIG. 17 may receive a physically sensed signal or neurologically sensed signal from the user as the biosignals 1606 introduced in FIG. 16. In one embodiment, the biosignals subsystem may receive biosignals data from biometric sensors for at least one of electroencephalography (EEG), electrocorticography (ECOG), electrocardiogram (ECG or EKG), electromyography (EMG), electrooculography (EOG), pulse determination, heart rate variability determination, blood sugar sensing, and dermal conductivity determination.

According to some examples, the method includes receiving, by a prompt composer, an input from at least one of the context subsystem and the biosignals subsystems; at block 1906. For example, the prompt composer 1616 illustrated in FIG. 16 may receive an input from the context subsystem or the biosignals subsystem. In one embodiment, the prompt composer may additionally receive a user input prompt. In this manner, a user may directly and explicitly provide instruction to the prompt composer.

According to some examples, the method includes generating, by the prompt composer, a prompt that identifies at least one of a requested output modality and a desired output modality at block 1908. For example, the prompt composer 1616 illustrated in FIG. 16 may generate a prompt that identifies a requested output modality or a desired output modality. In one embodiment, the prompt composer may generate at least one of a single token, a string of tokens, a series of conditional or unconditional commands suitable to prompt the GenAI model, tokens that identify at least one of the requested output modality and the desired output modality, an embedding to be provided separately to the GenAI model for use in an intermediate layer of the GenAI model, and multiple tokenized sequences at once that constitute a series of conditional commands.

According to some examples, the method includes utilizing, by a pre-trained Generative Artificial Intelligence (GenAI) model, the prompt to generate a multimodal output at block 1910. For example, the GenAI 1618 illustrated in FIG. 16 may utilize, by a pre-trained GenAI model, the prompt to generate a multimodal output. In one embodiment, the GenAI model may be at least one of large language models (LLMs), Generative Pre-trained Transformer (GPT) models, text-to-image creators, visual art creators, and generalist agent models.

According to some examples, the method includes transforming, by an output stage, the multimodal output into at least one form of user agency, user capability augmentation, and combinations thereof at block 1912. For example, the multimodal output stage 1620 illustrated in FIG. 16 may transform the multimodal output into at least one form of user agency and/or user capability augmentation. In one embodiment, the at least one form of the user agency includes neural stimulation to the user with Transcranial Direct Current Stimulation (tDCS), direct brain stimulation (DBS), or other known neural stimulation techniques. In one embodiment, the multimodal output may be in the form of at least one of text-to-speech utterances, written text, multimodal artifacts, other user agency supportive outputs, and commands to a non-language user agency device. In one embodiment, the output stage may receive an output mode selection signal from the user. The output mode selection signal may be a direct selection or may be generated from the user's biosignals. The output mode selection signal may instruct the output stage of a choice between multimodal outputs or may direct one or more alternative multimodal outputs to alternate endpoints. In one embodiment, an encoder/parser framework, such as the encoder/parser 1632 of FIG. 16, may encode the multimodal output to provide control commands to control at least one of a non-language user agency device, a robot system, and smart AI-powered devices.

According to some examples, the method includes detecting, using an output adequacy feedback system, an event related potential (ERP) which may be an error-related negativity in response to a multimodal output suggestion at block 1914.

According to some examples, the method includes, if an ERP is detected at decision block 1916, providing negative feedback to at least one of the user and the prompt composer at block 1918. The prompt composer may provide the negative feedback to the GenAI model.

According to some examples, the method includes, if an ERP is detected at decision block 1916, recording the ERP to the multimodal output suggestion at block 1920.

According to some examples, the method includes, if an ERP is detected at decision block 1916, automatically rejecting the multimodal output suggestion, generating new prompts with negative rejection feedback tokens, and sending the negative rejection feedback tokens to the prompt composer at block 1922.

### Simultaneous Users

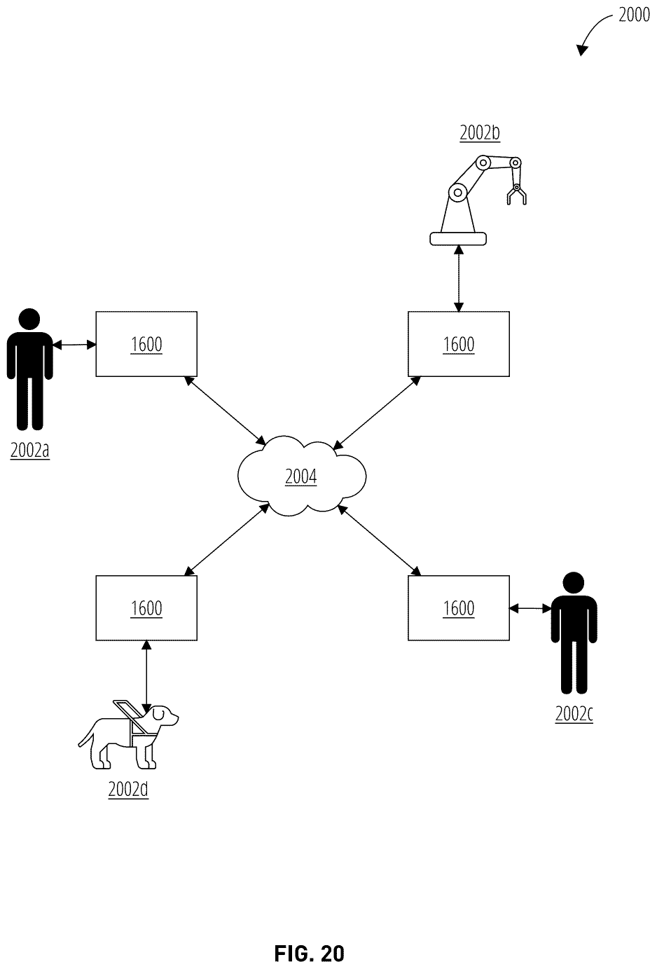

FIG. 20 illustrates a multiuser system 2000 in accordance with one embodiment. In some embodiments more than one user may be interacting simultaneously with a common artifact, environment, or in a social scenario. In these embodiments, each of simultaneous user 2002a, 2002b, 2002c, and 2002d, may interact with an instance of one or more of the user agency and capability augmentation system 1600 embodiments described herein.

Further, when multiple such user agency and capability augmentation systems 1600 are present, they may establish direct, digital communication with each other via a local area or mesh network 2004 to support direct context transmission and exchange of GenAI 1618 outputs.

In some instances, one or more of the simultaneous users may be a robot or other autonomous agent, such as simultaneous user 2002b. In other instances, one or more of the simultaneous users may be another human user, as shown by simultaneous user 2002c. In yet other instances, one or more of the users may be an assistive animal such as a sight impairment support dog, as shown by simultaneous user 2002d.

FIG. 21 illustrates an exemplary tokenizer 2100 in accordance with one embodiment. Input data 2102 may be provided to the exemplary tokenizer 2100 in the form of a text string typed by a user. In one embodiment, the text string may be generated by performing voice-to-text conversion on an audio stream. The exemplary tokenizer 2100 may detect tokenizable elements 2104 within the input data 2102. Each tokenizable element 2104 may be converted into a token 2106. The set of tokens 2106 created from the tokenizable elements 2104 of the input data 2102 may be sent from the exemplary tokenizer 2100 as tokenized output 2108. The set of tokens 2106 may be such as are used to create the prompt 1644 of FIG. 16.

For structured historical data such as plaintext, database, or web-based textual content, tokens may consist of the numerical indexes in an embedded or vectorized (e.g., word2vec or similar) representation of the text content such as are shown here. In some embodiments, a machine learning technique called an autoencoder may be utilized to transform plaintext inputs into high dimensional vectors that are suitable for indexing and tokenization ingestion by the prompt composer 1616 introduced with respect to FIG. 16.

In some embodiments, data to be tokenized may include audio, visual, or other multimodal data. For images, video, and similar visual data, tokenization may be performed using a convolution-based tokenizer such as a vision transformer. In some alternate embodiments, multimodal data may be quantized and converted into tokens 2106 using a codebook. In yet other alternate embodiments, multimodal data may be directly encoded and for presentation to a language model as a vector space encoding. An exemplary system that utilizes this tokenizer strategy is Gato, a generalist agent capable of ingesting a mixture of discrete and continuous inputs, images, and text as tokens.

FIG. 22A illustrates an isometric view of a BCI headset system 2200 in accordance with one embodiment. The BCI headset system 2200 comprises an augmented reality display lens 2202, a top cover 2204, an adjustable strap 2206, a padding 2208, a ground/reference electrode 2210, a ground/reference electrode adjustment dial 2212, a biosensor electrodes 2214, a battery cell 2216, a fit adjustment dial 2218, and a control panel cover 2220.

The augmented reality display lens 2202 may be removable from the top cover 2204 as illustrated in FIG. 22C. The augmented reality display lens 2202 and top cover 2204 may have magnetic portions that facilitate removably securing the augmented reality display lens 2202 to the top cover 2204. The augmented reality display lens 2202 may in one embodiment incorporate a frame around the lens material allowing the augmented reality display lens 2202 to be handled without depositing oils on the lens material.

The adjustable strap 2206 may secure the BCI headset system 2200 to a wearer's head. The adjustable strap 2206 may also provide a conduit for connections between the forward housing 2232 shown in FIG. 22C and the components located along the adjustable strap 2206 and to the rear of the BCI headset system 2200. Padding 2208 may be located at the front and rear of the BCI headset system 2200, as well as along the sides of the adjustable strap 2206, as illustrated. A fit adjustment dial 2218 at the rear of the BCI headset system 2200 may be used to tighten and loosen the fit of the BCI headset system 2200 by allowing adjustment to the adjustable strap 2206.

A snug fit of the BCI headset system 2200 may facilitate accurate readings from the ground/reference electrodes 2210 at the sides of the BCI headset system 2200, as illustrated here in FIG. 22A as well as in FIG. 22C. A snug fit may also facilitate accurate readings from the biosensor electrodes 2214 positioned at the back of the BCI headset system 2200. Further adjustment to these sensors may be made using the ground/reference electrode adjustment dials 2212 shown, as well as the biosensor electrode adjustment dials 2224 illustrated in FIG. 22B.

In addition to the padding 2208, biosensor electrodes 2214, and fit adjustment dial 2218 already described, the rear of the BCI headset system 2200 may incorporate a battery cell 2216, such as a rechargeable lithium battery pack. A control panel cover 2220 may protect additional features when installed, those features being further discussed with respect to FIG. 22B.

FIG. 22B illustrates a rear view of a BCI headset system 2200 in accordance with one embodiment. The control panel cover 2220 introduced in FIG. 22B is not shown in this figure, so that underlying elements may be illustrated. The BCI headset system 2200 further comprises a control panel 2222, a biosensor electrode adjustment dials 2224, an auxiliary electrode ports 2226, and a power switch 2228.

With the control panel cover 2220 removed, the wearer may access a control panel 2222 at the rear of the BCI headset system 2200. The control panel 2222 may include biosensor electrode adjustment dials 2224, which may be used to calibrate and adjust settings for the biosensor electrodes 2214 shown in FIG. 22A.

The control panel 2222 may also include auxiliary electrode ports 2226, such that additional electrodes may be connected to the BCI headset system 2200. For example, a set of gloves containing electrodes may be configured to interface with the BCI headset system 2200, and readings from the electrodes in the gloves may be sent to the BCI headset system 2200 wirelessly, or via a wired connection to the auxiliary electrode ports 2226.

The control panel 2222 may comprise a power switch 2228, allowing the wearer to power the unit on and off while the control panel cover 2220 is removed. Replacing the control panel cover 2220 may then protect the biosensor electrode adjustment dials 2224 and power switch 2228 from being accidentally contacted during use. In one embodiment, a power light emitting diode (LED) may be incorporated onto or near the power switch 2228 as an indicator of the status of unit power, e.g., on, off, battery low, etc.

FIG. 22C illustrates an exploded view of a BCI headset system 2200 in accordance with one embodiment. The BCI headset system 2200 further comprises a universal serial bus or USB port 2230 in the rear of the BCI headset system 2200 as well as a forward housing 2232 which may be capable of holding a smart phone 2234. The USB port 2230 may in one embodiment be a port for a different signal and power connection type. The USB port 2230 may facilitate charging of the battery cell 2216 and may allow data transfer through connection to additional devices and electrodes.

The top cover 2204 may be removed from the forward housing 2232 as shown to allow access to the forward housing 2232, in order to seat and unseat a smart phone 2234. The smart phone 2234 may act as all or part of the augmented reality display. In a BCI headset system 2200 incorporating a smart phone 2234 in this manner, the augmented reality display lens 2202 may provide a reflective surface such that a wearer is able to see at least one of the smart phone 2234 display and the wearer's surroundings within their field of vision. In one embodiment, this reflective surface may support reflecting AR overlays back to the user that are visible to the user but not visible to persons or entities in proximity to the user.

The top cover 2204 may incorporate a magnetized portion securing it to the forward housing 2232, as well as a magnetized lens reception area, such that the augmented reality display lens 2202 may, through incorporation of a magnetized frame, be secured in the front of the top cover 2204, and the augmented reality display lens 2202 may also be removable in order to facilitate secure storage or access to the forward housing 2232.

FIG. 22D illustrates an exploded view of a BCI headset system 2200 in accordance with one embodiment. The BCI headset system 2200 further comprises a smart phone slot 2236 in the forward housing 2232. When the augmented reality display lens 2202 and top cover 2204 are removed to expose the forward housing 2232 as shown, the smart phone slot 2236 may be accessed to allow a smart phone 2234 (not shown in this figure) to be inserted.

### Additional System Embodiment Details

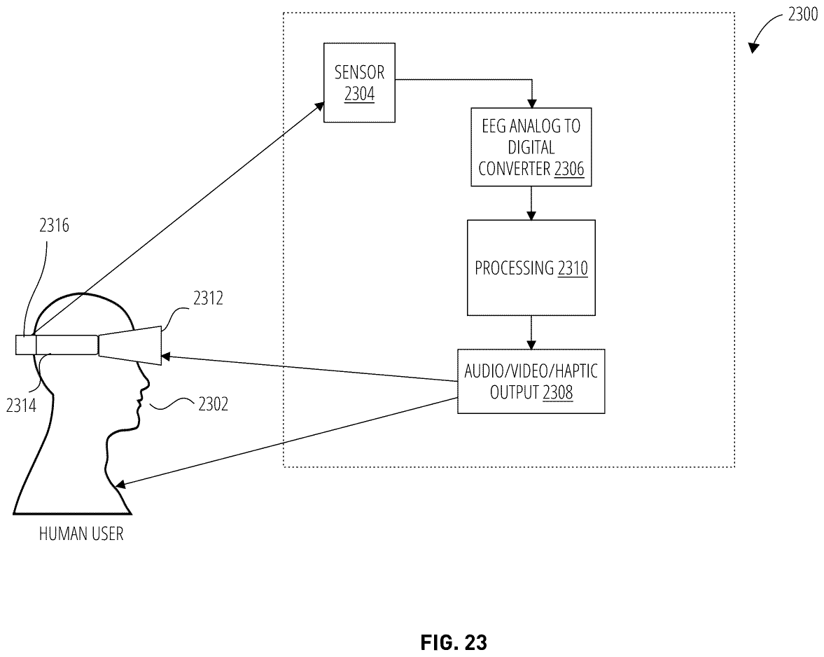

FIG. 23 illustrates an embodiment of a BCI+AR environment 2300. The BCI+AR environment 2300 comprises a sensor 2304, an EEG analog to digital converter 2306, an Audio/Video/Haptic Output 2308, a processing 2310, a strap 2314, an augmented reality glasses 2312, a human user 2302, and a BCI 2316. A human user 2302 is wearing BCI 2316, which is part of a headset. When the human user 2302 interacts with the environment, the sensor 2304, located within the BCI 2316, reads the intentions and triggers the operating system. The EEG analog to digital converter 2306 receives the sensor 2304 output (e.g., intention). EEG analog to digital converter 2306 transforms the sensor output into a digital signal which is sent to processing 2310. The signal is then processed, analyzed and mapped to an Audio/Video/Haptic Output 2308 and displayed on the augmented reality glasses 2312.

In an embodiment, strap 2314 is a head strap for securing the AR+BCI to the human head. In some embodiments, such as an implantable BCI, and AR system, the strap may not be used. The strapless system may use smart glasses or contact lenses. There may be multiple sensors, but no less than one sensor, in different embodiments. After seeing the output, the user may have different bio-signals from the brain, and as such this is a closed-loop biofeedback system. As the user focuses more on the SSVEP stimuli, the audio may feedback by frequency, power (volume), and selected cue audio to assist the human in reinforcing their focus on the stimuli. This may also occur with the vibration type and intensity of the haptics, as well as additional peripheral visual cues in the display. This feedback is independent from the audio and haptics that may play back through the AR headset via a smartphone. It is even possible to remotely add to the sensory mix that of olfactory (smell) feedback that actually travels through entirely different parts of the brain that has been shown to be one of the strongest bio-feedback reinforcements in human cognitive training.

As a non-limiting example, when someone uses the BCI for the first time, they are considered a “naïve” user, or one whose brain has never been trained with this kind of user interface. As a user continues to use it, their brain becomes less naïve and more capable and trained. They may become quicker and quicker at doing it. This is reinforcement learning—the BCI allows someone to align their intention and attention to an object and click it.

In an embodiment, to enrich the user interface experience, multiple feedback modalities (auditory, visual, haptic, and olfactory) may be available for choosing the most advantageous feedback modality for the individual or for the type of training. For example, when an appropriate brain wave frequency is generated by the user, real-time feedback about the strength of this signal may be represented by adjusting the intensity and frequency of the audio or haptic feedback. In addition, the possibility of using multimodal feedback means that multiple sensory brain regions are stimulated simultaneously, which enhances the neural signal and representation of feedback, thereby accelerating learning and neural plasticity.

An advantage of using odors as reinforcers may be due to the direct link between the brain areas that sense smell (olfactory cortex) and those that form memories (hippocampus) and produce emotions (amygdala). Odors may strengthen memory encoding, consolidation, and trigger recall.

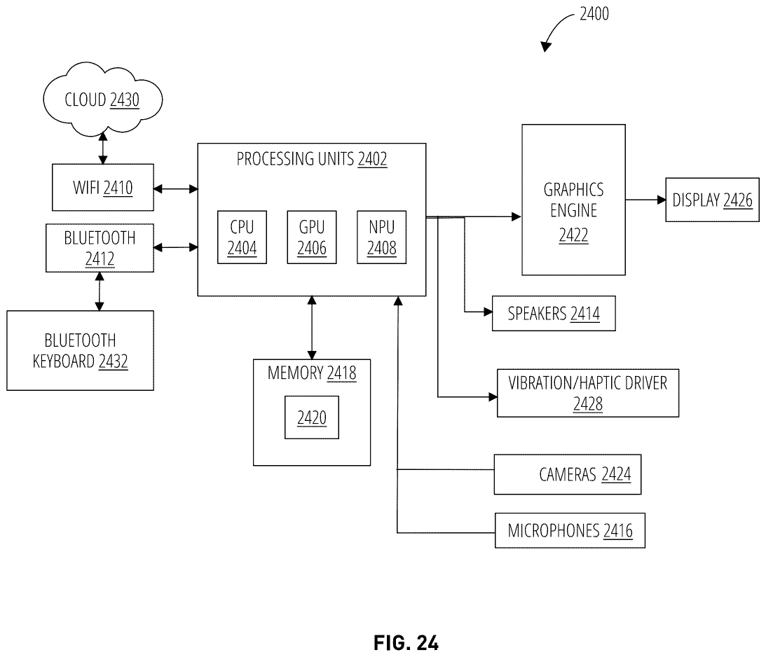

FIG. 24 illustrates components of an exemplary augmented reality device logic 2400. The augmented reality device logic 2400 comprises a graphics engine 2422, a camera 2424, processing units 2402, including one or more central processing units CPU 2404, graphical processing units GPU 2406, and/or neural processing units NPU 2408, a WiFi 2410 wireless interface, a Bluetooth 2412 wireless interface, speakers 2414, microphones 2416, one or more memory 2418, logic 2420, a visual display 2426, and vibration/haptic driver 2428.

The processing units 2402 may in some cases comprise programmable devices such as bespoke processing units optimized for a particular function, such as AR related functions. The augmented reality device logic 2400 may comprise other components that are not shown, such as dedicated depth sensors, additional interfaces, etc.

Some or all of the components in FIG. 24 may be housed in an AR headset. In some embodiments, some of these components may be housed in a separate housing connected or in wireless communication with the components of the AR headset. For example, a separate housing for some components may be designed to be worn or a belt or to fit in the wearer's pocket, or one or more of the components may be housed in a separate computer device (smartphone, tablet, laptop or desktop computer etc.) which communicates wirelessly with the display and camera apparatus in the AR headset, whereby the headset and separate device constitute the full augmented reality device logic 2400. A user may also communicate with the AR headset via a Bluetooth keyboard 2432. Additionally, the AR headset may communicate with the cloud 2430 via WiFi 2410 or cellular connection.

The memory 2418 comprises logic 2420 to be applied to the processing units 2402 to execute. In some cases, different parts of the logic 2420 may be executed by different components of the processing units 2402. The logic 2420 typically comprises code of an operating system, as well as code of one or more applications configured to run on the operating system to carry out aspects of the processes disclosed herein.

FIG. 25 is a block diagram of nonverbal multi-input and feedback device 2500 of a nonverbal multi-input and feedback device such as herein. It may be a block diagram of a portion of the device such as a processing portion of the device. FIG. 25 may be a high-level system architecture block diagram that helps explain the major building blocks. Block diagram of nonverbal multi-input and feedback device 2500 may be applied to the overall system (e.g., multiple devices used as inputs), into a common universal application interface that allows the application 2502 to synchronize data coming from multiple devices and process signals with meta data, plus vocabulary and output logic to a plurality of output methods.

In the center of block diagram of nonverbal multi-input and feedback device 2500 is the application 2502 or main processing block. To the left is the multimodal input and intent detection 2504 block which receives and processes user inputs from sensors (e.g., based on user input received by the sensors) such as touch 2512; bio-signals 2514; keyboard 2516; facial tracking 2518; eye and pupil tracking 2520; and alternative inputs 2522. This multimodal input and intent detection 2504 block feeds the processing from these inputs to the application 2502.

Above is a context awareness 2506 block which receives and processes metadata inputs from sensors such as biometrics 2524; environment 2526; object recognition 2528; facial recognition 2530; voice recognition 2532; date and time 2534; history 2536; location 2538; proximity 2540; and other metadata 2542 inputs. This context awareness 2506 block feeds the processing from these inputs to the application 2502.

To the right is an output and action 2510 block which sends outputs to displays, computing devices, controllers, speakers and network communication devices such as flat screen flat screen display 2544; augmented/virtual reality 2546; virtual AI assistant 2548; synthesized voice 2550; prosthetic device 2552; social media and messaging 2554; media consumption 2556; and other output. The outputs may include control commands and communication sent to other computing devices. They may include text, graphics, emoji, and/or audio.

Below is a GenAI 2508 block that provides a lexicon or vocabulary in the selected language to the application. FIG. 25 may also be applied to a single sensory device unto itself. This may be a “Big Idea” in so far as the architecture may scale from a single closed-loop system as well as combinations of sensory I/O devices. It may be a system of systems that scale up, down and play together.

The system in block diagram of nonverbal multi-input and feedback device 2500 comprises one (or more) sensory input, one intent detection application programming interface (API), one application, one (or more) meta data, one (or more) vocabulary, one (or more) output and action method, and one (or more) output/actuation system or device. It may be thought of as a universal “augmented intelligence” engine that takes inputs, enriches them with extra meaning, and directs the output based on instructions for the enriched information.

In a simple embodiment of diagram, a user sees a symbol or button that means “help”, and presses it, and the device says “help”. In a more complicated embodiment of block diagram of nonverbal multi-input and feedback device 2500, a user sees a symbol or button that means “help” and presses it. Here, rather than the device saying “help,” it learns that the user is connected to a caregiver with logic to send urgent matters to that person via text or instant message when away from home. The device may geolocation data that indicates the user is away from home; tag the communication with appended contextual information; and its output and action logic tell the system to send a text message to the caregiver with the user's location in a human-understandable grammatically correct phrase “Help, I'm in Oak Park” including the user's Sender ID/Profile and coordinates pinned on a map.

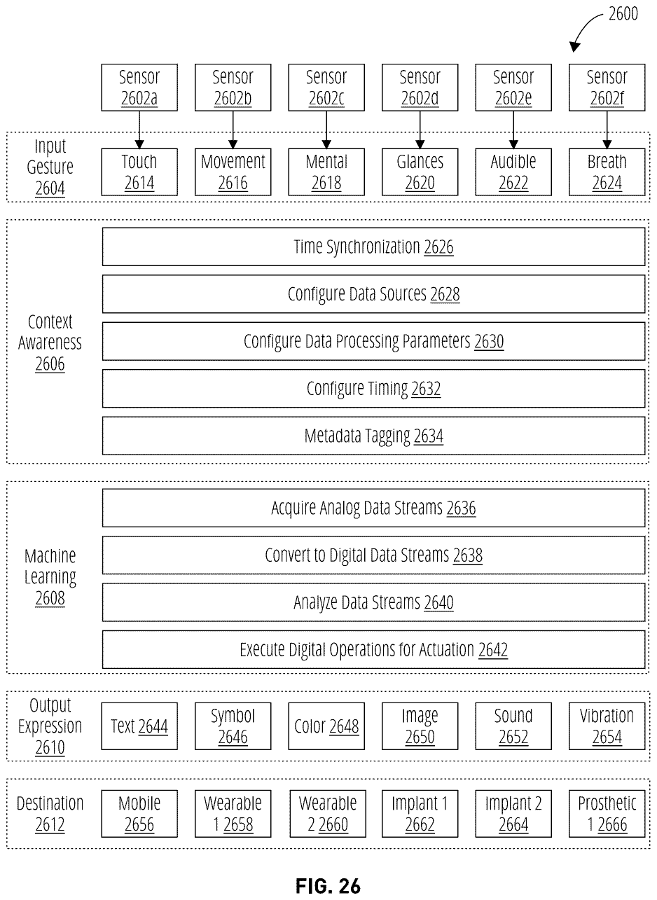

FIG. 26 is a block diagram of a single framework of a nonverbal multi-input and feedback device 2600 such as herein. The block diagram of a single framework of a nonverbal multi-input and feedback device 2600 may be of a single framework for translating diverse sensor inputs into a variety of understandable communication and command outputs for a nonverbal multi-input and feedback device such as herein. The single framework of a nonverbal multi-input and feedback device comprises sensors 2602a-2602f, input gestures 2604, context awareness 2606, machine learning 2608, output expressions 2610, and destinations 2612. Input gestures 2604 may include touch 2614, movement 2616, mental 2618, glances 2620, audible 2622, and breath 2624. Context awareness 2606 may include time synchronization 2626, configure data sources 2628, configure data processing parameters 2630, configure timing 2632, and metadata tagging 2634. Machine learning 2608 may include an acquire analog data streams 2636, convert to digital data streams 2638, analyze data streams 2640, and execute digital operations for actuation 2642. Output expressions 2610 may include text 2644, symbol 2646, color 2648, an image 2650, sound 2652, and vibration 2654. Destinations 2612 may include a mobile 2656, a wearable 1 2658, a wearable 2 2660, an implant 1 2662, an implant 2 2664, and a prosthetic 1 2666.

FIG. 26 may describe in more detail what kind of processing is happening within and across the blocks of FIG. 25. Specifically, the left intention signals being combined with context awareness metadata to enrich the data in order to determine the logic of the output and action. FIG. 26 may include the description of the GenAI 2508 and application 2502 boxes of FIG. 25, though not shown. It may be a block diagram of a portion of the device such as a processing portion of the device. In the framework, input from the sensors 2602a-2602f (e.g., due to input received by the sensors) are received by or as an input gesture 2604. In the framework, context awareness 2606 awareness is used to interpret or determine the user gesture or intent from the inputs received. In the framework machine learning 2608 is used to interpret or determine the user gesture or intent from the inputs received. In the framework, output expression 2610 is used to determine the outputs, such as control commands and communication sent to other computing devices that include text, graphics, emoji, and/or audio. In the framework, destination 2612 is used to determine where the outputs are sent, such as to what other computing devices the command and/or communications are to be sent (such as by the network). The user's Primary and Secondary language preferences are accessed during the processing of intention data which is stored in the GenAI 2508 subsystem such as shown in FIG. 25, and may be accessed in the context awareness 2606, machine learning 2608 and output and action 2510 systems and methods in FIG. 25 and FIG. 26.

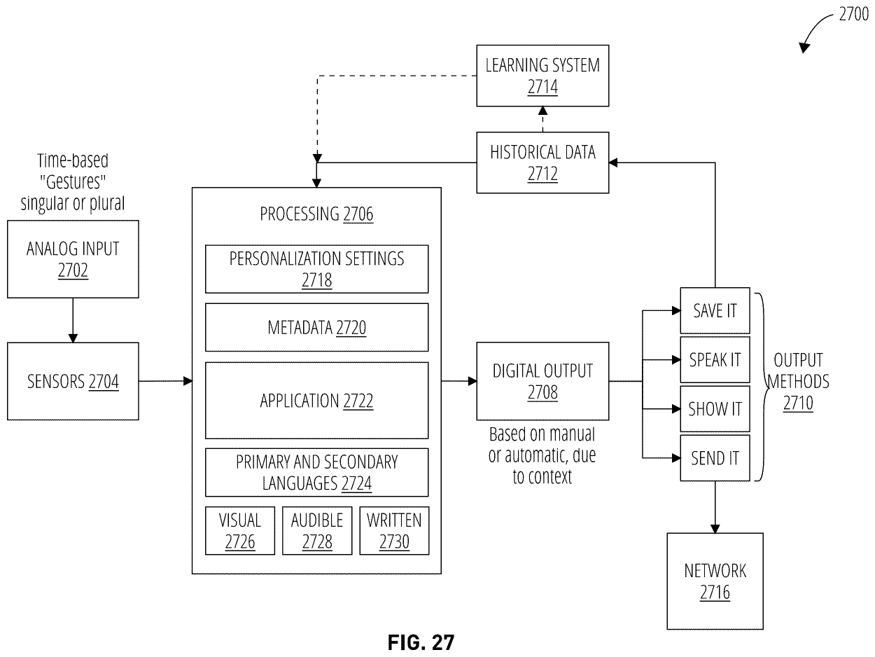

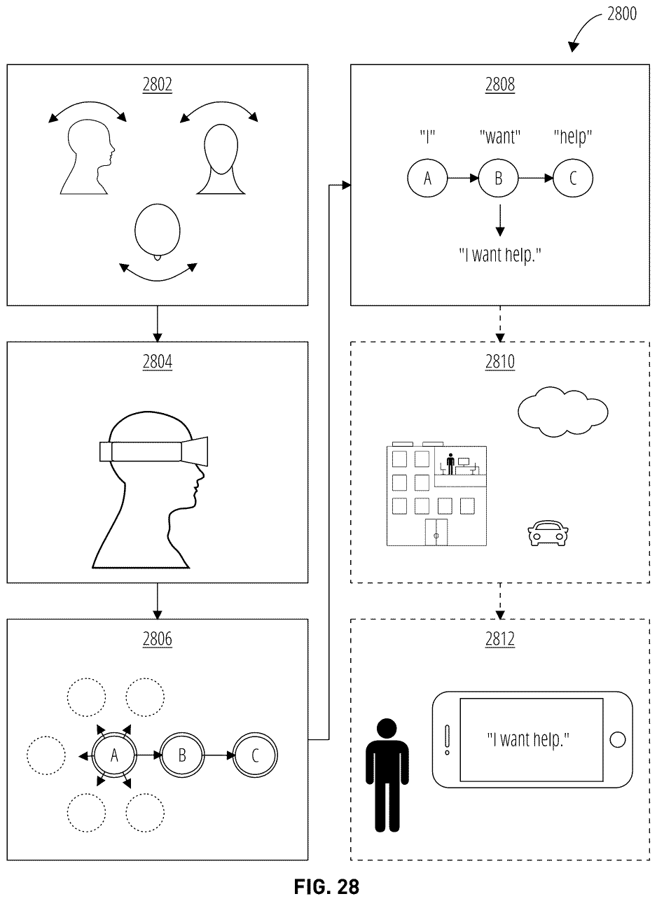

FIG. 27 illustrates a block diagram of nonverbal multi-input and feedback device 2700 in one embodiment. The block diagram of nonverbal multi-input and feedback device 2700 shows a system comprising analog input 2702, sensors 2704, processing 2706, digital output 2708, and output methods 2710 that may be performed with the digital output 2708.

The system illustrated may include an application programming interface (API) that is interoperable with multiple types of analog input 2702 from the sensors 2704. The system illustrated may also comprise a real-time clock for tracking, synchronizing, and metadata 2720 tagging of data streams and analog inputs 2702. The system further comprises a subsystem for data storage and management, for historical data 2712 in some embodiments. The system may comprise a subsystem for personalization settings 2718, as well as a subsystem for sourcing and integrating metadata 2720 into the application 2722 and data stream. The system may further comprise a software application 2722. In some embodiments, the system may include a graphical user interface (GUI) for the software application for the user. In other embodiments, the system may include a GUI for the software application for others who are connected to a system user.

A subsystem of the system may include processing for visual 2726, audible 2728, and written 2730 languages. This language subsystem may differentiate between the user's primary and secondary languages 2724. The language subsystem may set the secondary language manually or automatically. Attributes processed by visual 2726, audible 2728, and written 2730 language subsystems may include but not be limited to color, image, graphics, audible tones, phonemes, dialects, jargon, semantics, tonality, and written characters. In one embodiment, the language subsystems may consist of a suitably trained generative AI model.

The system may include a subsystem of digital outputs 2708 and output methods 2710, that may be configured either manually or automatically. The variety of output methods 2710 may include a network 2716 interface connection. The system may comprise a subsystem for managing data transfer over the network 2716.

The system in some embodiments may comprise a historical data 2712 subsystem for closed-loop machine learning of the system and subsystems and the sensory devices being used with the system. In some embodiments, improved models, algorithms and software may be pushed from the learning system 2714 to update and be used within the system and subsystems and the sensory devices being used with the system.

In one embodiment, the system and subsystems may operate entirely on a sensory device. In one embodiment, the system and subsystems may operate partially on a sensory device and partially distributed to other devices or the cloud. In one embodiment, the system and subsystems may operate entirely distributed on other devices or the cloud.

The system of FIG. 27 may be one embodiment of a fully self-contained brain computer interface in a wireless headset, comprising an augmented reality display as part of the digital output 2708, at least two sensors 2704 for reading a bio-signal from a user as analog input 2702, at least one processing 2706 module for the augmented reality display, at least one biofeedback device that produces at least one of a visual, audible, and tactile effect in communication with the processing module to provide feedback to the user, a wireless network interface that transmits and receives data to and from other devices over the processing 2706, wherein the data is at least one of stored, passed through, and processed on the fully self-contained BCI, as part of the output methods 2710, a battery, wherein the battery provides power to one or more of the augmented reality display, the at least two sensors, the processing module, and the at least one biofeedback device, at least one of onboard storage or remote storage with enough memory to store, process and retrieve the data, and a printed circuit board.

Bio-signals from the user may comprise at least one of EEG, ECG, functional near infrared spectroscopy (fNIRS), Magnetoencephalography (MEG), EMG, EOG, and Time-Domain variants (TD-) of these bio-signal processing methods. Bio-signals may also comprise a visually evoked potential, an audio evoked potential, a haptic evoked potential, and a motion evoked potential, and other bio-signals from multiple sources attached to other body parts other than a user's head.

The at least one processing module for the augmented reality display may include a processor that renders a stimulation effect. This stimulation effect may be at least one of a timed visual stimulation on the augmented reality display, a timed audio stimulation, and a haptic stimulation on the fully self-contained BCI configured to evoke a measurable response in a user's brain. The processing module may include a processor that analyzes and maps the bio-signal into a digital command. This digital command may include at least one of instructions for a visual output configured for displaying on the augmented reality display and instructions for triggering a visual effect. The processing module may be embodied as the processing units 2402 introduced in FIG. 24.

The printed circuit board may include at least one of the at least two sensors, the processing module, the at least one biofeedback device, the battery, and combinations thereof. The printed circuit board may be configured to emulate a Bluetooth keyboard and send output data to at least one of a mobile device, a computer, and the augmented reality display. The output data may include at least one of a letter, a character, a number, and combinations thereof.

Processing performed by the processing module may include the visually evoked potential, the audio evoked potential, and the haptic evoked potential. The bio-signal is processed and analyzed in real-time. The processing module may have different modes, including raw, simmer, and cooked modes, a human interface device-keyboard mode, and combinations thereof. The system may also have a strapless mode, wherein the fully self-contained BCI uses smart glasses or smart contact lenses, an implantable brain computer interface, and an AR system.

The raw mode may stream a full EEG sensor stream of data for further processing locally on device or remotely in a cloud via a mobile or desktop internet connected device that may filter, recognize, or interact with the full EEG sensor stream of data. The cooked mode may comprise a fully processed custom digital command generated by a local recognizer and classifier. This cooked mode data may consist of a sequence of biosignals tokens, as provided by the EEG tokenizer 1706, the kinematic tokenizer 1708, or the additional tokenizers 1710 introduced with respect to FIG. 17. The fully processed custom digital command may be sent to a destination system over the network 2716, per the “send it” output method 2710, and executed on the destination system, with no raw data passed to the user. The recognizer and classifier may be embodied as the recognizer 3224 and classifier 3226 introduced in FIG. 32. The simmer mode may be a hybrid combination between the raw mode and the cooked mode, and the at least one processing module may intersperse a raw data stream with cooked metadata 2720 appended to bio-signal data.

Time domain data may be appended to raw data, cooked data, and simmer data in order for the system to process bio-signal data streams from multiple bio-signal data sources and ensure all bio-signal data streams are synchronized. Metadata from other sensors and data sources may be appended to the raw data, the cooked data, and the simmer data in order for a classifier to alter the command that is sent to execute on a destination system. This classifier may be embodied as the classifier 3226 introduced in FIG. 32. Visual, audible, and tactile sensory frequency stimulators may be appended with metadata from other sensors 2704 and data sources wherein the visual, audible, and tactile sensory frequency stimulators are altered to produce a unique pattern which includes metadata that is decodable by the recognizer and classifier.

The fully self-contained BCI may be electrically detached from the augmented reality display and may be configured to transfer data wirelessly or via a wired connection to an external augmented reality display. The fully self-contained BCI in the wireless headset may be an accessory apparatus that is configured to be temporarily mechanically integrated with another wearable device and configured to transfer data wirelessly or via a wired connection to the other wearable device. The fully self-contained BCI may in another embodiment be permanently mechanically integrated with another wearable device and may transfer data wirelessly or via a wired connection to the other wearable device.

A charging port may be connected to a charging bridge, wherein the charging bridge includes internal circuitry and data management connected to the fully self-contained BCI and the augmented reality display. The internal circuitry may include charging circuitry, thereby allowing charging of both the fully self-contained BCI and the augmented reality display with the charging circuitry.

The fully self-contained BCI may be configured to generate visual, auditory, or haptic stimulations to a user's visual cortex, a user's auditory cortex, and a user's somatosensory cortex, thereby resulting in detectable brain wave frequency potentials that are at least one of stimulated, event-related, and volitionally evoked. The BCI may process the detectable brain wave frequencies, thereby facilitating mapping of bio-signals to digital commands. Stimulation effects and digital commands may be altered with metadata from other sensors or data sources.

The BCI may synchronize bio-signal processing from multiple sensors with a real-time clock such as the real-time clock 3222 introduced in FIG. 32. Digital commands may be associated with a device. The device may be operated according to the digital commands. The BCI may stimulate the user's visual cortex, wherein stimulating includes biofeedback to the user's visual cortex and biofeedback confirmation of the operating of the device. The BCI may stimulate the user's somatosensory cortex, wherein stimulating includes the biofeedback confirmation of the operating of the device. The BCI may stimulate the user's auditory cortex, wherein the stimulating includes biofeedback confirmation of the operating of the device.

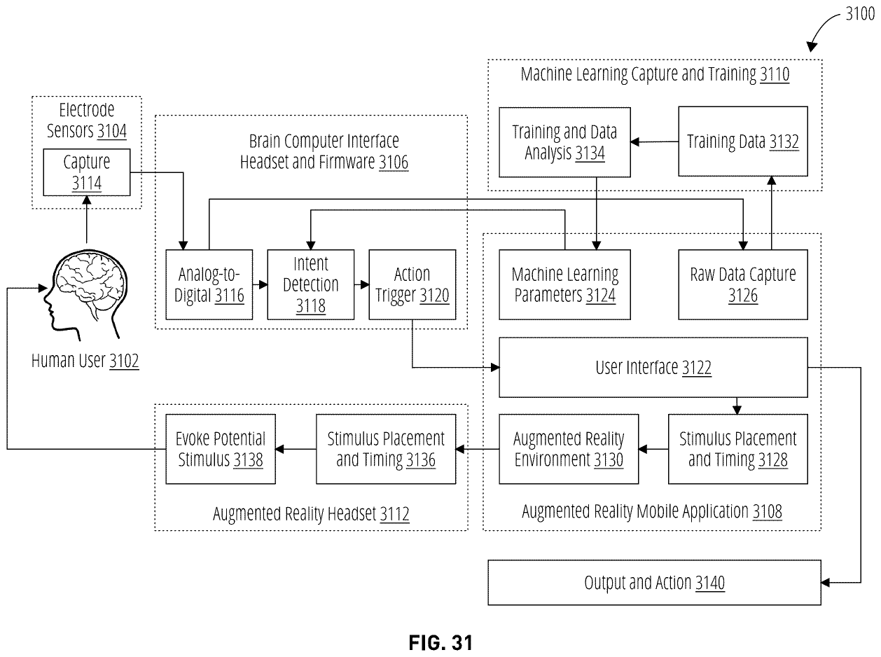

The fully self-contained BCI may be configured to utilize AI machine learning for pattern recognition, classification, and personalization that operates while the fully self-contained BCI is not connected to a network 2716. The AI machine learning may be embodied as the machine learning 2608 introduced in FIG. 26. It may be included in the learning system 2714 of this figure. It may also be supported by the machine learning capture and training 3110 and machine learning parameters 3124 introduced in FIG. 31. The AI machine learning may act as one or more of an auto-tuning dynamic noise reducer, a feature extractor, and a recognizer-categorizer-classifier. AI machine learning training may be applied when the fully self-contained BCI is connected to the network 2716 to create an individualized recognizer-categorizer-classifier. Derived outputs of the AI machine learning training may be stored in a GenAI model in cloud storage or on a mobile computing device having at least one of a wireless connection and a wired connection to the wireless headset and being at least one of mounted on the wireless headset and within wireless network range of the wireless headset. Synthesized insights derived from the AI machine learning and the GenAI may be stored in cloud storage or on the mobile computing device and may be used to generate an individualized executable recognizer-categorizer-classifier downloadable onto the at least one processing 2706 module of the fully self-contained BCI or the mobile computing device via at least one of a wireless connection and a wired connection between the network and a BCI storage device for offline usage without network dependencies. The system may be configured to interface with resource constrained devices including wearable devices, implantable devices, and internet of things (IoT) devices. At least one biofeedback device may be configured to stimulate at least one of a user's central nervous system and peripheral nervous system.

FIG. 28 illustrates a logical diagram of a user wearing an augmented reality headset 2800 that includes a display, speakers and vibration haptic motors and an accelerometer/gyroscope and magnetometer. FIG. 28 shows the flow of activity from head motion analog input 2802 as captured by a headset with head motion detection sensors 2804, through how a user selects options through head motion 2806 and the application creates output based on the user's selected options 2808. On the condition that system detects the user is away from home 2810, FIG. 28 shows that the system may send output to a caregiver via text message 2812.

The user may calibrate the headset based on the most comfortable and stable neck and head position which establishes the X/Y/Z position of 0/0/0. Based on this central ideal position, the user interface is adjusted to conform to the user's individual range of motion, with an emphasis of reducing the amount of effort and distance needed to move a virtual pointer in augmented reality from the 0/0/0 position to outer limits of their field of view and range of motion. The system may be personalized with various ergonomic settings to offset and enhance the users ease of use and comfort using the system. A head motion analog input 2802 may be processed as analog streaming data and acquired by the headset with head motion detection sensors 2804 in real-time, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by sending these post-processed data streams as tokens to the GenAI models and may include saving data locally on the sensory device or another storage device, streaming data to other subsystems or networks.

In the case illustrated in FIG. 28, the user is looking at a display that may include characters, symbols, pictures, colors, videos, live camera footage or other visual, oral or interactive content. In this example, the user is looking at a set of “radial menus” or collection of boxes or circles with data in each one that may be a symbol, character, letter, word or entire phrase. The user has been presented a set of words that surround a central phrase starter word in the middle like a hub and spoke to choose from based on typical functional communication with suggested fringe words and access to predictive keyboard, structured and unstructured language. The user selects options through head motion 2806 and may rapidly compose a phrase by selecting the next desired word presented in the radial menus or adding a new word manually via another input method. The user traverses the interface using head movement gestures, similar to 3-dimensional swipe movements, to compose communication. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. The application creates output based on the user's selected options 2808. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as a geographic information system (GIS) or a global positioning system (GPS) data or WiFi data, or manually personalized geofencing in the application personalization settings, where the system would know if the user is “at home” or “away from home”. On condition that system detects the user is away from home 2810, for example, the metadata may play a role in adapting the language being output to reflect the context of the user. For instance, the system could be configured to speak aloud when at home but send output to a caregiver via text message 2812 and append GPS coordinates when away from home. The system may support collecting and processing historical data from the sensory device, system, subsystems, and output actions to improve the performance and personalization of the system, subsystems, and sensory devices.

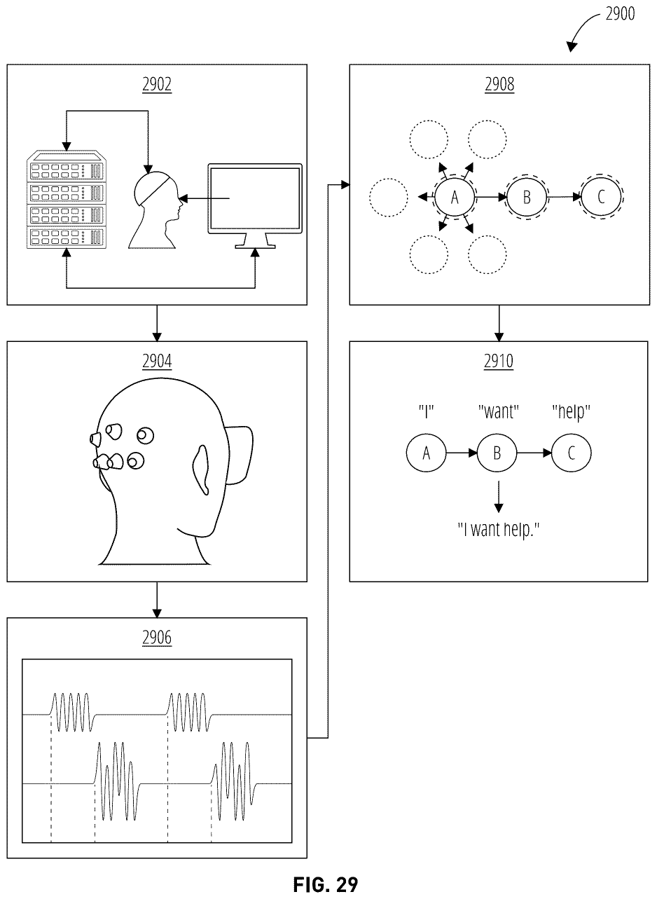

FIG. 29 illustrates a logical diagram of a user wearing an augmented reality headset 2900, in which user wears an EEG-based brain-computer interface headset 2902 containing electrodes that are contacting the scalp 2904. FIG. 29 shows that streaming analog data may be acquired from the brainwave activity 2906. In this manner, the user may be presented a set of words to choose from 2908, compose a phrase, and select what action the system takes using the phrase they've composed 2910.

A user wears an EEG-based brain-computer interface headset 2902 containing electrodes that are contacting the scalp 2904. The electrodes are connected to an amplifier and analog-to-digital processing pipeline. The sensory device (BCI) acquires streaming electrical current data measured in microvolts (μV). The more electrodes connected to the scalp and to the BCI, the more streaming analog data may be acquired from the brainwave activity 2906. The analog streaming data is acquired by the electrodes, pre-processed through amplification, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 29, the user is looking at a display that may include characters, symbols, pictures, colors, videos, live camera footage or other visual, oral or interactive content. In this example, the user is looking at a group of concentric circles, arranged in a radial layout, with characters on each circle. The user has been presented a set of words to choose from 2908 based on typical functional communication with suggested fringe words and access to predictive keyboard and may rapidly compose a phrase by selecting the next desired word presented in the outer ring of circles or adding a new word manually. The user progressively chooses the next word until they're satisfied with the phrase they've composed 2910 and may determine how to actuate the phrase. GenAI may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WiFi data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

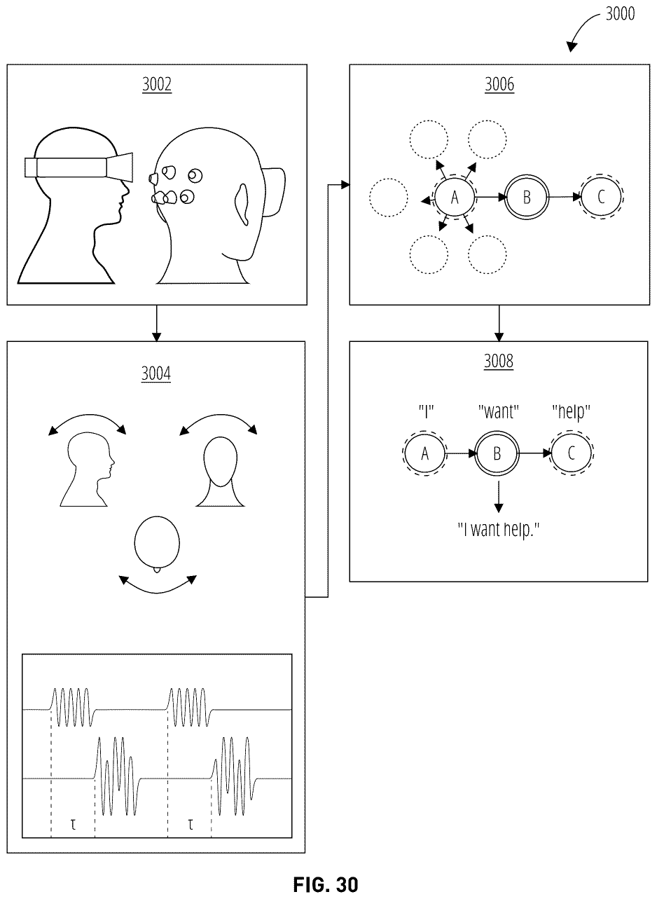

FIG. 30 illustrates a diagram of a use case including a user wearing an augmented reality headset 3000, in which a user wears an augmented reality headset combined with a brain computer interface 3002, having the capabilities described with respect to FIG. 28 and FIG. 29. Both head motion analog input and brainwave activity 3004 may be detected and may allow a user to select from a set of words to choose from 3006, as well as what to do with the phrase they've composed 3008 by selecting those words.

A user is wearing an augmented reality headset combined with a brain computer interface on their head. The headset contains numerous sensors as a combined sensory device including motion and orientation sensors and temporal bioelectric data generated from the brain detected via EEG electrodes contacting the scalp of the user, specifically in the regions where visual, auditory and sensory/touch is processed in the brain. The AR headset may produce visual, auditory or haptic stimulation that is detectible via the brain computer interface, and by processing brainwave data with motion data, the system may provide new kinds of multi-modal capabilities for a user to control the system. The analog streaming data is acquired by the Accelerometer, Gyroscope, Magnetometer and EEG analog-to-digital processor, and digitally processed, either directly on the sensory device or via a remotely connected subsystem. The system may include embedded software on the sensory device that handles the pre-processing of the analog signal. The system may include embedded software that handles the digitization and post-processing of the signals. Post-processing may include but not be limited to various models of compression, feature analysis, classification, metadata tagging, categorization. The system may handle preprocessing, digital conversion, and post-processing using a variety of methods, ranging from statistical to machine learning. As the data is digitally post-processed, system settings and metadata may be referred to determine how certain logic rules in the application are to operate, which may include mapping certain signal features to certain actions. Based on these mappings, the system operates by executing commands and may include saving data locally on the sensory device or another storage device, streaming data to other subsystems or networks.

In the case illustrated in FIG. 30, the user is looking at a display that may include characters, symbols, pictures, colors, videos, live camera footage or other visual, oral or interactive content. In this example, the user is looking at a visual menu system in AR with certain hard to reach elements flickering at different frequencies. The user has been presented a set of items to choose from based on typical functional communication with suggested fringe words and access to predictive keyboard and may rapidly compose a phrase by selecting the next desired word presented in the AR head mounted display or adding a new word manually. Enabling the user affordances of extra-sensory reach of visible objects out of reach within the comfortable range of motion of neck movement. The user progressively chooses the next word until they're satisfied with the phrase they've composed and may determine how to actuate the phrase. Algorithms may be used to predict the next character, word, or phrase, and may rearrange or alter the expression depending on its intended output including but not limited to appending emoji, symbols, colors, sounds or rearranging to correct for spelling or grammar errors. The user may desire for the phrase to be spoken aloud to a person nearby, thus selecting a “play button” or simply allowing the sentence to time out to be executed automatically. If they compose a phrase that is a control command like “turn off the lights”, they may select a “send button” or may, based on semantic natural language processing and understanding, automatically send the phrase to a third party virtual assistant system to execute the command, and turn off the lights. The potential use of metadata, in this example, could simply be geolocation data sourced from other systems such as GIS or GPS data or WIFI data, or manually personalized geofencing in the application personalization settings, where the system may know if the user is “at home” or “away from home”. In this case, the metadata may play a role in adapting the language being output to reflect the context of the user. For instance, the system could be configured to speak aloud when at home but send to a caregiver via text message and append GPS coordinates when away from home. The system may support collecting and processing historical data from the sensory device, system, subsystems, and output actions to improve the performance and personalization of the system, subsystems, and sensory devices.

FIG. 31 is a flow diagram 3100 showing a closed loop bio-signal data flow for a nonverbal multi-input and feedback device such as herein. It may be performed by inputs or a computer of the device. The flow diagram 3100 comprises a human user 3102, electrode sensors 3104, a brain computer interface headset and firmware 3106, an augmented reality mobile application 3108, machine learning capture and training 3110 that may be performed in an edge, peer, or cloud device, and an augmented reality headset 3112. The electrode sensors 3104 may capture 3114 data that is sent for analog-to-digital 3116 conversion. The digital signal may be used for intent detection 3118 resulting in an action trigger 3120 to a user interface 3122. The digital data may further be sent to raw data capture 3126 and may be used as training data 3132 for training and data analysis 3134. Training and data analysis 3134 may yield machine learning parameters 3124 which may be fed back for use in intent detection 3118. The user interface 3122 may determine stimulus placement and timing 3128, which may be used in the augmented reality environment 3130 created by the augmented reality mobile application 3108. The stimulus placement and timing 3136 resulting in the augmented reality headset 3112 and may evoke potential stimulus 3138 in the human user 3102. The user interface 3122 may also generate an output and action 3140.

The flow diagram 3100 includes computer stimulates visual, auditory and somatosensory cortex with evoked potentials; signal processing of real time streaming brain response; human controls computer based on mental fixation of stimulation frequencies; and system may determine different output or actions on behalf of the user for input data received via one or more sensors of the device. Flow diagram 3100 may apply to a user wearing any of the nonverbal multi-input and feedback devices and/or sensors herein. As a result of this being closed-loop biofeedback and sensory communication and control system that stimulates the brains senses of sight, sound, and touch and reads specific stimulation time-based frequencies, and tags them with metadata in real-time as the analog data is digitized, the user may rapidly learn how to navigate and interact with the system using their brain directly. This method of reinforcement learning is known in the rapid development process of the brain's pattern recognition abilities and the creation of neural plasticity to develop new neural connections based on stimulation and entrainment. This further allows the system to become a dynamic neural prosthetic extension of their physical and cognitive abilities. The merging of context awareness metadata, vocabulary, and output and action logic into the central application in addition to a universal interface for signal acquisition and data processing is what makes this system extremely special. Essentially, this system helps reduce the time latency between detecting cognitive intention and achieving the associated desired outcome, whether that be pushing a button, saying a word or controlling robots, prosthetics, smart home devices or other digital systems.

FIG. 32 is a flow diagram 3200 showing multimodal, multi-sensory system for communication and control 3202 for a nonverbal multi-input and feedback device such as herein. It may be performed by inputs or a computer of the device. The flow diagram 3200 comprises multimodal, multi-sensory systems for communication and control 3202 that includes wireless neck and head tracking 3204 and wireless brain tracking 3206. The multimodal, multi-sensory system for communication and control 3202 may further comprise central sensors 3208 for EEG, peripheral sensors 3210 such as EMG, EOG, ECG, and others, an analog to digital signal processor 3212 processing data from the central sensors 3208, and an analog to digital signal processor 3214 processing data from the peripheral sensors 3210. The analog to digital subsystem 3216 and sensor service subsystem 3218 manage output from the analog to digital signal processor 3212 and the analog to digital signal processor 3214, respectively. Output from the analog to digital subsystem 3216 may be sent to a storage subsystem 3260.

Outputs from the analog to digital subsystem 3216 and sensor service subsystem 3218 go to a collector subsystem 3220, which also receives a real-time clock 3222. The collector subsystem 3220 communicates with a recognizer 3224 for EEG data and a classifier 3226 for EMG, EOG, and ECG data, and data from other sensing. The collector subsystem 3220 further communicates to a wireless streamer 3228 and a serial streamer 3230 to interface with a miniaturized mobile computing system 3236 and a traditional workstation 3232, respectively. The traditional workstation 3232 and miniaturized mobile computing system 3236 may communicate with a cloud 3234 for storage or processing. The miniaturized mobile computing system 3236 may assist in wireless muscle tracking 3238 (e.g., EMG data) and wireless eye pupil tracking 3240.

A controller subsystem 3242 accepts input from a command queue 3244 which accepts input from a Bluetooth or BT write callback 3250. The BT write callback 3250 may send commands 3246 to a serial read 3248. The controller subsystem 3242 may send output to the controller subsystem 3242 and a peripherals subsystem 3252. The peripherals subsystem 3252 generates audio feedback 3254, haptic feedback 3256, and organic LED or OLED visual feedback 3258 for the user.

The flow diagram 3200 includes synchronizing signals from multiple biosensors including brain, body (see skin colored arm), eye and movement; processing multiple models concurrently for multi-sensory input; and directing and processing biofeedback through peripheral subsystems. Flow diagram 3200 may apply to a user wearing any of the nonverbal multi-input and feedback devices and/or sensors herein.

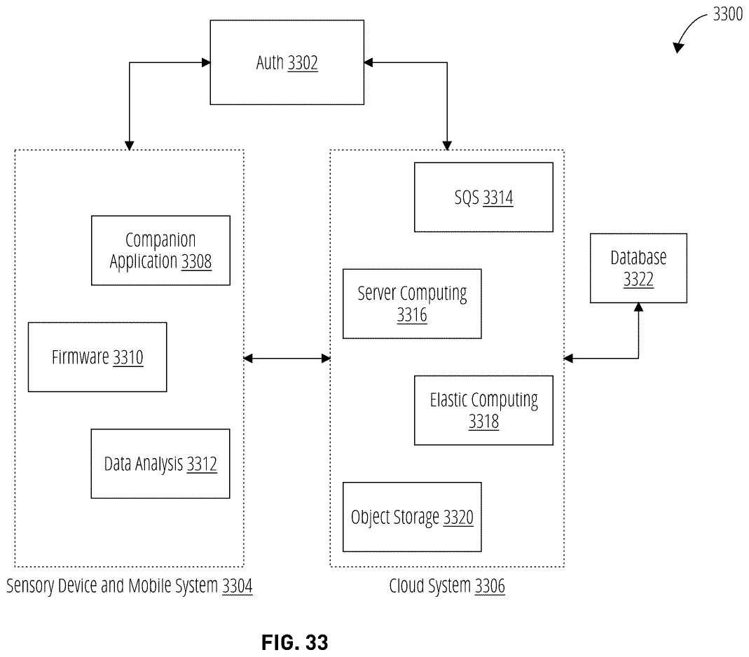

FIG. 33 is a block diagram 3300 showing an example of cloud processing for a nonverbal multi-input and feedback device such as herein. The block diagram 3300 comprises data authentication 3302, a sensory device and mobile system 3304, a cloud system 3306, and a database 3322. The data authentication 3302 module may be configured to authenticate data and communicate with the sensory device and mobile system 3304 and cloud system 3306. The sensory device and mobile system 3304 may include companion application 3308 and data collection, firmware 3310 and data collection, and data analysis 3312 or raw and processed data. The cloud system 3306 may comprise simple queue service or SQS message queuing 3314, server computing 3316 to analyze raw and process data, elastic computing 3318 to build, train, and test machine learning models, and object storage 3320 for persistent storage of biodata, machine learning, and metadata. The database 3322 stores associations and metadata and is in communication with the cloud system 3306.

Block diagram 3300 has the cloud system, the nonverbal multi-input device and an authorization system. Block diagram 3300 includes: machine learning processing signal data on device; metadata enrichment; push raw and processed data to cloud; cloud application building new models for devices; system updates devices remotely and wirelessly; secure and privacy compliant. Privacy-preserving processing of biosignal data may include one or more of (i) on-device feature extraction with reduction of raw biosignal data prior to egress, (ii) application of a differential-privacy mechanism to telemetry aggregated across users, and (iii) a configurable data-retention window applied in accordance with a user consent parameter. This configuration is quite powerful but unassumingly simple in this block diagram.

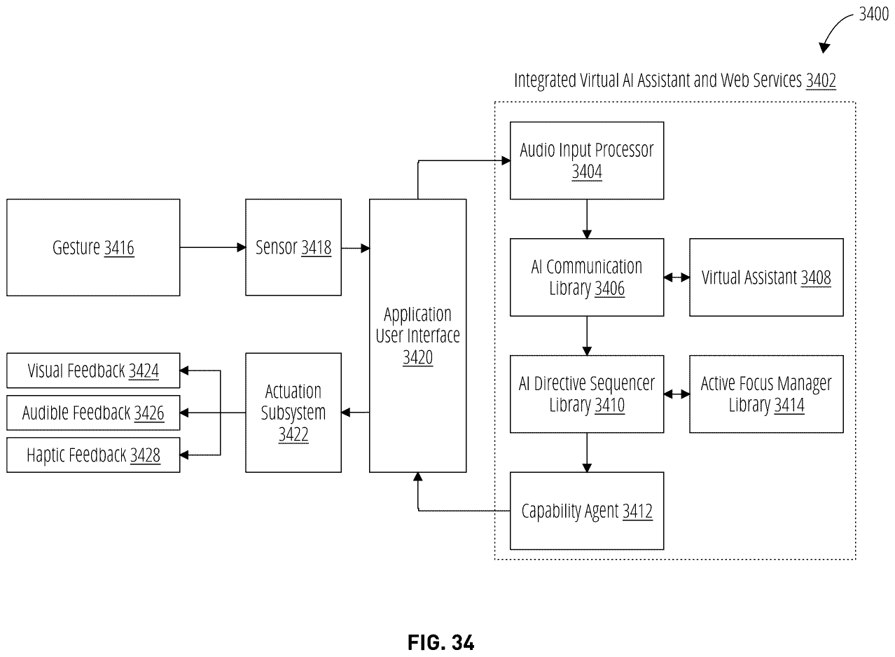

FIG. 34 is a block diagram 3400 showing an example of a system architecture for integrated virtual AI assistant and web services 3402 for a nonverbal multi-input and feedback device such as herein. The block diagram 3400 comprises integrated virtual AI assistant and web services 3402 which may include an audio input processor 3404, an AI communication library 3406, a virtual assistant 3408 such as Alexa, an AI directive sequencer library 3410, a capability agent 3412, and an active focus manager library 3414. A gesture 3416 from a user may be detected by a sensor 3418. An application user interface 3420 may process sensor data and may send data to the audio input processor 3404. The capability agent 3412 may send data back to the application user interface 3420. The application user interface 3420 may signal an actuation subsystem 3422 to provide visual feedback 3424, audible feedback 3426, and haptic feedback 3428.

The block diagram 3400 includes: system manages intention signal acquisition, processing, language composition, and output; in the event where a user wants to send their intention to a virtual assistant (like Alexa, Siri). The blocks outside of the dashed border run on the sensory device, and currently, the blocks inside the dashed line are running in the cloud (e.g., represent a custom configuration for how to use the Alexa service in a cloud architecture.) It may also be possible that all of what is described here as in the cloud may run locally in the sensory device.

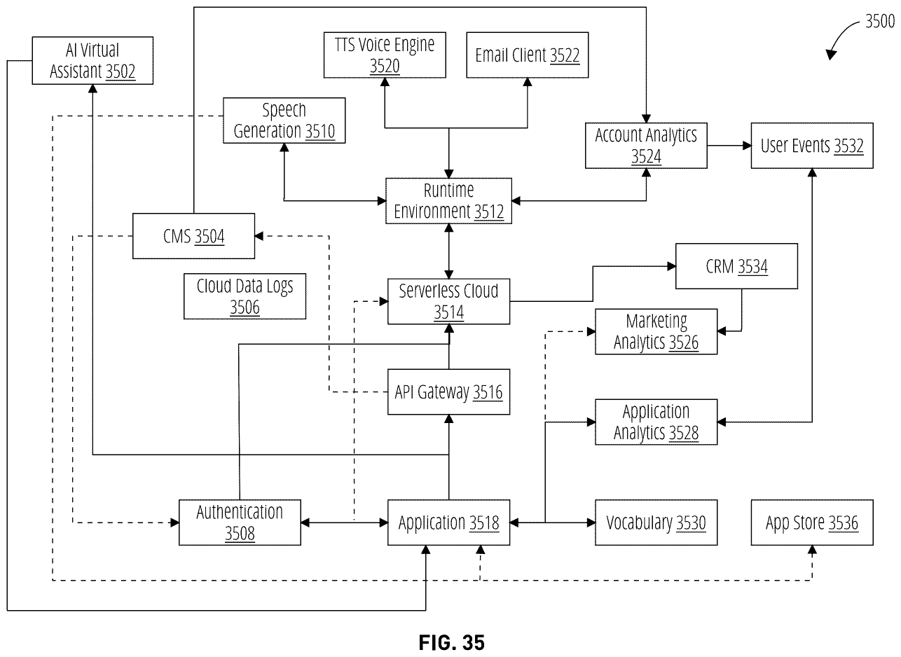

FIG. 35 is a block diagram 3500 showing an example of system operations for a nonverbal multi-input and feedback device such as herein. The block diagram 3500 comprises an AI virtual assistant 3502, such as Alexa, a content management system 3504, cloud data logs 3506, authentication 3508, speech generation 3510, a runtime environment 3512, a serverless cloud 3514, an API gateway 3516, an application 3518, a text-to-speech or TTS voice engine 3520, an email client 3522, account analytics 3524, marketing analytics 3526, application analytics 3528, a vocabulary 3530, user events 3532, a customer relations management 3534, and an app store 3536.

Block diagram 3500 includes: system operation blocks including authentication. This is an example of the complexity of a system operating in the cloud. Everything in this figure is in the cloud, except for the application that is running on the sensory device. The augment/virtual reality application 3518 for the nonverbal multi-input and feedback device may interface with an authentication 3508 module, an API gateway 3516, a vocabulary 3530, application analytics 3528, AI virtual assistant 3502, and marketing analytics 3526. The AI virtual assistant 3502 may communicate back to the application 3518. The application 3518 may also be in direct communication with a serverless cloud 3514 or may communicate with the serverless cloud 3514 through the API gateway 3516. Authentication 3508 may also be in communication with the serverless cloud 3514. The API gateway 3516 further allows the application 3518 to communicate with the content management system 3504, which may be used to store cloud data logs 3506. The content management system 3504 may send data back to the application 3518 through the authentication 3508 module, which may act as a gateway to ensure security and content authorization. Finally, the content management system 3504 may provide data to an account analytics 3524 module. Account analytics 3524 may provide data to a user events 3532 module, which may in turn feed data to application analytics 3528.

The serverless cloud 3514 may allow communication with the runtime environment 3512 and the customer relations management 3534 module. The customer relations management 3534 may provide data for marketing analytics 3526. The runtime environment 3512 may interface with speech generation 3510, a TTS voice engine 3520, an email client 3522, and account analytics 3524. Speech generation 3510 may allow a user to access an app store 3536.

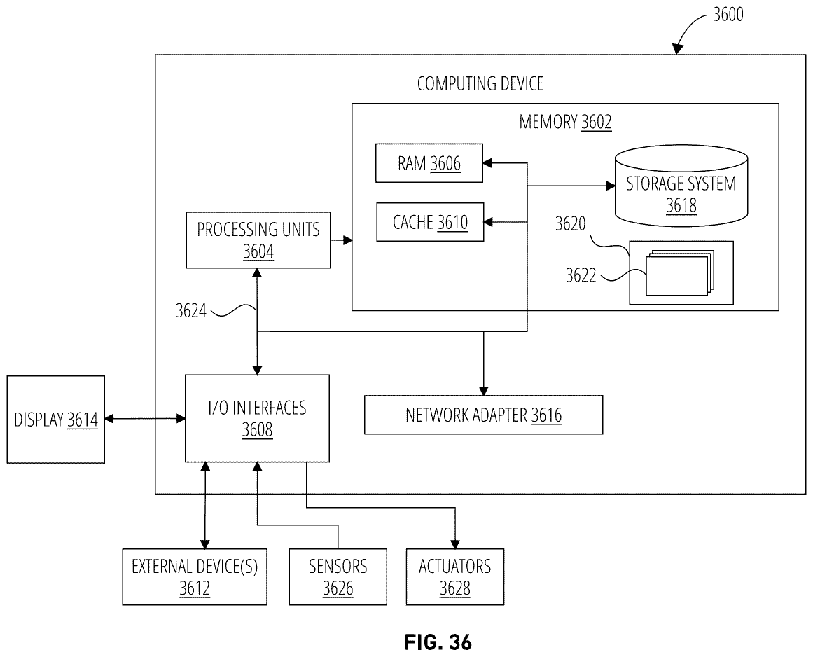

As shown in FIG. 36, a computing device 3600, such as a smart phone or other smart device, is shown in the form of a general-purpose computing device. The components of computing device 3600 may include, but are not limited to, one or more processors or processing units 3604, a system memory 3602, and a bus 3624 that couples various system components including system memory 3602 to processor processing units 3604. Computing device 3600 may include sensors 3626 such as cameras, accelerometers, microphones, etc., and actuators 3628, such as speakers, vibrating or haptic actuators, etc. Computing device 3600 may be a smartphone, a tablet, laptop, desktop computer, or other computing device suitable for implementing the disclosed solution as described herein.

Bus 3624 represents one or more of any of several types of bus structures, including a memory bus or memory controller, a peripheral bus, an accelerated graphics port, and a processor or local bus using any of a variety of bus architectures. By way of example, and not limitation, such architectures include Inter-Integrated Circuit (I2C), Serial Peripheral Interface (SPI), Controller Area Network (CAN), Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computing device 3600 typically includes a variety of computer system readable media. Such media may be any available media that is accessible by computing device 3600, and it includes both volatile and non-volatile media, removable and non-removable media.

System memory 3602 may include computer system readable media in the form of volatile memory, such as Random access memory (RAM) 3606 and/or cache memory 3610. Computing device 3600 may further include other removable/non-removable, volatile/non-volatile computer system storage media. By way of example, a storage system 3618 may be provided for reading from and writing to a non-removable, non-volatile magnetic media (not shown and typically called a “hard drive”). Although not shown, a flash drive, a magnetic disk drive for reading from and writing to a removable, non-volatile magnetic disk (e.g., a “floppy disk”), and an optical disk drive for reading from or writing to a removable, non-volatile optical disk such as a compact disc read only memory (CD-ROM), digital versatile disc read only memory (DVD-ROM), or other optical media, may be provided. In such instances, each may be connected to bus 3624 by one or more data media interfaces. As will be further depicted and described below, system memory 3602 may include at least one program product having a set (e.g., at least one) of program modules that are configured to carry out the functions of the disclosure.

Program/utility 3620 having a set (at least one) of program modules 3622 may be stored in system memory 3602 by way of example, and not limitation, as well as an operating system, one or more application programs, other program modules, and program data. Each of the operating system, one or more application programs, other program modules, and program data or some combination thereof, may include an implementation of a networking environment. Program modules 3622 generally carry out the functions and/or methodologies of the disclosure as described herein.

Computing device 3600 may also communicate with one or more external devices 3612 such as a keyboard, a pointing device, a display 3614, etc.; one or more devices that allow a user to interact with computing device 3600; and/or any devices (e.g., network card, modem, etc.) that allow computing device 3600 to communicate with one or more other computing devices. Such communication may occur via I/O interfaces 3608. I/O interfaces 3608 may also manage input from computing device 3600 sensors 3626, as well as output to actuators 3628. Still yet, computing device 3600 may communicate with one or more networks such as a local area network (LAN), a general wide area network (WAN), and/or a public network (e.g., the Internet) via network adapter 3616. As depicted, network adapter 3616 communicates with the other components of computing device 3600 via bus 3624. It may be understood that although not shown, other hardware and/or software components could be used in conjunction with computing device 3600. Examples include, but are not limited to, microcode, device drivers, redundant processing units, external disk drive arrays, redundant array of independent disks (RAID) systems, tape drives, data archival storage systems, etc.

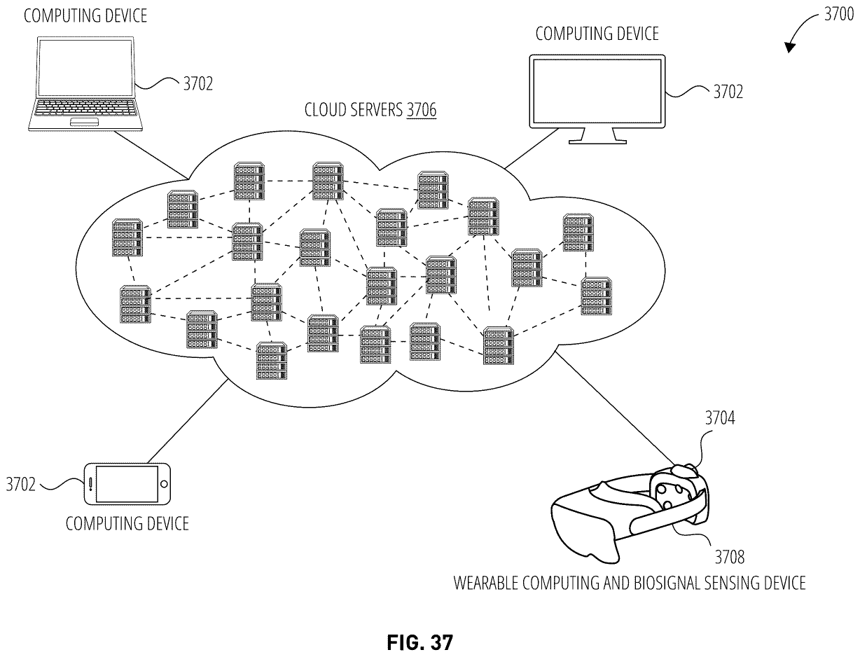

Referring now to FIG. 37, an illustrative cloud computing system 3700 is depicted. “Cloud computing” refers to a model for enabling convenient, on-demand network access to a shared pool of configurable computing resources (e.g., networks, servers, storage, applications, and services) that may be rapidly provisioned and released with minimal management effort or service provider interaction. This cloud model promotes availability and is comprised of at least five characteristics, at least three service models, and at least four deployment models. Examples of commercially hosted cloud computing systems 3700 include Amazon Web Services (AWS), Google Cloud, Microsoft Azure, etc.

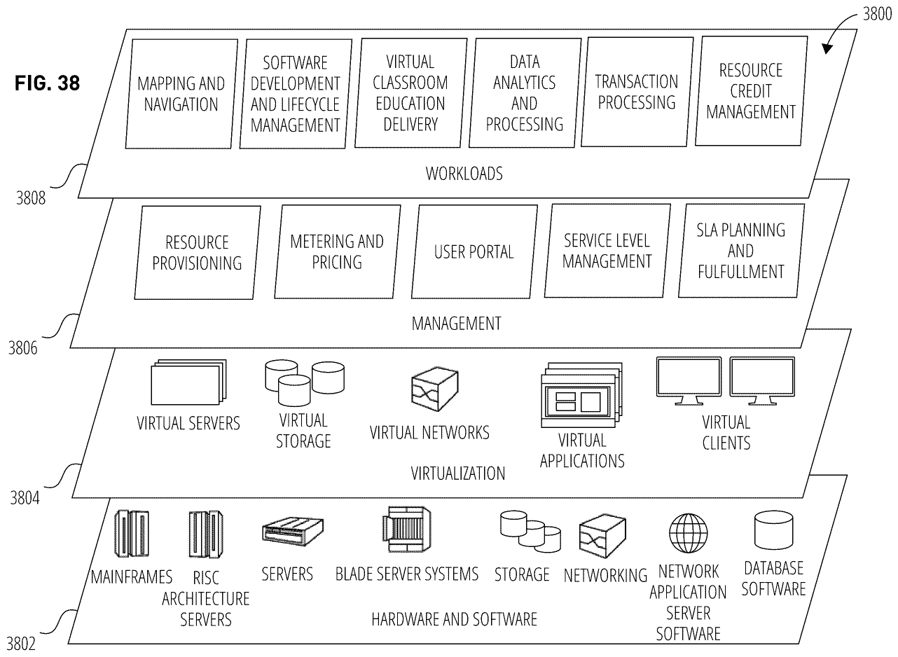

As shown, cloud computing system 3700 may comprise one or more cloud servers 3706, with which computing devices 3702 such as, for example, personal digital assistants (PDAs), smart devices such as smart phones, laptops, desktop computers, and/or wearable computing and biosignal sensing device 3708 brain computer interfaces or BCIs 3704 may communicate. This allows for infrastructure, platforms, and/or software to be offered as services (as described above in FIG. 38) from cloud servers 3706, so as to not need each client to separately maintain such resources. It is understood that the types of computing devices shown in FIG. 37 are intended to be illustrative and not limiting, and that cloud servers 3706 may communicate with any type of computerized device over any type of network and/or network/addressable connection (e.g., using a web browser).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

Characteristics are as follows:

On-demand self-service: a cloud consumer may unilaterally provision computing capabilities, such as server time and network storage, as needed automatically without needing human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities may be rapidly and elastically provisioned, in some cases automatically, to quickly scale out and rapidly released to quickly scale in. To the consumer, the capabilities available for provisioning often appear to be unlimited and may be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage may be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which may include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security needs, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that supports data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 38, a set of cloud computing functional abstraction layers 3800 provided by cloud computing systems 3700 such as those illustrated in FIG. 37 is shown. It may be understood in advance that the components, layers, and functions shown in FIG. 38 are intended to be illustrative, and the disclosure is not limited thereto. As depicted, the following layers and corresponding functions are provided:

Hardware and software layer 3802 includes hardware and software components.

Examples of hardware components include mainframes, reduced instruction set computer (RISC) architecture based servers, servers, blade servers, storage devices, and networks and networking components. Examples of software components include network application server software and database software.

Virtualization layer 3804 provides an abstraction layer from which the following exemplary virtual entities may be provided: virtual servers; virtual storage; virtual networks, including virtual private networks; virtual applications; and virtual clients.

Management layer 3806 provides the exemplary functions described below. Resource provisioning provides dynamic procurement of computing resources and other resources that are utilized to perform tasks within the Cloud computing environment. Metering and Pricing provide cost tracking as resources are utilized within the cloud computing environment, and billing or invoicing for consumption of these resources. In one example, these resources may comprise application software licenses. Security provides identity verification for users and tasks, as well as protection for data and other resources. The user portal provides access to the Cloud computing environment for both users and system administrators. Service level management provides Cloud computing resource allocation and management such that the service levels needed are met. Service Level Agreement (SLA) planning and fulfillment provide pre-arrangement for, and procurement of, Cloud computing resources for which a future need is anticipated in accordance with an SLA.

Workloads layer 3808 provides functionality for which the cloud computing environment is utilized. Examples of workloads and functions which may be provided from this layer include mapping and navigation; software development and lifecycle management; virtual classroom education delivery; data analytics processing; transaction processing; and resource credit management. As mentioned above, all of the foregoing examples described with respect to FIG. 38 are illustrative, and the disclosure is not limited to these examples.

### LISTING OF DRAWING ELEMENTS

100 system architecture
102 primary user
104 wearable computing and biosignal sensing device
106 secondary user
108 environmental tools
110 input interface
112 contextual data
114 biosignal processing logic
116 external application
118 pre-processing/feature extraction logic
120 knowledge base
122 historical data
124 accumulated logged data
126 agent assembly model
128 AI agent
130 primary user interface
132 secondary user interface
134 agentic action
136 monitoring/data logging logic
138 short-loop adaptive response logic
140 long-loop long-term model training component
142 reporting/visualization logic
144 short-loop feedback
146 long-loop feedback
148 real-time biosignals
150 user state
152 environmental insight
154 event and outcome log
200 routine
202 block
204 block
206 block
208 block
210 block
212 block
214 block
216 block
218 block
220 block
222 block
300 RAG index data and inference pipeline
302 multimodal RAG index data development
304 real-time inference operation
306 interaction log
308 text embedding
310 images/video
312 image embedding
314 device telemetry
316 text embedding
318 EEG data
320 spectrogram/filtered waveforms
322 multimodal embedding
324 vector store
326 semantic similarity search
328 user interface AI agent
330 contextual data
332 real-time multimodal embedding
334 biosignal data/sensor data
336 next action prediction
338 trigger hover on predicted likely target stimulus
340 increase sensitivity of a predicted likely target stimulus
342 enlarge a predicted likely target stimulus
400 real-time adaptive assistant
402 triggering event
404 active event
406 observation
408 assessment
410 in-event action adjustment
412 across events
414 aggregation and analysis
416 event history
418 outcome record
420 context pattern
422 user baseline
424 external override
426 real-time query
428 training pull
430 event logging
500 volitional signal control system
502 triggering event
504 active event
506 monitoring
508 assessment
510 in-event action adjustment
512 across events
514 aggregation and analysis
516 intent profile
518 command history
520 pattern memory
522 target preferences
524 learned demonstrations
526 real-time query
528 training pull
530 event logging
600 multi-agent reasoning and learning system
602 triggering event
604 active event
606 sensing
608 classification
610 re-routing
612 across events
614 aggregation and analysis
616 session RAG store
618 user model
620 response traces
622 session insights
624 rejected paths
626 real-time query
628 training pull
630 event logging and user model updating
700 seizure support and intervention system
702 environmental monitoring
704 IoT sensors
706 notification
708 emergency service
710 smart home commands
712 smart home
714 status alerts
716 caregiver and companion application
718 manual override and user/caregiver feedback
800 assistive robot system for paralyzed users
802 environmental camera sensor
804 wheelchair and obstacle sensor
806 smart home/IoT integration
808 external camera and microphone
810 critical alert
812 emergency service
814 robot command
816 assistive robot
818 status alerts
820 caregiver and companion application
822 manual override and user/caregiver feedback
824 caregiver demonstration capture
900 cognitive health support system
902 user profile and context database
904 environmental camera sensor
906 exercise suggestion
908 adaptive brain exercise
910 AR cues and overlays
912 AR display
914 light, sound, and temperature settings
916 environmental adjustments
918 reminders and alerts
920 memory and task reminders
922 status alerts
924 caregiver and companion application
926 manual override and user/caregiver feedback
1000 goal-oriented dialog support system
1002 sentiment analysis API
1004 facial expression and voice audio analysis
1006 RAG database
1008 output
1010 next question/prompt
1012 conversation summary
1014 user reactions
1100 routine
1102 block
1104 block
1106 block
1108 block
1110 block
1112 block
1114 block
1200 routine
1202 block
1204 block
1206 block
1208 block
1210 block
1212 block
1214 block
1216 block
1218 block
1220 block
1222 block
1224 block
1300 routine
1302 block
1304 block
1306 block
1308 block
1400 routine
1402 block
1404 block
1406 block
1408 block
1500 routine
1502 block
1504 block
1506 block
1508 block
1510 block
1600 user agency and capability augmentation system
1602 user
1604 wearable computing and biosignal sensing device
1606 biosignals
1608 background material
1610 sensor data
1612 other device data
1614 application context
1616 prompt composer
1618 GenAI
1620 multimodal output stage
1622 output modalities
1624 utterance
1626 written text
1628 multimodal artifact
1630 other user agency
1632 encoder/parser
1634 non-language user agency device
1636 biosignals prompt
1638 context prompt
1640 user input prompt
1642 shared data
1644 prompt
1646 multimodal output
1648 output mode selection signal
1700 biosignals subsystem
1702 additional biosensors
1704 biosignals classifier
1706 EEG tokenizer
1708 kinematic tokenizer
1710 additional tokenizers
1800 context subsystem
1802 raw background material tokenizer
1804 final background material tokenizer
1806 raw sensor data tokenizer
1808 final sensor data tokenizer
1810 raw device data tokenizer
1812 final device data tokenizer
1814 raw application context tokenizer
1816 final application context tokenizer
1818 context prompt composer
1820 preliminary tokens
1822 final tokens
1900 routine
1902 block
1904 block
1906 block
1908 block
1910 block
1912 block
1914 block
1916 decision block
1918 block
1920 block
1922 block
2000 multiuser system
2002a simultaneous user
2002b simultaneous user
2002c simultaneous user
2002d simultaneous user
2004 network
2100 exemplary tokenizer
2102 input data
2104 tokenizable element
2106 token
2108 tokenized output
2200 BCI headset system
2202 augmented reality display lens
2204 top cover
2206 adjustable strap
2208 padding
2210 ground/reference electrode
2212 ground/reference electrode adjustment dial
2214 biosensor electrodes
2216 battery cell
2218 fit adjustment dial
2220 control panel cover
2222 control panel
2224 biosensor electrode adjustment dials
2226 auxiliary electrode ports
2228 power switch
2230 USB port
2232 forward housing
2234 smart phone
2236 smart phone slot
2300 BCI+AR environment
2302 human user
2304 sensor
2306 EEG analog to digital converter
2308 Audio/Video/Haptic Output
2310 processing
2312 augmented reality glasses
2314 strap
2316 BCI
2400 augmented reality device logic
2402 processing units
2404 CPU
2406 GPU
2408 NPU
2410 WiFi
2412 Bluetooth
2414 speakers
2416 microphones
2418 memory
2420 logic
2422 graphics engine
2424 camera
2426 visual display
2428 vibration/haptic driver
2430 cloud
2432 Bluetooth keyboard
2500 block diagram of nonverbal multi-input and feedback device
2502 application
2504 multimodal input and intent detection
2506 context awareness
2508 GenAI
2510 output and action
2512 touch
2514 bio-signals
2516 keyboard
2518 facial tracking
2520 eye and pupil tracking
2522 alternative inputs
2524 biometrics
2526 environment
2528 object recognition
2530 facial recognition
2532 voice recognition
2534 date and time
2536 history
2538 location
2540 proximity
2542 other metadata
2544 flat screen display
2546 augmented/virtual reality
2548 virtual AI assistant
2550 synthesized voice
2552 prosthetic device
2554 social media and messaging
2556 media consumption
2600 block diagram of a single framework of a nonverbal multi-input and feedback
device
2602a sensor
2602b sensor
2602c sensor
2602d sensor
2602e sensor
2602f sensor
2604 input gesture
2606 context awareness
2608 machine learning
2610 output expression
2612 destination
2614 touch
2616 movement
2618 mental
2620 glances
2622 audible
2624 breath
2626 time synchronization
2628 configure data sources
2630 configure data processing parameters
2632 configure timing
2634 metadata tagging
2636 acquire analog data streams
2638 convert to digital data streams
2640 analyze data streams
2642 execute digital operations for actuation
2644 text
2646 symbol
2648 color
2650 image
2652 sound
2654 vibration
2656 mobile
2658 wearable 1
2660 wearable 2
2662 implant 1
2664 implant 2
2666 prosthetic 1
2700 block diagram of nonverbal multi-input and feedback device
2702 analog input
2704 sensors
2706 processing
2708 digital output
2710 output methods
2712 historical data
2714 learning system
2716 network
2718 personalization settings
2720 metadata
2722 application
2724 primary and secondary languages
2726 visual
2728 audible
2730 written
2800 logical diagram of a user wearing an augmented reality headset
2802 head motion analog input
2804 headset with head motion detection sensors
2806 user selects options through head motion
2808 application creates output based on the user's selected options
2810 condition that system detects the user is away from home
2812 send output to a caregiver via text message
2900 logical diagram of a user wearing an augmented reality headset
2902 user wears an EEG-based brain-computer interface headset
2904 electrodes that are contacting the scalp
2906 streaming analog data may be acquired from the brainwave activity
2908 set of words to choose from
2910 phrase they've composed
3000 diagram of a use case including a user wearing an augmented reality headset
3002 augmented reality headset combined with a brain computer interface
3004 head motion analog input and brainwave activity
3006 set of words to choose from
3008 phrase they've composed
3100 flow diagram
3102 human user
3104 electrode sensors
3106 brain computer interface headset and firmware
3108 augmented reality mobile application
3110 machine learning capture and training
3112 augmented reality headset
3114 capture
3116 analog-to-digital
3118 intent detection
3120 action trigger
3122 user interface
3124 machine learning parameters
3126 raw data capture
3128 stimulus placement and timing
3130 augmented reality environment
3132 training data
3134 training and data analysis
3136 stimulus placement and timing
3138 evoke potential stimulus
3140 output and action
3200 flow diagram
3202 multimodal, multi-sensory system for communication and control
3204 wireless neck and head tracking
3206 wireless brain tracking
3208 central sensors
3210 peripheral sensors
3212 analog to digital signal processor
3214 analog to digital signal processor
3216 analog to digital subsystem
3218 sensor service subsystem
3220 collector subsystem
3222 real-time clock
3224 recognizer
3226 classifier
3228 wireless streamer
3230 serial streamer
3232 traditional workstation
3234 cloud
3236 miniaturized mobile computing system
3238 wireless muscle tracking
3240 wireless eye pupil tracking
3242 controller subsystem
3244 command queue
3246 command
3248 serial read
3250 BT write callback
3252 peripherals subsystem
3254 audio feedback
3256 haptic feedback
3258 OLED visual feedback
3260 storage subsystem
3300 block diagram
3302 data authentication
3304 sensory device and mobile system
3306 cloud system
3308 companion application
3310 firmware
3312 data analysis
3314 SQS message queuing
3316 server computing
3318 elastic computing
3320 object storage
3322 database
3400 block diagram
3402 integrated virtual AI assistant and web services
3404 audio input processor
3406 AI communication library
3408 virtual assistant
3410 AI directive sequencer library
3412 capability agent
3414 active focus manager library
3416 gesture
3418 sensor
3420 application user interface
3422 actuation subsystem
3424 visual feedback
3426 audible feedback
3428 haptic feedback
3500 block diagram
3502 AI virtual assistant
3504 content management system
3506 cloud data logs
3508 authentication
3510 speech generation
3512 runtime environment
3514 serverless cloud
3516 API gateway
3518 application
3520 TTS voice engine
3522 email client
3524 account analytics
3526 marketing analytics
3528 application analytics
3530 vocabulary
3532 user events
3534 customer relations management
3536 app store
3600 computing device
3602 system memory
3604 processing units
3606 Random access memory (RAM)
3608 I/O interfaces
3610 cache memory
3612 external devices
3614 display
3616 network adapter
3618 storage system
3620 program/utility
3622 program modules
3624 bus
3626 sensors
3628 actuators
3700 cloud computing system
3702 computing device
3704 BCI
3706 cloud servers
3708 wearable computing and biosignal sensing device
3800 cloud computing functional abstraction layers
3802 hardware and software layer
3804 virtualization layer
3806 management layer
3808 workloads layer

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has Circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

Terms used herein may be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

What is claimed is:

1. A computer-implemented system comprising:
a biosignal acquisition and processing subsystem configured to receive multimodal biosignal data from a user;
a feature extraction and classification subsystem configured to classify the multimodal biosignal data into at least one user state;
a dynamic network of goal-driven software agents configured to select and execute at least one action based on the classified at least one user state;
a knowledge base storing historical biosignal patterns, user baselines, and prior action outcomes; a short-loop adaptive response logic configured to adjust the at least one action in real time based on feedback signals; and
a long-loop long-term model training component configured to periodically refine classifiers of the feature extraction and classification subsystem and agent decision policies based on accumulated biosignal, action, and outcome data.

2. The computer-implemented system of claim 1, wherein the short-loop adaptive response logic is configured to read from the knowledge base with a latency of seconds or less to inform in-event action adjustment;
wherein the long-loop long-term model training component is configured to read from and write to the knowledge base on a session-to-session basis to refine at least one of an agent assembly model and an agent decision policy; and
wherein both the short-loop adaptive response logic and the long-loop long-term model training component operate over the knowledge base on different timescales.

3. The computer-implemented system of claim 1, wherein the system is configurable to operate in at least one mode selected from:
a real-time adaptive assistant mode in which the dynamic network of the goal-driven software agents autonomously selects and executes actions in response to classified user states without receiving explicit user commands;
a volitional signal control mode in which the dynamic network of the goal-driven software agents decodes a user intent from volitional biosignals and executes commands on external targets after passing through a confirmation gate; and
a multi-agent reasoning and learning mode in which a plurality of specialist agents collaborate under a supervisor agent via an agent-to-agent protocol and access external tools via a model context protocol, wherein the system maintains and updates a user model across events.

4. The computer-implemented system of claim 1, wherein the dynamic network of the goal-driven software agents operates autonomously without an explicit user command;
wherein the at least one action produced by the dynamic network of the goal-driven software agents is directed to at least one target selected from: emergency services, stakeholder notification, and environmental actuation; and
wherein the at least one action is executed without routing to a user interface.

5. The computer-implemented system of claim 1, further comprising:
an adaptive complexity logic configured to perform intra-session state estimation from biosignal features comprising a latency, an error rate, a retry frequency, and fatigue indicators;
wherein the adaptive complexity logic dynamically adjusts a complexity of outputs delivered to the user based on the intra-session state estimation, in accordance with a configurable balance between compensation of a target behavior and rehabilitation of the target behavior.

6. The computer-implemented system of claim 1, wherein the biosignal acquisition and processing subsystem is configured to receive a volitional intent signal comprising a volitional biosignal indicating an intent of the user to act, and a target signal comprising a user-directed selection of a target object, a direction, or a command; and
wherein the system further comprises a confirmation component configured to evaluate a decoded intent against at least one proxy confirmation signal, permitting execution of the decoded intent on condition that no rejection signal is detected within a specified verification window.

7. The computer-implemented system of claim 6, wherein the feature extraction and classification subsystem is configured to fuse a plurality of input modalities into a unified intent vector;
wherein the plurality of input modalities includes at least two of: partial or degraded speech, gaze fixation or saccade patterns, gesture or pointing, symbol or touch selection, typed text input, contextual signals from an environment of the user, and biometric affect signals; and
wherein a relative weighting of each of the plurality of input modalities in the unified intent vector is personalized for the user based on historical modality reliability.

8. The computer-implemented system of claim 1, wherein the dynamic network of goal-driven software agents comprises a plurality of specialist agents and a supervisor agent;
wherein the plurality of specialist agents communicates via an agent-to-agent protocol;
wherein one or more specialist agents of the plurality of specialist agents accesses external tools via a model context protocol; and
wherein the supervisor agent selects which of the plurality of specialist agents acts at each step of a session based at least in part on the classified user state.

9. The computer-implemented system of claim 8, wherein the knowledge base comprises three cooperating tiers comprising a profile store containing user-specific category-level performance mappings, an episodic and relational memory store containing person-indexed, location-indexed, and topic-indexed prior-interaction records, and a semantic intent graph mapping intended meanings to expressions by way of a personalized semantic distance model; and
wherein the three cooperating tiers are continuously updated from each session.

10. The computer-implemented system of claim 1, further comprising a platform orchestration layer configured to:
expose a sensor-abstraction interface configured to receive biosignal input from a plurality of sensor devices conforming to a defined biosignal input protocol, wherein the sensor-abstraction interface is configured to accept sensor devices of different sensor modalities without modification of the feature extraction and classification subsystem;
expose an output-modality-abstraction interface configured to route outputs of the dynamic network of goal-driven software agents to at least one presentation surface conforming to a defined output protocol, wherein the at least one presentation surface include at least one of a visual display, an augmented reality display, a haptic device, a synthesized-voice output, and a networked actuator;
record, in an audit log, each received biosignal input, each classified user state, each AI agent decision, and each executed action, together with a timestamp and a retention-policy tag associated with each recorded entry; and
apply a privacy-preserving processing policy to the multimodal biosignal data, the privacy-preserving processing policy comprising at least one of:
on-device feature extraction with reduction of raw biosignal data prior to egress from a user device; and
application of a differential-privacy mechanism to telemetry data aggregated across users; and a configurable data-retention window applied per a user consent parameter.

11. The computer-implemented system of claim 10, wherein the sensor-abstraction interface is configured to receive the biosignal input from at least two sensor modalities selected from electroencephalography, heart-rate variability, electrodermal activity, eye tracking, facial expression, and voice analysis, concurrently and without reconfiguration of the feature extraction and classification subsystem.

12. The computer-implemented system of claim 10, wherein the privacy-preserving processing policy comprises the on-device feature extraction such that the raw biosignal data is reduced to a feature representation on the user device prior to transmission, and the audit log records the feature representation rather than the raw biosignal data.

13. A method for driving adaptive agent behavior from biosignal data, the method comprising:
acquiring multimodal biosignal data from a user;
classifying the multimodal biosignal data into at least one user state;
selecting, by at least one software agent, at least one action responsive to the classified at least one user state, wherein the selecting is informed by a knowledge base of historical biosignal patterns and prior outcomes;
executing the selected at least one action;
receiving feedback signals comprising further biosignal data and environmental data;
adjusting the selected at least one action in real time based on the feedback signals; and
periodically retraining a classifier and refining agent decision policies based on accumulated biosignal, action, and outcome data.

14. The method of claim 13, wherein classifying the multimodal biosignal data comprises determining a severity level for a detected state change; and
wherein the executed at least one action is selected based on the severity level, wherein, when the severity level exceeds a severity threshold, simultaneous environmental, stakeholder, and emergency-service actions are triggered.

15. The method of claim 13, wherein periodically retraining the classifier and refining agent decision policies comprises updating a persistent user model stored in the knowledge base, such that the persistent user model evolves across events as a principal output from the events.

16. A computer-implemented method for adapting a user interface based on a biosignal-grounded interaction history, the method comprising:
collecting, during prior sessions, multimodal time-series data comprising interaction logs, at least one of image and video, device telemetry, and electroencephalography signals;
segmenting the collected multimodal time-series data into chunks keyed to a user goal and an outcome comprising one of success and failure;
generating a multimodal embedding for each chunk;
storing the multimodal embedding in a vector store;
receiving current interaction context data and real-time biosignal data at runtime;
generating a real-time multimodal embedding from the current interaction context data and the real-time biosignal data in a same latent space as the stored multimodal embeddings;
retrieving, from the vector store, at least one stored multimodal embedding similar to the real-time multimodal embedding;
predicting, from the retrieved at least one stored multimodal embedding, at least one of a likely next user action and a likely target stimulus; and
modifying at least one interface parameter for the predicted likely target stimulus to reduce effort taken to complete the predicted likely next user action.

17. The computer-implemented method of claim 16, wherein modifying the at least one interface parameter comprises at least one action selected from:
increasing a rendered size of the predicted likely target stimulus;
increasing a sensitivity of a brain-computer interface classifier specifically for the predicted likely target stimulus; and
bypassing a dwell or hover confirmation step for the predicted likely target stimulus in a multi-step selection paradigm.

18. A method comprising:
capturing an environmental image via a wearable device;
detecting text within the environmental image;
classifying the text for linguistic complexity using a real-time performance state estimate of a user; and
rendering an augmented reality overlay containing at least one of a simplified text restatement, a symbol-based substitute, and an audio summary.

19. A method comprising:
receiving audio of a conversation in which a user is a participant;
detecting a word-retrieval-failure event using at least one of biosignal features and audio features;
identifying candidate words or concepts via a personalized semantic intent graph; and
rendering the candidate words or concepts as an augmented reality overlay visible to the user and not visible to conversation partners.

20. A method comprising:
classifying an ongoing social scenario using multimodal input;
retrieving encoded memories of similar prior scenarios;
generating contextual cues;
rendering the contextual cues as augmented reality overlays; and
re-encoding the ongoing social scenario to memory upon completion.
